(19) United States
(12) Patent Application Publication
(10) Pub. No.: US 2024/0378259 A1
(43) Pub. Date: Nov. 14, 2024

(54) Convolution Calculation Engine

(71) Applicant: SambaNova Systems, Inc., Palo Alto, CA (US)

(72) Inventors: Mark William Gottscho, Mountain View, CA (US); Ram SIVARAMAKRISHNAN, San Jose, CA (US); David Brian JACKSON, Dana Point, CA (US); Ruddhi CHAPHEKAR, Palo Alto, CA (US); Tuowen Zhao, Palo Alto, CA (US); Lei Xia, Milwaukee, WI (US)

(73) Assignee: SambaNova Systems, Inc., Palo Alto, CA (US)

(21) Appl. No.: 18/144,818

(22) Filed: May 8, 2023

(51) Int. Cl. G06F 17/15; G06F 7/544

(52) U.S. Cl. CPC G06F 17/153; G06F 7/5443

(57) ABSTRACT

A convolution calculation engine to perform a convolution operation includes a convolution address compute unit. The convolution address compute unit includes an outer output base location register to provide an outer output base location for the convolution operation and an outer input base location register to provide an outer input base location for the convolution operation. It also includes a kernel element counter that starts to count from an initial kernel count value to a maximum kernel count value in response to a change in the outer output base location and a kernel offset generator to generate a kernel offset based on an output of the kernel element counter. In addition, the convolution address compute unit includes inner location logic to calculate an output location based on the outer output base location and an input location based on the outer input base location and output of the kernel element counter.

### CROSS-REFERENCES AND INCORPORATIONS

This application is related to the following patent applications, which are hereby incorporated by reference for all purposes:
U.S. patent application Ser. No. 17/216,651, entitled “Lossless Tiling in Convolution Networks Tiling Configuration,” filed on Mar. 29, 2021, and issued as U.S. Pat. No. 11,195,080.
U.S. patent application Ser. No. 17/824,830, entitled “Matrix Multiplication on Coarse-grained Computing Grids,” filed on May 25, 2022.
U.S. patent application Ser. No. 18/095,132, entitled “Dataflow Architecture Processor Statically Reconfigurable to Perform N-Dimensional Affine Transform,” filed on January 110, 2023.
U.S. patent application Ser. No. 18/099,218, entitled “Fracturable Data Path in a Reconfigurable Data Processor,” filed on Jan. 19, 2023.
U.S. patent application Ser. No. ______, entitled “Convolution Calculation Engine Using Look-Up Tables for Address Calculation,” same day filed with this patent application.

The following are incorporated by reference for all purposes:
Prabhakar et al., “Plasticine: A Reconfigurable Architecture for Parallel Patterns,” ISCA '17, Jun. 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

### BACKGROUND

### Technical Field

The technology disclosed relates to performing convolutions in a data flow architecture. In particular, it relates to using specialized hardware to generate addresses for the matrices during a convolution operation.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Coarse grain reconfigurable architectures (CGRAs) exhibit far superior performance over conventional architectures, such as field programmable gate arrays (FPGAs) as they provide the capability to execute applications as nested dataflow pipelines. Maximizing the utilization of compute units in the CGRA to perform useful computations is critical to harness the benefits of a CGRA. A challenge to increasing compute unit (e.g., arithmetic logic unit (ALU)) utilization is to provide input data to the compute units at high enough bandwidth to sustain high compute throughput. CGRAs typically have memories organized in a distributed grid on-chip. Providing data at high throughput to compute units thus involves generating memory addresses at high throughput.

One operation that is commonly used for classification and computer vision tasks in machine learning (ML) and artificial intelligence (AI) applications is a convolutional neural network (CNN). A CNN includes three types of layers: a convolutional layer, a pooling layer, and a fully-connected layer. A convolutional layer passes a feature detector (i.e., a filter or kernel matrix) across an input tensor (i.e., input matrix) to generate a feature map (i.e., output matrix) using a convolution operation. The convolution operation is calculated as a dot product between the kernel matrix and a receptive field of the input matrix for each element in the output matrix. The matrices can have any dimension order, and convolutions using one-dimensional (1D) matrices for processing of audio, two-dimensional (2D) matrices for processing of images, and three-dimensional (3D) matrices for processing of 3D images or video, are commonly performed for various tasks. Higher dimensional convolutions may be used for other signal processing tasks. After a convolution operation, a rectified linear unit (ReLU) operation may be performed on the feature map before passing it to a pooling layer. During training of the CNN, back-propagation using a transposed convolution may be performed.

A straight-forward computation of an address to index into a multidimensional matrix for a convolution requires a divmod function to generate an integer quotient and remainder, which is difficult to generate in a cost-effective way using electronic circuitry. For example, to determine the (x,y) location of a particular element in at an offset of i into a 2D output matrix of dimension R×C stored in row-major order, (x, y) may be calculated using an integer divide operation of i/C, where x is the integer quotient of i and y is the remainder. The calculation of the addresses for each element of the input matrix for use in calculating the value of the output matrix at i is also computationally expensive.

The receptive field of a convolution operation depends on the size of the kernel matrix (sometimes simply referred to as a kernel) as well as several hyperparameters of the convolution operation, such as the dilation and the stride. Dilation expands the effective size of the kernel by spreading the kernel out, effectively adding zeros between the elements of the kernel, while stride indicates how far the kernel is moved across the input tensor for generation of the next element of the output. Another hyperparameter for a convolution operation is the effective padding value, which indicates how much space around the input tensor is added, although this does not affect the size of the receptive field. Support of dilation and stride values other than 1 and effective padding other than 0 adds additional computational complexity for the address calculations. Transposed convolutions can have fractional strides (i.e., moving the filter less than a full element of the input for each output element), providing even more computational complexity.

### BRIEF DESCRIPTION OF THE DRAWINGS

The technology will be described with reference to the drawings, in which:

FIG. 1 is a block diagram of an example convolution calculation engine to perform a convolution operation in an implementation of the present disclosure.

FIG. 2 provides a graphical illustration of a simple two-dimensional convolution operation.

FIG. 3 is a block diagram of an example circuit to generate addresses for a convolution operation that may be suitable for use in a memory unit of FIG. 1 in an implementation of the present disclosure.

FIG. 4A is a pseudocode listing showing more detail of the operation of an implementation of the circuit to generate addresses for a convolution operation shown in FIG. 3.

FIG. 4B is a pseudocode listing of operations for an alternative implementation of the circuit to generate addresses for a convolution operation shown in FIG. 3 as well as operations for a compiler to generate configuration information for that implementation.

FIG. 5 is a listing of operations that may be generated in an implementation of a convolution calculation engine to perform the convolution operation shown in FIG. 2 using the circuit to generate addresses for a convolution operation shown in FIG. 3 with a single accumulator.

FIG. 6A provides a graphical illustration of a convolution operation with an effective padding hyperparameter of 1.

FIG. 6B is a listing of operations that may be generated in an implementation of a convolution calculation engine to perform the convolution operation shown in FIG. 6A using the circuit to generate addresses for a convolution operation shown in FIG. 3 but with 6 accumulators.

FIG. 7A provides a graphical illustration of a convolution operation with a stride hyperparameter of 2.

FIG. 7B is a listing of operations that may be generated in an implementation of a convolution calculation engine to perform the convolution operation shown in FIG. 7A using the circuit to generate addresses for a convolution operation shown in FIG. 3 but with 6 accumulators.

FIG. 8A provides a graphical illustration of a convolution operation with a dilation hyperparameter of 2.

FIG. 8B is a listing of operations that may be generated in an implementation of a convolution calculation engine to perform the convolution operation shown in FIG. 8A using the circuit to generate addresses for a convolution operation shown in FIG. 3 but with 3 accumulators.

FIGS. 9A, 9B, 9C, 9D, 9E, 9F, 9G, 9H, 9I, 9J, 9K, 9L, 9M, 9N, 9O, 9P, 9Q, 9R, and 9S provide a graphical illustration over time of an implementation of a pipeline of 3 multiply-accumulate units in the compute unit of FIG. 1 to perform the convolution operation shown in FIG. 8A.

FIGS. 10A and 10B show a table providing more detail of the operation of one of the multiply-accumulate units shown in FIGS. 9A-9S performing the convolution operation shown in FIG. 8A where the input tensor has multiple components per element.

FIG. 11A provides a graphical illustration of a convolution operation with a sparse asymmetric kernel.

FIG. 11B is a listing of operations that may be generated in an implementation of a convolution calculation engine to perform the convolution operation shown in FIG. 11A using the circuit to generate addresses for a convolution operation shown in FIG. 3 using a look-up table and having 4 accumulators.

FIG. 12 illustrates an example system including a statically reconfigurable dataflow architecture processor using an array of coarse-grained reconfigurable units, a host, and a memory.

FIG. 13 illustrates an example of a computer, including an input device, a processor, a storage device, and an output device.

FIG. 14 illustrates example details of a CGR architecture including a top-level network (TLN) and two CGR arrays.

FIG. 15 illustrates an example CGR array, including an array of CGR units in an array-level network (ALN).

FIG. 16 illustrates an example of a reconfigurable memory unit and a reconfigurable compute unit, which may be combined in a fused compute and memory unit (FCMU).

FIG. 17 illustrates example hardware for a fracturable data path of a reconfigurable memory unit as shown in FIG. 16, including a plurality of stages in a memory address computation pipeline, in an implementation of the present disclosure.

FIG. 18 illustrates an example implementation of the header mux shown in FIG. 17, in an implementation of the present disclosure.

FIG. 19A illustrates details of an example of a stage in the data path pipeline shown in FIG. 17, in an implementation of the present disclosure.

FIG. 19B illustrate example operations performed by the fracturable data path shown in FIG. 17, in an implementation of the present disclosure, while performing an address calculation for a convolution operation.

FIG. 20 illustrates example hardware for a reconfigurable compute unit as shown in FIG. 16, in an implementation of the present disclosure.

FIG. 21 provides a graphical illustration of a convolution operation with a stride hyperparameter of 2 and effective padding of 1.

FIGS. 22A, 22B, 22C, 22D, 22E, and 22F provides a graphical illustration of a convolution operation with a stride hyperparameter of ½ and effective padding of 1 that is the transposed convolution of the convolution operation of FIG. 21.

FIG. 23 shows a table of the dot products for the convolution operation of FIG. 22A-F organized into groups having equal numbers of multiply-accumulate operations.

FIG. 24 is a block diagram of an example convolution address generator for a convolution operation that may be suitable for use in a reconfigurable memory unit, as shown in FIG. 16, in an implementation of the present disclosure.

FIG. 25 shows two tables with the dot products for the convolution operation of FIG. 22A-F organized into separate groups having equal numbers of multiply-accumulate operations for each dimension of the convolution operation.

FIGS. 26A and 26B combine to be a pseudocode listing showing more detail of the operation of an implementation of the circuit shown in FIG. 24 to generate addresses for a convolution operation.

FIG. 27 is listing of operations that may be generated in an implementation of a convolution calculation engine to perform the convolution operation shown in FIG. 21 using example convolution address generator shown in FIG. 24.

FIG. 28 is listing of operations that may be generated in an implementation of a convolution calculation engine to perform the convolution operation shown in FIG. 22A-22F using example convolution address generator shown in FIG. 24.

FIG. 29 shows a flowchart of a method for use by a compiler to produce a configuration file to configure a convolution calculation engine in an implementation of the present disclosure.

FIG. 30A is a Python listing of operations for a compiler to generate configuration information for an implementation of the present disclosure.

FIG. 30B shows example look up tables generated by the Python code of FIG. 30A.

FIG. 31 is a block diagram of a compiler stack implementation suitable for generating a configuration file for a statically reconfigurable dataflow architecture processor.

FIG. 32 shows an example user program in an example first stage of the compiler stack.

FIG. 33 shows the user program in an example second stage of the compiler stack.

FIG. 34 shows the user program in an example third stage of the compiler stack.

FIG. 35 shows the user program in an example fourth stage of the compiler stack.

FIG. 36 shows the logical computation graph and an example physical layout of the user program.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

Traditional compilers translate human-readable computer source code into machine code that can be executed on a Von Neumann computer architecture. In this architecture, a processor serially executes instructions in one or more threads of software code. Each new instruction is retrieved from memory, decoded, and then executes, commonly using a bank of registers within the processor, before the processor moves on to the next instruction. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as a statically reconfigurable dataflow architecture processor (SRDAP) using coarse-grained reconfigurable (CGR) units or graphic processing units (GPUs). As opposed to traditional Von Neumann architecture processor, a dataflow architecture processor configures a block of hardware in the processor to perform a task within the flow of a program. A program may be represented by a computation graph and a node in the graph may correspond to task to perform. The block of hardware waits for the data that it needs to perform its assigned task and then when the data is available, it performs the task on the data and passes the output of the task to the next node in the graph. Different nodes in the graph operate at the pace allowed by the availability of their inputs.

ML/AI applications may be expressed using computation graphs to describe an artificial neural network (ANN). In some cases, the computation graph may include a single node which it itself is a neural network. One type of neural network node that may be used is a convolutional neural network (CNN) which includes a convolutional layer. Note that while the discussion herein uses the term “convolution” throughout, the operations performed may be more accurately mathematically described as “cross-correlations.” A convolution and a cross-correlation are very similar in that both slide a kernel across an input to create an output. The difference is that in a true convolution, the kernel is flipped before sliding it across the input, while in a cross-correlation, the kernel is not flipped. Much of what is called a convolution within the ML/AI community is actually a cross-correlation and one of ordinary skill will appreciate that the systems, apparatuses, and methods presented herein can be equally applied to either a true convolution or a cross-correlation.

A convolutional operation computed by a convolutional layer of a CNN may be performed on an input tensor having any number of dimensions, with individual elements having any number of components. In an image processing operation, the input tensor may have two dimensions, width and height, with three components, such as red, green, and blue, for each element, which may be referred to as a pixel. A three-dimensional input tensor may refer to each element as a voxel, and an element, as the term is used herein, may refer to a pixel, a voxel, or an element of an input tensor of any dimension with any number of components.

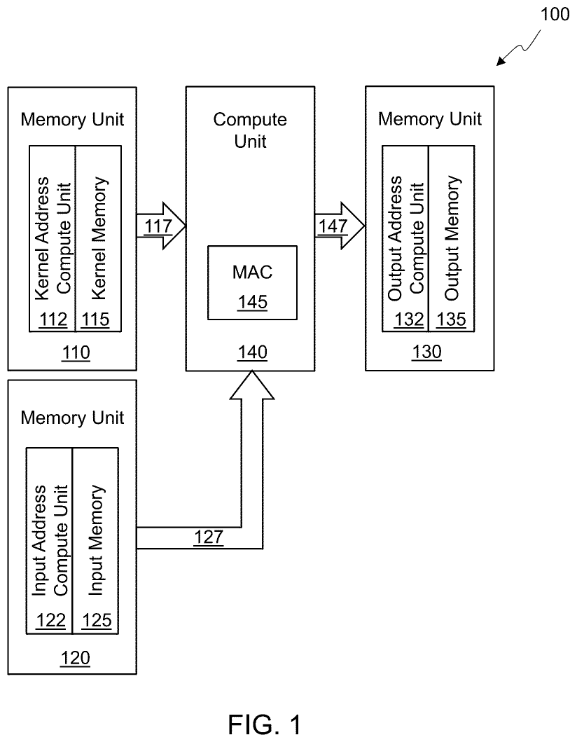

The convolution function (actually, a cross-correlation function as mentioned earlier) can be calculated as a dot product between the kernel and a receptive field of the input tensor for each element of the output. In a dataflow architecture, this can be accomplished by having a first memory unit of the dataflow architecture store the kernel and a second memory unit of the dataflow architecture store the input tensor (or a shard thereof). Each of the two memory units then sends its respective kernel and input data in the appropriate order to a compute unit to perform the dot product using a multiply-accumulate circuit (MAC). The compute unit then sends the computed output element to a third memory unit designated to buffer the output which then may be sent to another unit in the dataflow architecture for further processing. This type of system can be seen in FIG. 1.

In a traditional Von Neuman architecture computer using a traditional programming language, the address calculation for each of the kernel, the input, and the output, can be expressed as a series of nested ‘for loops’ which one loop for each dimension of the input tensor. But this representation breaks down for a dataflow architecture where the address calculation for the memory tensor may be too complicated for the address calculation hardware included in a memory block of the dataflow architecture.

One way of dealing with this issue is to precompute the addressed using a traditional computer and store this as a table in a fourth memory unit while the tensor data is stored in a second memory unit. The data in the table in the fourth memory unit is then sent to the second memory unit and used as the address into the input tensor to access the appropriate data from the tensor in the proper order for the convolution. This type of graph can be used to generate a convolution in a dataflow architecture, but at the cost of additional memory use (i.e., the fourth memory unit) to hold the address table and additional bandwidth to send the table data from the fourth memory unit to the second memory unit in the network connecting the units of the dataflow architecture.

Described herein are hardware circuits, included in the memory units of the dataflow architecture processor, to perform convolution address calculations for the kernel, the input tensor, and the output. In one implementation, a kernel element counter is used to walk through the kernel for each output element. Each count of the kernel element counter corresponds to a particular element of the kernel. An outer input base location and an outer output base location are maintained as is an input location for the element of the input tensor that is to be multiplied by the particular element of the kernel for the current count of the kernel element counter. The location of the current output element is calculated based on the outer input base location and the current count of the kernel element counter. For systems where a single MAC in the compute element is used to generate the output, the outer output base location may be kept equal to the current output element.

In some systems, the compute unit provides multiple MACs that can operate in parallel. In systems where each input element has multiple components that are used to generate a single component of the output and the elements of the kernel and the input are sent as vectors from the memory units to the compute unit, the number of MAC cycles needed to calculate a single output element may exceed the number of cycles needed to send the kernel and input vectors to the computer unit. The use of multiple MACs can then increase the efficiency of performing the convolution operation in the system. In such systems, the convolution address calculation circuits include an accumulator counter to track which MAC is to be used for a particular output. The accumulator counter cycles through its count for each count of the kernel element counter, and the memory unit that holds the input tensor generates an input address for each accumulator, using an inner input base location, the current count of an inner input base register, and the current count of the accumulator counter, before allowing the kernel element counter to increment. This allows the compute unit to finish the calculation of one output element in each MAC for one cycle through the kernel element counter. The compute unit can then send the accumulated values in each MAC to the output memory unit. When the kernel element counter wraps back to its initial value, the inner input base location is updated to correspond to the first input element that will be used for the next output element and the kernel element counter starts counting again with the accumulator counter cycling through its count for each kernel element counter value.

In some implementations, a separate offset for each dimension of the convolution operation is generated and an address calculation circuit takes those offsets and generates a linear address into the memory array. In such implementations, the various base registers and counters are organized and maintained for each dimension.

The calculation of the input offset for a particular kernel count is performed by multiplying the kernel count by the dilation value for the convolution, adding it to the inner input base location, and subtracting the effective padding value. In some implementations, the value of the kernel count multiplied by the dilation value and then subtracting the effective padding value is precomputed and stored in a look-up table in the hardware circuit, indexed by the kernel count. This substitutes a small look-up table for a hardware multiply circuit, which may take significantly less room on an integrated circuit.

For convolutions with a fractional stride value, some of the kernel elements do not correspond to an element of the input tensor for a given output element and are thus effectively multiplied by zero to compute that output element. Rather than spend the cycles to multiply those kernel elements by zero and then accumulate the zero value in the MAC, some implementations skip those elements of kernel when sending the kernel elements to the compute unit. This means, however, that unlike systems where every kernel element is used to calculate every output element, the number of multiply-accumulate operations may vary between output elements. If a single accumulator is used, this may be handled by providing the number of accumulate cycles needed for each output element, which may utilize additional bandwidth. But for systems where multiple MACs are used, each MAC may need to perform the same number of cycles before the accumulated values are sent to the output memory unit and calculation of a new set of outputs starts. This may waste MAC cycles.

To more efficiently utilize the MACs, some implementations may divide the output calculations into groups having using an equal number of MAC cycles. The hardware includes a group counter and a group look-up table that provides the number of MAC cycles for each count of the group counter. The hardware also includes an offset look-up table that provides a kernel offset and/or a relative input offset that is indexed by the current counts of both the group counter and the kernel element counter. The input location is calculated as described earlier, using an outer input base register and an inner input base register and using the accumulator count, the kernel element count, and the inner input base register. Note that the output elements are not calculated in order in such systems, so the output memory unit includes similar hardware to calculate the proper output address matching the order in which they are calculated. By organizing the calculation of the output elements in such a way that all of the output elements being concurrently calculated by the MACs require the same number of accumulate cycles, the MACs can be kept busy and the number of MAC cycles required can be updated when the group number changes.

### Terminology

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetic, or mechanical, between the things that are connected, without any intervening things or devices.

The term configured (to perform a task or tasks) is a broad recitation of structure generally meaning “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

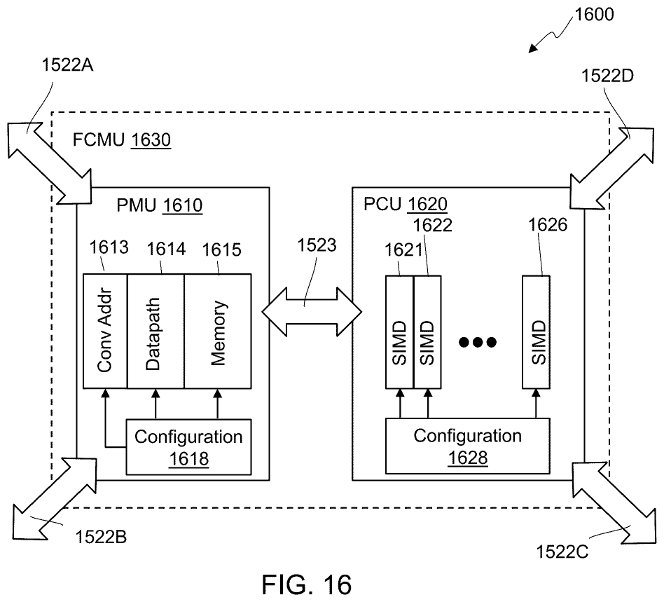

Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 16.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CGR Array—an array of CGR units, coupled with each other through an array-level network (ALN), and coupled with external elements via a top-level network (TLN). A CGR array can physically implement the nodes and edges of a dataflow graph.

Dataflow Graph—a computation graph that includes one or more loops that may be nested, and wherein nodes can send messages to nodes in earlier layers to control the dataflow between the layers.

Data path—a collection of functional units that perform data processing operations. The functional units may include memory, multiplexers, ALUs, SIMDs, multipliers, registers, buses, etc.

FCMU—fused compute and memory unit—a circuit that includes both a memory unit and a compute unit.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

A logical CGR array or logical CGR unit—a CGR array or a CGR unit that is physically realizable, but that may not have been assigned to a physical CGR array or to a physical CGR unit on an IC.

Metapipeline—a subgraph of a computation graph that includes a producer operator providing its output as an input to a consumer operator to form a pipeline. A metapipelines may be nested within another metapipeline, that is, producer operators and consumer operators may include other metapipelines.

ML—machine learning.

PCU—pattern compute unit—a compute unit that can be configured to repetitively perform a sequence of operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. Statically reconfigurable dataflow architecture processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the statically reconfigurable dataflow architecture processor, CGR array level, and/or GCR unit level.

Pipeline Stages—a pipeline is divided into stages that are coupled with one another to form a pipe topology.

PMU—pattern memory unit—a memory unit that can locally store data according to a programmed pattern.

PNR—place and route—the assignment of logical CGR units and associated processing/operations to physical CGR units in an array, and the configuration of communication paths between the physical CGR units.

RAIL—reconfigurable dataflow unit (RDU) abstract intermediate language.

SIMD—single-instruction multiple-data—an arithmetic logic unit (ALU) that simultaneously performs a single programmable operation on multiple data elements delivering multiple output results.

TLIR—template library intermediate representation.

TLN—top-level network.

### Implementations

Implementations of a convolution calculation engine to perform a convolution operation can include memory units to store a kernel, an input tensor, and an output of a convolution application, and a compute unit having one or more multiply-accumulate units. The memory units may include a memory array, a general address calculation unit, and a convolution address compute unit. In other implementations, a convolution address compute unit may be provided as a separate element in the convolution calculation engine.

An implementation of a convolution address compute unit. The convolution address compute unit includes an outer output base location register to provide an outer output base location for the convolution operation and an outer input base location register to provide an outer input base location for the convolution operation. It also includes a kernel element counter that starts to count from an initial kernel count value to a maximum kernel count value in response to a change in the outer output base location and a kernel offset generator to generate a kernel offset based on an output of the kernel element counter. In addition, convolution address compute unit includes inner location logic to calculate an output location based on the outer output base location and an input location based on the outer input base location and the output of the kernel element counter.

An alternative implementation of a convolution address compute unit includes a kernel element counter for a convolution operation between a kernel and an input tensor. The kernel element counter wraps back to an initial kernel count value after reaching a maximum kernel count value. The convolution calculation engine also includes an offset look-up table (LUT) that provides a relative input offset into the input tensor based on an output of the kernel element counter and input location calculation logic that provides an input location within an input tensor for the convolution operation based on the relative input offset provided by the offset LUT.

An implementation of a compiler is configured to produce a configuration file to configure one or more statically reconfigurable units in an array of coarse-grained reconfigurable units of a statically reconfigurable dataflow architecture processor to act as a convolution calculation engine and perform a convolution operation. The configuration file may configure a convolution address compute unit in a statically reconfigurable unit to generate an address sequence for a convolution operation between an input tensor and a filter kernel. The compiler determines a first group of pairs of kernel offsets into filter kernel and relative input offsets into the input tensor for an output element of an output of the convolution operation based on a dilation value, an effective padding value, and a stride value of the convolution operation. It then generates an offset table of the relative input offsets to load an input offset look-up table in the convolution address compute unit and includes the offset table of the relative input offsets in the configuration file.

FIG. 1 is a block diagram of an example convolution calculation engine 100 to perform a convolution operation in an implementation of the present disclosure. The convolution calculation engine 100 includes a first memory unit 110, a second memory unit 120, and a third memory unit 130. The first memory unit 110, the second memory unit 120, and the third memory unit 130 may be custom hardware units specifically designed for their individual purpose or they may be identical hardware units configured for their specific task. In some implementations, the memory units 120, 120, 130 may be coarse-grained reconfigurable (CGR) units in a CGR array and may be a part of a statically reconfigurable dataflow architecture processor.

The first memory unit 110 includes a kernel address compute unit 112 and a memory 115 to hold elements of the kernel for the convolution operation. The second memory unit 120 includes an input address compute unit 122 and a memory 125 to hold elements of the input tensor for the convolution operation. The third memory unit 130 includes an output address compute unit 132 and a memory 135 to hold elements of the output of the convolution operation. Each of the first memory unit 110, the second memory unit 120, and the third memory unit 130 includes a memory controller configured to access the memory array 115, 125, 135 using a memory address received from the address compute unit 112, 122, 132.

The kernel address compute unit 112, the input address compute unit 122 and the output address compute unit 132 may be customized to their specific address calculation task, but in some implementations, the kernel address compute unit 112, the input address compute unit 122 and the output address compute unit 132 are identical hardware circuits that are configured at runtime to perform their specific address calculation task. In such implementations, the memory units 120, 120, 130 may include a selection register to store an indication of whether the address compute unit 112, 122, 132 is in the kernel address compute unit 112 in the first memory unit, the input address compute unit 122 in the second memory unit 120, or the output address compute unit 135 in third memory unit 130.

The convolution calculation engine 100 also includes a compute unit 140 that includes a first multiply-accumulate (MAC) unit 145 communicatively coupled to the first memory unit 110 by interconnect 117, the second memory unit 120 by interconnect 127, and the third memory unit 130 by interconnect 147. The compute unit 140 may be custom hardware units specifically designed for task of computing dot products or it may be more general purpose hardware configured for use in the computation of convolution operations. In some implementations, the compute unit 140 may be a coarse-grained reconfigurable (CGR) unit in a CGR array and may be a part of a statically reconfigurable dataflow architecture processor.

The compute unit is configured to receive pairs of values respectively from the first memory unit 110 over interconnect 117 and the second memory unit 120 over interconnect 127. A pair of values includes a value of an element of the kernel read from the kernel memory 115 using an address generated by the kernel address compute unit 112 and a value of an element of the input tensor from the input memory 125 using an address generated by the input address compute unit 122. The compute unit 140 performs a multiply and accumulate of the pairs of values using the MAC 145 and sends an accumulated value from the MAC 145 to the third memory unit 130 over interconnect 147. The third memory unit 130 then stores the accumulated value received from compute unit 140 in its output memory 135 using an address calculated by the output address generation unit 132.

In at least one implementation, the kernel address compute unit 112, the input address compute unit 122, and the output address compute unit 132 each include an outer output base location register to provide an outer output base location for the convolution operation, an outer input base location register to provide an outer input base location for the convolution operation, and a kernel element counter that starts to count from an initial kernel count value to a maximum kernel count value in response to a change in the outer output base location. The kernel address compute unit 112 includes a kernel offset generator to generate a kernel offset based on an output of the kernel element counter. The input address compute unit 122, includes inner location logic to calculate an input location based on the outer input base location and the output of the kernel element counter. The output address compute unit 132 includes inner location logic to calculate an output location based on the outer output base location.

In another implementation, the kernel address compute unit 112, the input address compute unit 122 and the output address compute unit 132 each include a kernel element counter for the convolution operation. The input address compute unit 122 includes an offset look-up table (LUT) that provides a relative input offset into the input tensor based on an output of the kernel element counter, and input location calculation logic that provides an input location within an input tensor for the convolution operation based on the relative input offset provided by the offset LUT. The kernel address compute unit 112 may include a kernel offset look-up table (LUT) that provides an offset into the kernel based on an output of the kernel element counter. The kernel offset LUT may be a part of the offset LUT where the relative input offset and the kernel offset are different fields of the LUT's output or the kernel offset LUT may be a different LUT than the offset LUT. The output address compute unit 132 includes logic to calculate an output location. The kernel element counter wraps back to an initial kernel count value after reaching a maximum kernel count value.

The first memory unit 110 is configured to use the kernel offset to calculate a kernel memory address in the kernel address compute unit 112, use the kernel memory address to read kernel data from its memory array 115, and send the kernel data as a first element of a pair of values over interconnect 117 to the MAC unit 145 in the compute unit 140. The second memory unit 120 is configured to use the input location to calculate an input memory address in the input address compute unit 122, use the input memory address to read input data from its memory array 125, and send the input data as a second element of the pair of values over interconnect 127 to the MAC unit 145 in the compute unit 140. The third memory unit 130 is configured to use the output location to calculate an output memory address in the output address compute unit 132, and use the output memory address to store the accumulated value received from the MAC unit 145 of the compute unit 140 in its memory array 135.

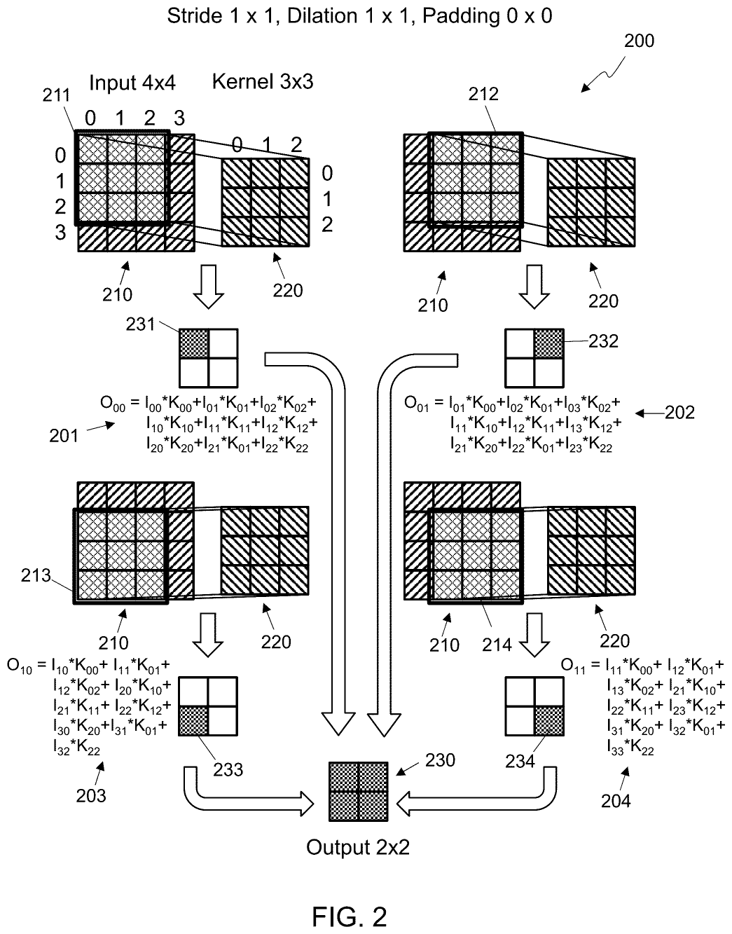

FIG. 2 provides a graphical illustration 200 of a simple two-dimensional (2D) convolution operation. The convolution operation has a stride of 1 in both the width and height dimension, a dilation of 1 in both the width and height dimension, and no effective padding. The convolution operation uses a 3×3 kernel 220 on a 4×4 input tensor 210 to generate the 2×2 output 230. To generate the first output element 231 at row 0 and column 0, the kernel 220 is applied to the receptive field 211 of the input 210 to create a dot product as shown in equation 201. To generate the second output element 232 at row 0 and column 1, the kernel 220 is applied to the receptive field 212 of the input 210 to create a dot product as shown in equation 202. To generate the third output element 233 at row 1 and column 0, the kernel 220 is applied to the receptive field 213 of the input 210 to create a dot product as shown in equation 203. And to generate the fourth output element 234 at row 1 and column 1, the kernel 220 is applied to the receptive field 214 of the input 210 to create a dot product as shown in equation 204.

Note that in this disclosure, several different notations are used to indicate the location of an element within a matrix/tensor. For example, in the equations 201-204 in FIG. 2, subscripts are used to indicate the location within the input 210, kernel 220, and output 320 (e.g., I₀₀, K₀₀, O₀₀). In other places, the location may be represented as a pair of numbers in parentheses following the variable name, such as Out(0,0). In other places square brackets may be used in place of parentheses (e.g., Ker[0,0]) and in FIG. 10A-10B, the indices are simply listed in order following the variable name with no subscript, parentheses, or square brackets (e.g., In00). All of these representations should be interpreted as being equivalent so that In00, In(0,0), In[0,0], and In00 all represent the element at row 0 and column 0 of the matrix ‘In’.

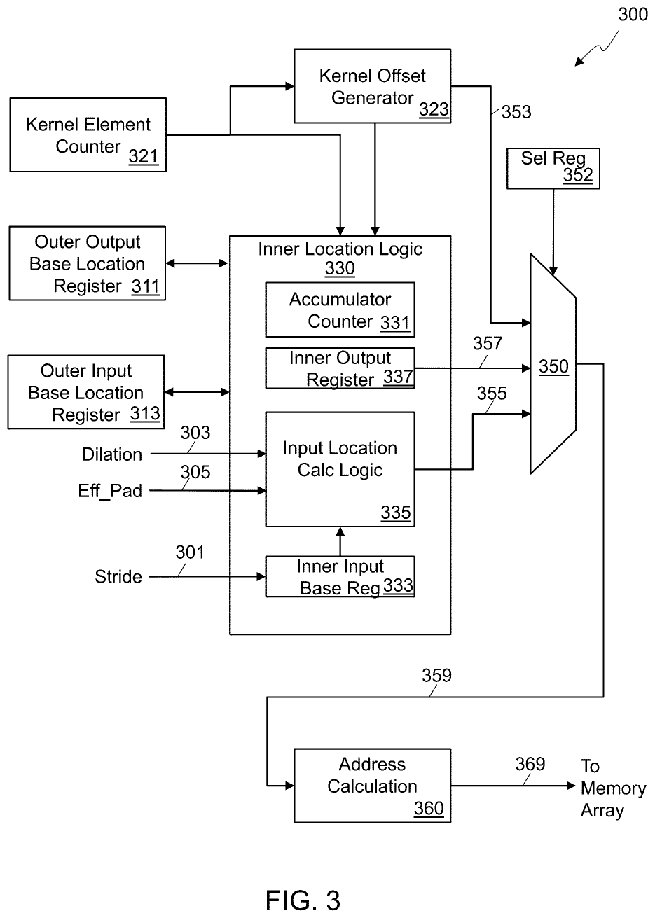

FIG. 3 is a block diagram of an example circuit 300 to generate addresses for a convolution operation that may be suitable for use in a memory unit of FIG. 1 an address compute unit 112, 122, 132 in an implementation of the present disclosure. While the use of the circuit 300 is described herein for use in convolution operations, the circuit 300 may be useful for other operations, such as pooling operations, which operate on a local region within a multidimensional tensor. The circuit 300 includes an outer output base location register 311 to provide an outer output base location for the convolution operation and an outer input base location register 313 to provide an outer input base location for the convolution operation. They are referred to as ‘outer’ registers because they are changed less frequently than ‘inner’ registers that will be discussed later.

The circuit 300 also includes a kernel element counter 321 that starts to count from an initial kernel count value to a maximum kernel count value in response to a change in the outer output base location and then wraps back to the initial kernel count value from the maximum kernel count value. The initial kernel count value may be zero in implementations (although other values are possible) and the maximum kernel count value may be set by software using control/status registers (CSRs), configuration bits from a configuration file, or received as a parameter for the convolution operation. In some implementations, the maximum kernel count is directly based on the size of the kernel, but in other implementations, the maximum kernel count may be smaller than the actual size of the kernel, as will be explained later. In implementations having a single accumulator, the outer input base location register 313 increments by a stride amount 301 for the convolution operation and the outer output base location register 311 increments by 1 in response to the kernel element counter 321 wrapping back to its initial value.

The circuit 300 includes at least one of (a) a kernel offset generator 323 to generate a kernel offset 353 based on an output of the kernel element counter 321, (b) logic, such as an inner output register 337, to calculate an output location 357 based on the outer output base location stored in the outer output base location register 311, or (c) input location calculation logic 335 to compute an input location 355 based on the outer input base location 313 and the output of the kernel element counter 321. Inner location logic 330 may calculate both an output location 357 based on the outer output base location register 311 and an input location 355 based on the outer input base location 313 and the output of the kernel element counter 321 in some implementations of the circuit 300. The inner location logic 330 may be configured to update the input location 355 in response to an update of the kernel element counter 321. The inner location logic may also be configured to calculate the input location 355 further based on a dilation value 303 and/or an effective pad value 305 for the convolution operation by multiplying the output of the kernel element counter 321 by a dilation value 303 for the convolution operation and adding a difference between the inner input base register 333 and an effective pad value 305 for the convolution operation.

In certain cases, such as where the effective padding value 305 is non-zero, an input location 355 may be calculated that is outside of the bounds of the input tensor, such as a negative value or a value greater than the length of the tensor. To handle these cases, the inner location calculation logic 335 may include circuitry configured to check the input location 355 against bounds for the input tensor. In response to determining that the input location 355 is outside of the bounds, the inner location calculation logic 335 can set a predicate for the input location 355 to indicate that no memory read should be performed and that a value of zero should be provided in place of data read from memory for the input location. The memory unit 120 is configured to detect the predicate and provide a zero value of the interconnect 127 for that input location instead of any data read from the input memory 125. In some implementations, the memory unit 120 omits a read operation from the input memory 120 in response to detecting the predicate.

As was described in the discussion of FIG. 1, an address compute unit 112, 122, 132 respectively computes a kernel element address, an input tensor element address, or an output element address so not all circuits need compute all three of the kernel offset 353, the output location 357, and the input location 355, so the kernel address compute unit 112 may generate only the kernel offset 353, the input address compute unit 122 may generate only the input location 355, and the output address compute unit 132 may generate only the output location 357. But in some implementations, the address compute units 112, 122, 132 are identical circuits configured differently, so that each of the address compute units 112, 122, 132 generate all three of the kernel offset 353, the output location 357, and the input location 355. In such systems, the circuit 300 also includes a selector circuit 350 (e.g., a multiplexer) coupled to the kernel offset generator 323, and the inner location logic 330 that is configured to select either the kernel offset 353, the output location 357, or the input location 355 as its output 359. The circuit 300 may also include a selection register 352, coupled to the selector circuit 350, to provide selection information to the selector circuit 350 and an address calculation unit 360 coupled to the selector circuit 350 and configured to calculate a memory address 369 based on the output 359 of the selector circuit 350. The memory address 369 is then provided to the memory array 115, 125, 135 to access the appropriate location in memory for the task assigned to the particular memory unit 110, 120, 130.

The circuit 300 may be designed to accommodate a certain number of dimensions to support a multidimensional convolution operation, such as a two-dimensional (2D) convolution operation using a 2D input tensor and 2D kernel, or a three-dimensional (3D) convolution operation using a 3D input tensor and 3D kernel. In addition, each element of the input tensor may include multiple components, such as a 2D image having red, green, and blue components. The kernel may generate a single component output, with a separate kernel element for each of the components of the input tensor. For generation of multiple component outputs, a separate kernel for each output component may be used. These separate kernels may be thought of as yet another dimension for the kernels in some implementations, however, so that a single kernel with an output component dimension, along with the nominal dimensions of the convolution operation and an input component dimension.

So, for circuit 300 that provides hardware support for a multidimensional convolution operation, the various hardware elements may be broken into separate elements per dimension. Thus, the outer output base location register 311 can include a first dimension outer output base location register for a first dimension of an output of the convolution operation and a second dimension outer output base location register for a second dimension of the output of the convolution operation. The outer input base location register 313 can include a first dimension outer input base location register for a first dimension of an input to the convolution operation and a second dimension outer input base location register for a second dimension of the input to the convolution operation. The kernel element counter 321 can include a first dimension kernel counter for the first dimension of the kernel and a second dimension kernel counter for the second dimension of the kernel, where the second dimension kernel counter is configured to increment in response to the first dimension kernel counter wrapping to its initial value from a maximum first dimension kernel count value. The kernel offset generator 323 can generate a first dimension kernel offset for a first dimension of a kernel for the convolution operation and a second dimension kernel offset for a second dimension of the kernel for the convolution operation. In some implementations, the first dimension kernel offset generator may simply utilize the output of the first dimension kernel counter as the first dimension kernel offset, and the second dimension kernel offset generator may simply utilize the output of the second dimension kernel counter as the second dimension kernel offset. The inner location logic 330 can calculate a first dimension input location for the first dimension of the input to the convolution operation and a second dimension input location for the second dimension of the input to the convolution operation. The inner location logic 330 can also calculate a first dimension output location for the first dimension of the output of the convolution operation, a second dimension output location for the second dimension of the output of the convolution operation.

In some implementations, the circuit 300 is designed for a 3D convolution operation. Note that the 3D hardware can easily support a 1D or 2D convolution operation simply be setting the unused dimension(s) to ‘1’. An example implementation of the circuit 300 supporting a 3D convolution operation includes a third dimension outer output base location register in the outer output base location register 311 for a third dimension of the output of the convolution operation, a third dimension outer input base location register of the outer input base location register 313 for a third dimension of the input to the convolution operation, and a third dimension kernel counter in the kernel element counter 321 for a third dimension of the kernel, where the third dimension kernel counter is configured to increment in response to the second dimension kernel counter wrapping to its initial value from a maximum second dimension kernel count value. In this example, the kernel offset generator 323 generates a third dimension kernel offset for a third dimension of the kernel for the convolution operation, the inner location logic 330 calculates a third dimension input location for the third dimension of the input to the convolution operation, and the inner location logic 330 also calculates a third dimension output location for the third dimension of the output of the convolution operation. Other implementations may support any number of dimensions and it should be clear to one of ordinary skill that the techniques described herein can be extended to provide an implementation supporting four dimensional convolutions, five dimensional convolutions, or any number of dimensions depending on the application and the implementation.

In some implementations, the compute unit 140 includes multiple MACs. The circuit 300 of such implementations can include an accumulator counter 331 configured to be reset to an initial accumulator value, such as 0, in response to a change in the kernel element counter 321, and increment in response to a new input location being calculated, until reaching a maximum accumulator count value. The inner input base register 333 provides an inner input base location by incrementing in response to the accumulator counter 331 wrapping back to the initial accumulator value, incrementing in response to the accumulator counter 331 incrementing, and loading the outer input base location in response to the kernel element counter 321 wrapping back to the initial kernel count value. The kernel element counter 321 is configured to increment in response to the accumulator counter 331 reaching the maximum accumulator count value.

For each combination of accumulator counter 331 and kernel element counter 321, the second memory unit 120 can use the input location calculation logic 335 to calculate a new input location 355 based on the inner input base register 333 and the output of the kernel element counter 321. This may be done by multiplying the kernel count by the dilation value 303 for the convolution, adding it to the inner input base location provided by the inner input base register 333, and subtracting the effective padding value 305. In some implementations, however, an offset lookup table (LUT) is used to provide an input offset that has been precomputed for the hyperparameters of the convolution operation. The offset LUT is indexed by the output of the kernel element counter 321 and outputs an input offset value which may be added to the output of the inner input base register 333 to calculate the input location 355.

In the first memory unit 110, the kernel offset generator 323 may, in some implementations, include an offset lookup table, indexed by the output of the kernel element counter, and outputting the kernel offset. The offset lookup table may be shared with the offset lookup table used to provide the relative input offset in some cases.

The third memory unit 130 may calculate a new output location for each new value of the accumulator counter 331, except for implementations where only one accumulator is used, in which case a new output location is calculated each time that the kernel element counter wraps back to its initial value. This may be accomplished by having the inner output register, which provides the output location, increment in response to a new input location being calculated, and to load the outer input base location in response to the kernel element counter wrapping back to the initial kernel count value. The outer output base location is set the latest value of the inner output register upon the kernel element counter wrapping back to the initial kernel count value

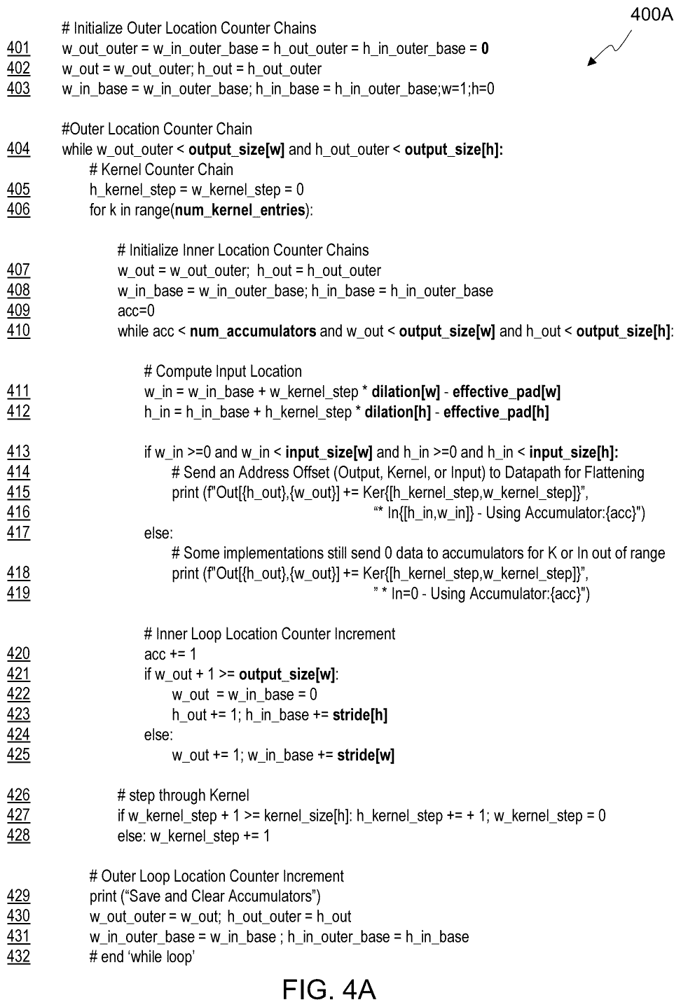

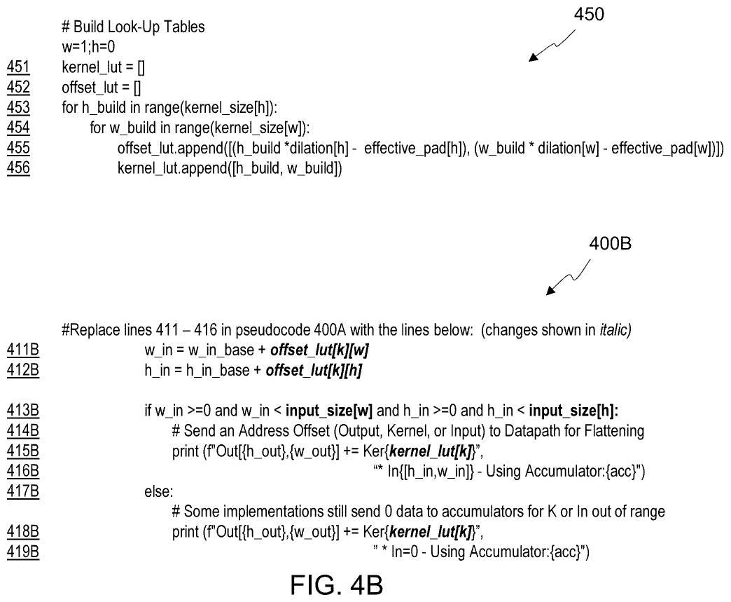

FIG. 4A is a pseudocode listing 400A showing more detail of the operation of an implementation of the circuit 300 to generate addresses for a convolution operation shown in FIG. 3. The pseudocode is written in Python but with some instructions combined on a single line and separated by semicolons to save space. It should be noted that while the Python code is normally executed in a sequential fashion, its purpose here is to illustrate the functionality of the circuit 300 which has different blocks of circuitry that can operate in parallel and/or in a cascaded fashion where the function of one block of hardware is dependent upon an output of another block of hardware. Thus, the linear functionality of the pseudocode 400A should not be seen as limiting on implementations. Note that the pseudocode 400A shows a 2D convolution but could easily be extended to higher dimensions by one of ordinary skill in the art. Also note that bolded variables (and immediate values) may be received in a CSR or configuration bits for the particular convolution operation.

The pseudocode 400A begins with a block of code on lines 401-403 to initialize various variables. The w_out_outer and h_out_outer variables correspond to two dimensions of the outer output base location register 311, while the w_in_outer_base and h_in_outer_base variables correspond to two dimensions of the outer input base location register 313. The w_out and h_out variables correspond to two dimensions of the inner output register 337, and the w_in_base and h_in_base correspond to two dimensions of the inner input base register 333. Note that to start, all of these registers may be set to a base address, such as zero, which may be received in the configuration bits or from a CSR. The base address used here may not correspond to an actual base address for the input or output as that may be incorporated into the actual memory address in the address calculation unit 360, which is not shown in the pseudocode 400A.

The pseudocode 400A continues with a ‘while loop’ at line 404. The while loop will continue until the outer output base location register 311 (represented by the variables w_out_outer and h_out_outer) exceeds its bounds as determined by the output size which is provided to the convolution calculation engine. Note that in the pseudocode 400A, those variables are updated in line 430 and in the hardware, the outer output base location register 311 may be loaded upon overflow of the kernel element counter 321. The outer output base location register 311 is set to the next output location to be calculated after a full set outputs equal to the number of accumulators being used have been calculated, as noted by the print statement on line 429 inserted in the pseudocode 440A as a placeholder. Note that the compute unit 140 is responsible for determining that this point has been reached, sending the accumulated values to the third memory unit 130, and then clearing the accumulators for the next round of values. Also note that at the same time, the outer input base register 313 (represented by the w_in_outer_base and h_in_outer_base variables) is loaded with the value of the inner input base register 333 (represented by the w_in_base and h_in_base variables) as that is the input base value for the next output to be calculated.

Thus, the pseudocode 400A can show a method for use in a convolution operation that includes initializing an outer output base location register to provide an outer output base location for the convolution operation and initializing an outer input base location register to provide an outer input base location for the convolution operation.

Line 406 of the pseudocode 400A represents the kernel element counter 321 and lines 405 and 426-428 represent the kernel element offset generator 323 with the values of w_kernel_step and h_kernel_step representing the kernel offset values 353. Note that for the 2D implementation shown, the w_kernel_step increments by 1 for each increment of the kernel element counter until it exceeds its bound where it is reset to 0 and h_kernel_step is incremented as shown in lines 427-428. In other implementations, the kernel element counter 321 may be implemented as two counters with the first dimension counter being modulo output_size[h] which when it overflows, increments the second dimension counter which is modulo output_size[w]. The output of those two counters could then be used directly as the kernel offset 353 with the kernel offset generator simply passing those values through. In the example shown, the maximum kernel count, num_kernel_entries, is received by the convolution calculation engine as a parameter for the convolution operation. Note that the memory unit 130 may set num_kernel_entries equal to 1 (independent of the actual size of the kernel) to avoid generating duplicate output locations.

Thus, the method for use in a convolution operation can include counting, with a kernel element counter, from an initial kernel count value to a maximum kernel count value in response to a change in the outer output base location.

After initiating the kernel element counter 321 and at each increment thereafter, the inner output register 337 (represented by the w_out and h_out variables) is loaded with the value of the outer output base location register 311 (represented by the variables w_out_outer and h_out_outer) in line 407 and the inner input base register (represented by the w_in_base and h_in_base variables) is loaded with the value of the outer input base location register 313 (represented by the w_in_outer_base and h_in_outer_base variables) in line 408.

The ‘while loop’ at line 410, along with initialization of the acc variable at line 409 and the increment of the acc variable in line 420 represent the accumulator counter 331. Note that the while loop will run a number of times equal to the value of the acc variable except for the last time through the loop. If the size of the output is not equally divisible by the number of accumulators as represented by the variable num_accumulators (which may be received as a parameter of the convolution operation or may be fixed for a particular implementation based on the number of MACs in the compute unit 140), the last pass through the while loop will not use all of the accumulators. Note that the memory unit 110 may set acc to 1, independent of the actual number of accumulators used, to avoid generating duplicate kernel offsets.

The method for use in a convolution operation may also include resetting an accumulator counter to an initial accumulator value in response to a change in the kernel element counter and incrementing the accumulator counter in response to a new input location being calculated, until reaching a maximum accumulator count value.

Once inside the ‘while loop’ starting at line 410, which is initiated by resetting the value of the accumulator counter 331 and repeats each time that the accumulator counter 331 increments until reaching the maximum accumulator count value (variable num_accumulators), the circuit 300 will generate at least one of a kernel offset 353 based on an output of the kernel element counter 321, an output location 357 from the inner output register 337 which is based on the outer output base location, or an input location 355 (represented by the variables w_in and h_in) based on the outer input base location from the inner input base register 333 and the output of the kernel element counter 321. The calculation of the input location 355 is shown in lines 411-412, where for each dimension, the kernel offset 353 (w_kernel_step or h_kernel_step) is multiplied by the dilation and added to the inner input base location from the inner input base register 333 (w_in_base or h_in_base). The value of the effective_pad is then subtracted from that to generate the input location 355 (w_in and h_in).

Thus, a method for use in a convolution operation can include generating a first dimension kernel offset for a first dimension of a kernel for the convolution operation and generating a second dimension kernel offset for a second dimension of the kernel for the convolution operation. The method may alternatively or also include calculating a first dimension input location for the first dimension of the input to the convolution operation and calculating a second dimension input location for the second dimension of the input to the convolution operation. The method may alternatively or also include calculating a first dimension output location for the first dimension of the output of the convolution operation and calculating a second dimension output location for the second dimension of the output of the convolution operation. In some implementations, the method includes incrementing a first dimension kernel counter as a part of the counting by the kernel element counter, incrementing the second dimension kernel counter in response to the first dimension kernel counter wrapping to its initial value from a maximum first dimension kernel count value, and wrapping the kernel element counter back to the initial kernel count value after reaching the maximum kernel count value.

In some implementations, the circuit 300 of the second memory unit 120 may check the input location 355 against bounds (represented by variables input_size[w] and input_size[h]) for an input to the convolution operation as represented by line 413. If the input location 355 is within the bounds of the input tensor, the input location 355 is sent to the address calculation unit 360 and on to the memory 115 to read the element of the input tensor which is then sent to the compute unit 140 over interconnect 127. But if the input location 355 is outside of the bounds of the input tensor, the input location calculation logic 335 can set a predicate for the input location 355 to indicate that no memory read should be performed and that a value of zero should be provided in place of data read from memory for the input. So instead of reading the memory 115, a value of zero is sent on interconnect 127 in place of data read from memory for the predicated input location 355. This is represented by the print statement on lines 418-419 (acting as a placeholder for the hardware action).

After the kernel offset, output location, or input location have been calculated and sent to the address calculation unit 360 as represented by the print statement on lines 415-416 (acting as a placeholder for the hardware action), the accumulator counter 331 is incremented (line 420) and the inner output register 337 (w_out and h_out) and the inner input base register 333 (w_in_base and h_in_base) are updated as shown in lines 421-425. Note that for the 2D implementation shown, the first dimension of the inner output register 337 (w_out) is incremented and if it has exceeded its bound (output_size[w]), it is reset to zero and the second dimension of the inner output register 337 (h_out) is incremented. This may be implemented in hardware using two cascaded counters where the first dimension counter is a modulo output_size[w] counter and the second dimension counter is a modulo output_size[h] counter. The first dimension of the inner input base inner input base register 333 (w_in_base) is incremented by a stride amount 301 for the first dimension and if the first dimension of the inner output register 337 has exceeded its bound (output_size[w]), the first dimension of the inner input base register 333 (w_in_base) is reset to 0 and the second dimension of the inner input base register 333 (h_in_base) is incremented by a stride amount 301 for the second dimension. Note that bounds checking of the inner input base register 333 (w_in_base and h_in_base) does not need to be performed here as any input location generated using the value will be checked in line 413.

The method may also include incrementing the kernel element counter in response to the accumulator counter reaching the maximum accumulator count value, incrementing an inner input base register in response to a new input location being calculated, and loading the outer input base location register with the inner input base location in response to the kernel element counter wrapping back to the initial kernel count value. In some implementations, the method includes loading the outer input base location into the inner input base register in response to the kernel element counter wrapping back to the initial kernel count value, calculating the input location based on the inner input base location and the output of the kernel element counter, incrementing an inner output register in response to the accumulator counter incrementing and incrementing the inner output register in response to the accumulator wrapping back to the initial accumulator value, the inner output register to provide the output location, and loading the outer output base location into the inner output register in response to the kernel element counter wrapping back to the initial kernel count value.

Not shown in the pseudocode 400A, but included in the circuit 300, is the selection circuit 350 and address calculation unit 360. So, the method may include selecting, based on selection information from a selection register, either the kernel offset, the output location, or the input location as offset information for use in accessing a memory, and calculating a memory address based on the selected offset information.

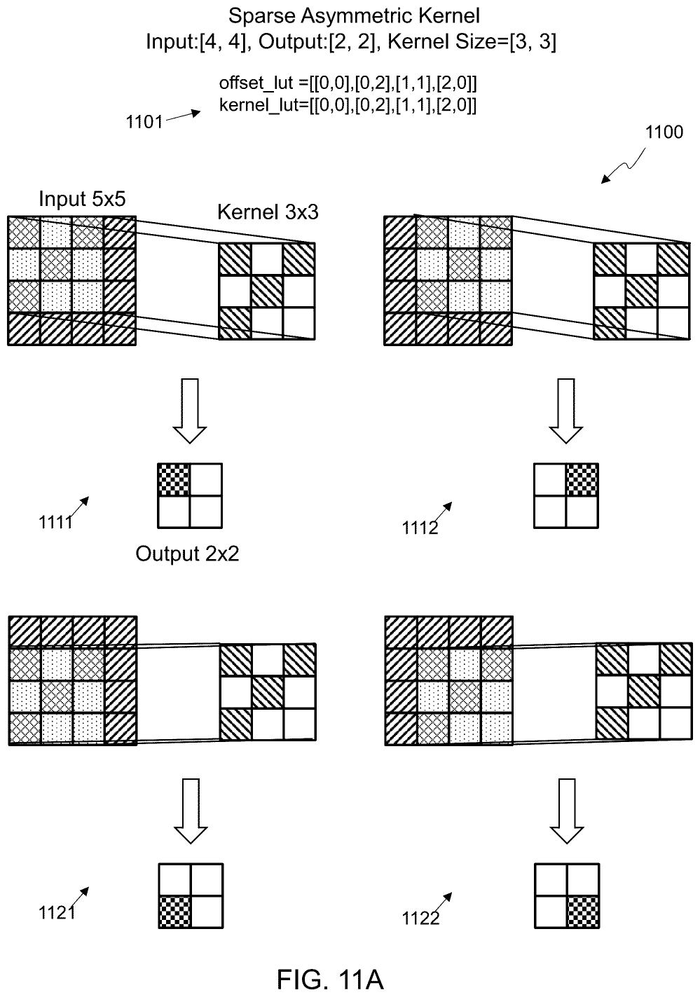

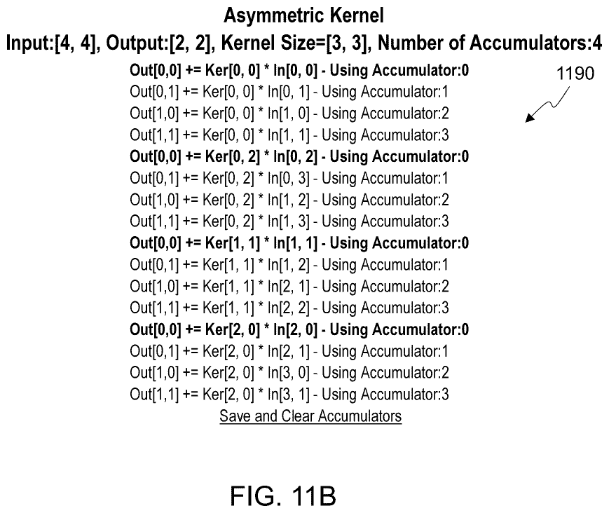

FIG. 4B is a pseudocode listing of operations for an alternative implementation 400B of the circuit to generate addresses for a convolution operation shown in FIG. 3 as well as operations for a compiler to generate configuration information for that implementation. The pseudocode 400B includes lines 411B-419B which can be substituted into the pseudocode 400A of FIG. 4A to replace lines 411-419 to create the alternative implementation. The alternative implementation includes an offset look-up table (LUT) in the input location calculation logic 335 that contains pre-computed input offsets based on the kernel element counter. The offset LUT may also include kernel offsets in some implementations. For the 2D implementation shown, the offset LUT includes a first dimension offset and a second dimension offset for each entry of the LUT. Using a common offset LUT with entries for each dimension that is indexed by a linear counter of kernel entries (k) that counts to num_kernel_entries allows for support of an asymmetric sparse kernel such as the one shown in FIG. 11A. If an implementation only supports symmetric kernels, then a separate offset LUT for each dimension that is indexed independently may be used in place of the common offset LUT. Lines 411B-412B show accessing the offset LUT using the output of the kernel element counter 321 to index into the LUTs for the two dimensions of convolution operation. The calculation of the input location 355 is shown in lines 411B-412B, where for each dimension, the kernel offset 353 (w_kernel_step or h_kernel_step) is used to access the offset_lut and its output is added to the inner input base location from the inner input base register 333 (w_in_base or h_in_base) to generate the input location 355 (w_in and h_in). The multiply using dilation and the subtraction using effective_pad are precomputed into the values stored in the offset_lut, thereby avoiding the cost of a hardware multiplier and adder for each dimension. Line 413B-414B are the same as line 413-414 but lines 415B-416B show that the kernel offset 353 may be accessed from a kernel_lut in some implementations.

Thus, a method for use in a convolution operation can include calculating the input location by indexing into an offset lookup table using the output of the kernel element counter 321 to obtain an input offset value, and adding a value of the inner input base register 333 to the input offset value. The method may also include generating the kernel offset 353 by indexing into the offset lookup table using the output of the kernel element counter 321 to obtain the kernel offset 353.

The pseudocode 450 shows the operations to build the kernel_lut and offset_lut in a compiler or other software to configure the circuit 300 to use fully populated kernel for a convolution having a dilation, integer stride, and effective pad. Other implementations may populate the LUTs using other techniques, such as to one to support an asymmetric sparse kernel like the one shown in FIG. 11A. Lines 451 and 452 initialize a list for the kernel_lut and offset_lut, respectively. Then for each of the two dimensions, a ‘for loop’ for each of the variables h_build and w_build is started in lines 453-454. The relative input offset is computed for the kernel offset determined by h_build and w_build and added to offset_lut as a new entry to the list. Note that the input offsets include the multiply by the dilation value and subtraction of the effective_pad value. The values of h_build and w_build are added to the kernel_lut list to represent the corresponding kernel offset. Note that in some implementations, the relative input offset and the kernel offset may be different fields in the same look-up table.

The values of the kernel_lut and offset_lut are then loaded into the hardware look-up tables in the circuit 300 at runtime. Although not explicitly shown in FIG. 3, they may be located in the kernel offset generator 323 and/or the inner location logic 330.

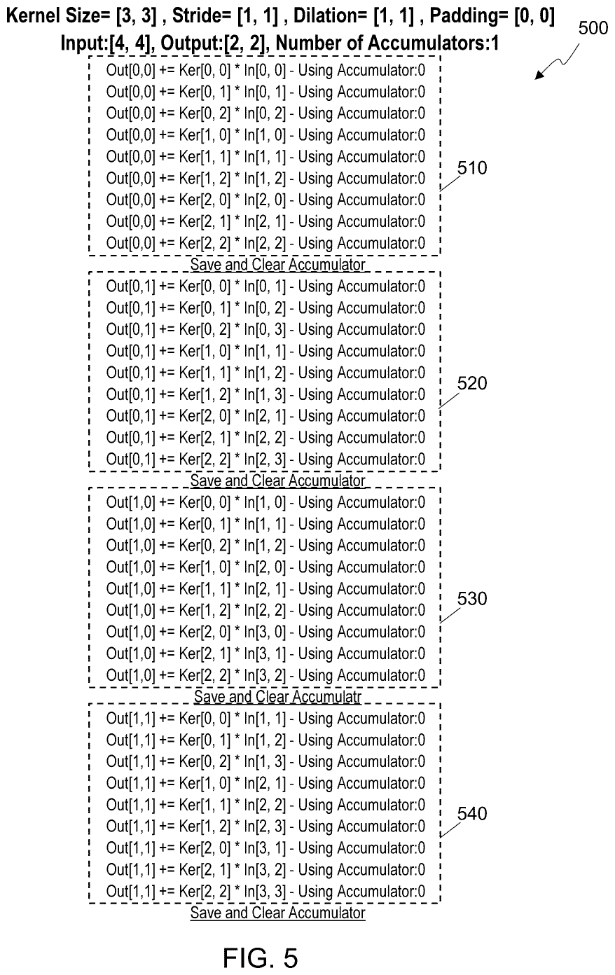

FIG. 5 is a listing of operations 500 that may be generated in an implementation of a convolution calculation engine 100 to perform the convolution operation shown in FIG. 2 using the circuit 300 shown in FIG. 3 to generate addresses for a convolution operation with a single accumulator. Because only a single MAC is used, calculation for only one output location can be performed at any one time. For the convolution operation shown, the input tensor is 4×4, the kernel size is 3×3, and the output size is 2×2 with stride and dilation of 1 in both dimensions and no padding.

In block 510, the kernel offsets and corresponding input locations for the calculation of Out(0,0) are shown. The first memory unit 110 generates the kernel offsets (e.g., Ker[0,0]) shown in block 510, uses them to generate addresses for the kernel elements corresponding to those kernel offsets, and sends them to the compute unit 140 in the order shown. Concurrent to that, the second memory unit 120 generates the input locations (e.g., In[0,0]) shown in block 510, uses them to generate addresses for the elements of the input tensor corresponding to those input locations, and sends them to the compute unit 140 in the order shown. The compute unit 140 performs a multiply-accumulate operation using all 9 kernel element/input tensor element pairs for Out(0,0) using the dataflow characteristics of the system to match the pairs appropriately, and then send the accumulated value for Out(0,0) to the third memory unit 130 which calculates the proper address for the Out(0,0) output element and stores the accumulated result in memory 135.

The process repeats for each output element with block 520 showing the kernel, input, and output locations for Out(0,1), block 530 showing the kernel, input, and output locations for Out(1,0), and block 540 showing the kernel, input, and output locations for Out(1,1).

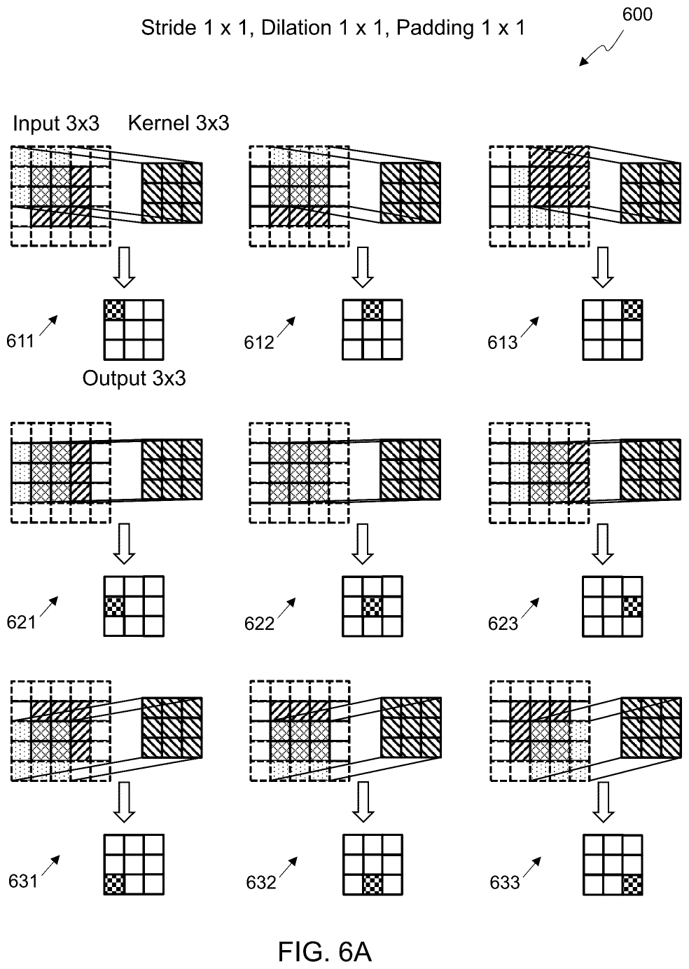

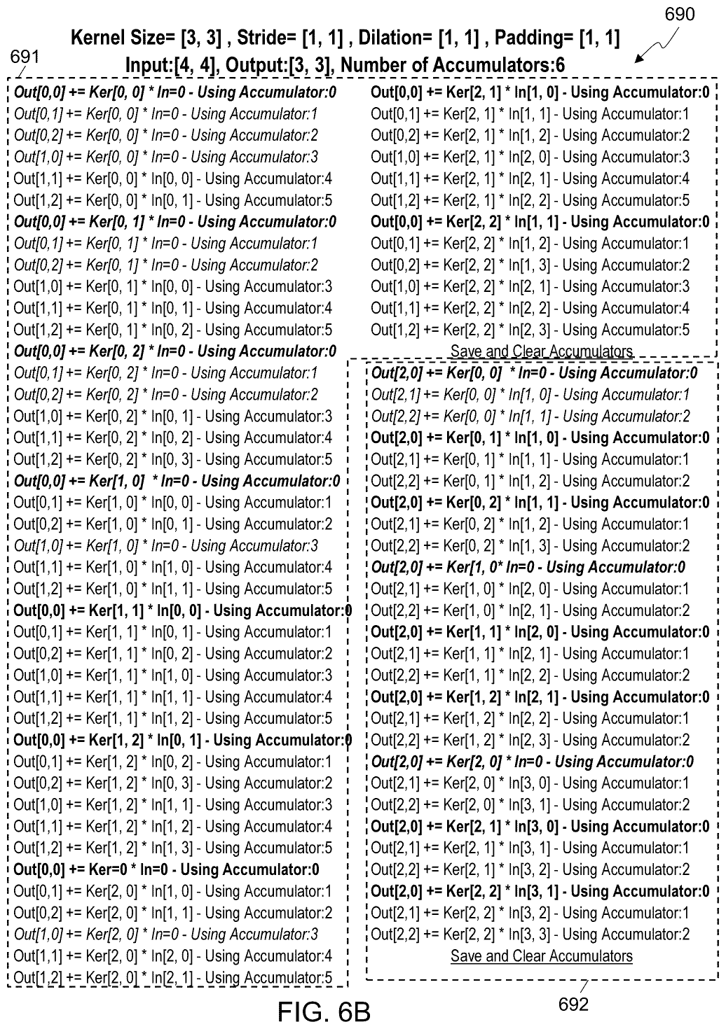

FIG. 6A provides a graphical illustration 600 of a 2D convolution operation with an effective padding hyperparameter of 1×1. The convolution operation has a stride of 1 in both the width and height dimension and a dilation of 1 in both the width and height dimension. The convolution operation uses a 3×3 kernel on a 3×3 input tensor to generate the 3×3 output. To generate the first output element at row 0 and column 0, the kernel is applied to the receptive field of the input extending into the padding as shown in diagram 611.

Note that in this figure, as well as other figures in this disclosure showing convolution operations, the kernel is shown with its elements filled with a pattern that slopes up and to the left, the elements of the input tensor that are not included in the receptive field are filled with a pattern that slopes up and to the right, the elements of the input tensor that are included in the receptive field and thus will be used in the dot product with elements of the kernel are shown in a cross-hatched fill, elements of the receptive field that are structurally set to zero (e.g. padding elements or elements created due to a fractional stride) are filled with a lightly stippled pattern, elements of the input tensor outside of the receptive field that are structurally set to zero (e.g. padding elements or elements created due to a fractional stride) are unfilled (as well as elements of the output vector not being calculated in a particular diagram), and the output element calculated is filled with a checkerboard pattern.

The generation of each of the 9 outputs is shown in diagrams 611-633 with the calculation of Out(0,0) graphically depicted in diagram 611, the calculation of Out(0,1) graphically depicted in diagram 612, and the calculation of Out(0,2) graphically depicted in diagram 613. The calculation of Out(1,0) is graphically depicted in diagram 621, the calculation of Out(1,1) is graphically depicted in diagram 622, and the calculation of Out(1,2) is graphically depicted in diagram 623. And lastly, the calculation of Out(2,0) is graphically depicted in diagram 631, the calculation of Out(2,1) is graphically depicted in diagram 632, and the calculation of Out(2,2) is graphically depicted in diagram 633.

FIG. 6B is a listing of operations 690 that may be generated in an implementation of a convolution calculation engine 100 to perform the convolution operation shown in FIG. 6A using the circuit 300 shown in FIG. 3 to generate addresses for a convolution operation while using 6 accumulators. Note that because 6 accumulators are used, calculations for 6 different output elements can be concurrently accumulated as shown in block 691. Operations using accumulator 0 are bolded to help clarify the pattern of usage of the different accumulators and their association with the output elements. In block 691, Out(0,0) is calculated using accumulator 0, Out(0,1) is calculated using accumulator 1, Out(0,2) is calculated using accumulator 2, Out(1,0) is calculated using accumulator 3, Out(1,1) is calculated using accumulator 4, and Out(1,2) is calculated using accumulator 5. Each accumulator accumulates 9 operations, so that they will finish in the same sequence in which they are started. Thus, there are 9 sets of 6 pairs of kernel offsets and input locations in block 691. Each set of 6 pairs uses the same kernel offset, with the first 6 pairs using Ker(0,0) the next 6 using Ker(0,1) and so on. This is due to the nested accumulator counter 331 within the kernel element counter 321 sequence in the circuit 300.

For the convolution of FIG. 6A, the padding means that some of the input locations are directed to locations outside of the input tensor, such as the first 4 pairs of the block 691. The input location calculation logic 335 of the circuit 300 detects this and adds a predicate to the input location informing the memory to omit the memory read and just return a value of 0 for that input location, as shown for the first 4 pairs by the “In=0” indication.

Once the 9 pairs of kernel/input have been multiplied and accumulated in each accumulator, those values are sent from the compute unit 140 to the third memory unit 130 for storage. The third memory unit uses the output address compute unit 132 to calculate the corresponding output address for each accumulated value and store the accumulated value in the memory 135. Note that if the common circuit 300 is used for the output address compute unit 132, setting num_kernel_entries to 1 will generate cause the circuit 300 to generate a single instance of each output location in the proper order.

Once the first six output elements have been calculated using the 6 accumulators, the final 3 output elements are calculated using 3 of the accumulators as shown in block 692, with Out(2,0) using accumulator 0, Out(2,1) using accumulator 1, and Out(2,2 using accumulator 2. This time 9 sets of three pairs of kernel/input as sent to the compute unit 140, which uses 3 of the accumulators to generate the dot products for the final three output elements. Once they are calculated the compute unit 140 sends the 3 results to the third memory unit 130 for storage.

Thus, in some implementations, the convolution calculation engine 100 includes a second MAC unit communicatively coupled to the memory units 110, 120, 130. The second MAC unit may be a part of a second compute unit or may be a second MAC in the compute unit 140. The kernel address compute unit 112, the input address compute unit 122, and the output address compute unit 132 in these implementations include an accumulator counter which is used to determine how many output calculations can occur concurrently. The first memory unit 110 is configured to calculate a first kernel memory address in the kernel address compute unit 112 based on the kernel offset during a first period where the accumulator counter has a first value, use the first kernel memory address to read a first kernel vector element from its memory array 115, and send the first kernel vector element over interconnect 117 to the first MAC unit 145. The second memory unit is configured to calculate a first input memory address in the input address compute unit 122 based on the input location during the first period, use the first input memory address to read a first input vector element from its memory array 125, and send the first input vector element over interconnect 127 to the first MAC unit 145. The first MAC unit 145 is configured to calculate a first dot product of the first kernel vector element and the first input vector element and accumulate a result of the first dot product with a previous value of an accumulator of the first MAC unit 145.

The second memory unit is further configured to calculate a second input memory address in the input address compute unit 122 based on the input location during a second period where the accumulator counter has a second value, use the second input memory address to read a second input vector element from its memory array 125, and send the second input vector element over interconnect 127 to the second MAC unit. The second MAC unit is configured to receive the first kernel vector element from the first MAC unit 145, calculate a second dot product of the first kernel vector element and the second input vector element, and accumulate a result of the second dot product with a previous value of an accumulator of the second MAC unit. The calculation of the second dot product in the second MAC unit at least partly overlaps in time with the calculation of the first dot product in the first MAC unit 145.

The first MAC unit is further configured to, after processing K kernel vector elements and K input vector elements where K is a number of active locations in a receptive field of an input for the convolution operation (e.g. K=9 in the example of FIG. 6B), send a first accumulated value from the accumulator of the first MAC unit 145 to the third memory unit 130. The second MAC unit is further configured to, after processing K kernel vector elements and K input vector elements, send a second accumulated value from the accumulator of the second MAC unit to the third memory unit 130. The third memory unit is configured to calculate a first output memory address in the output address compute unit 132 based on the output location during the first period and a second output memory address in the output address compute unit 132 based on the output location during the second period, use the first output memory address to store the first accumulated value received from the first MAC unit 145 in its memory array 135, and use the second output memory address to store the second accumulated value received from the second MAC unit in its memory array 135.

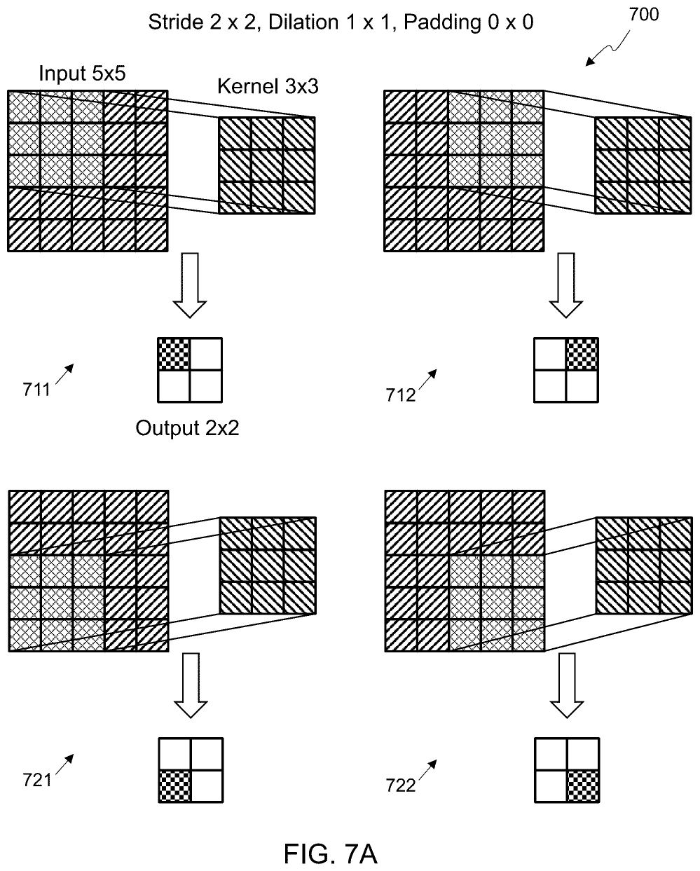

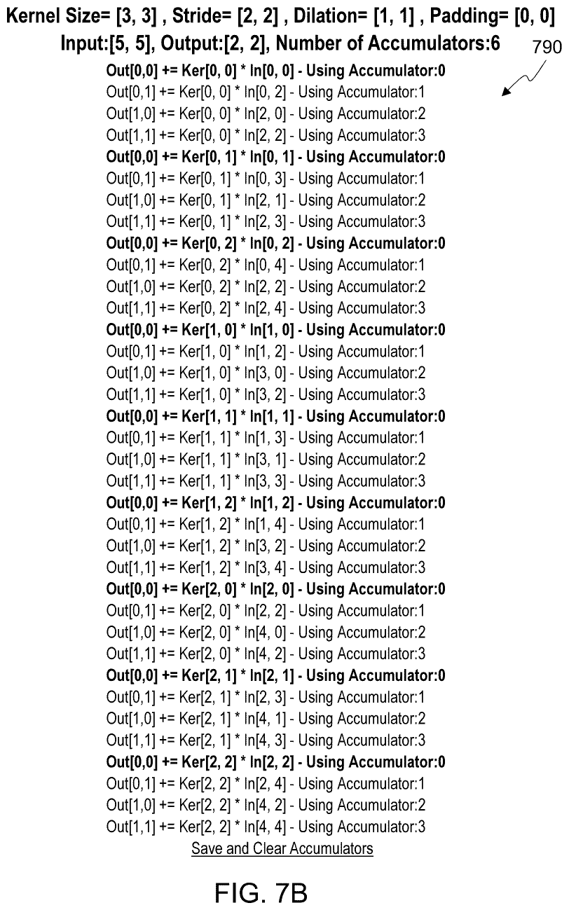

FIG. 7A provides a graphical illustration 700 of a 2D convolution operation with a stride hyperparameter of 2×2. The convolution operation has a dilation of 1 in both the width and height dimension and no effective padding. The convolution operation uses a 3×3 kernel on a 5×5 input tensor to generate the 2×2 output.

The generation of each of the 4 outputs is shown in diagrams 711-722 with the calculation of Out(0,0) graphically depicted in diagram 711, the calculation of Out(0,1) graphically depicted in diagram 712, and the calculation of Out(1,0) graphically depicted in diagram 721. The calculation of Out(1,1) is graphically depicted in diagram 722.

FIG. 7B is a listing of operations 790 that may be generated in an implementation of a convolution calculation engine 100 to perform the convolution operation shown in FIG. 7A using the circuit 300 shown in FIG. 3 to generate addresses for a convolution operation using 6 accumulators. Because the output has fewer elements than the circuit 300 has accumulators (in this example), all 4 outputs can be calculated concurrently, with 9 sets of 4 pairs of kernel/input elements being sent to the compute unit 140 to generate the output. Note that the 2×2 stride is properly accounted for in the generation of the input locations with the receptive field of the input tensor for Out(1,1) being 2 elements to the right and down as compared to the receptive field of the input tensor for Out(0,0).

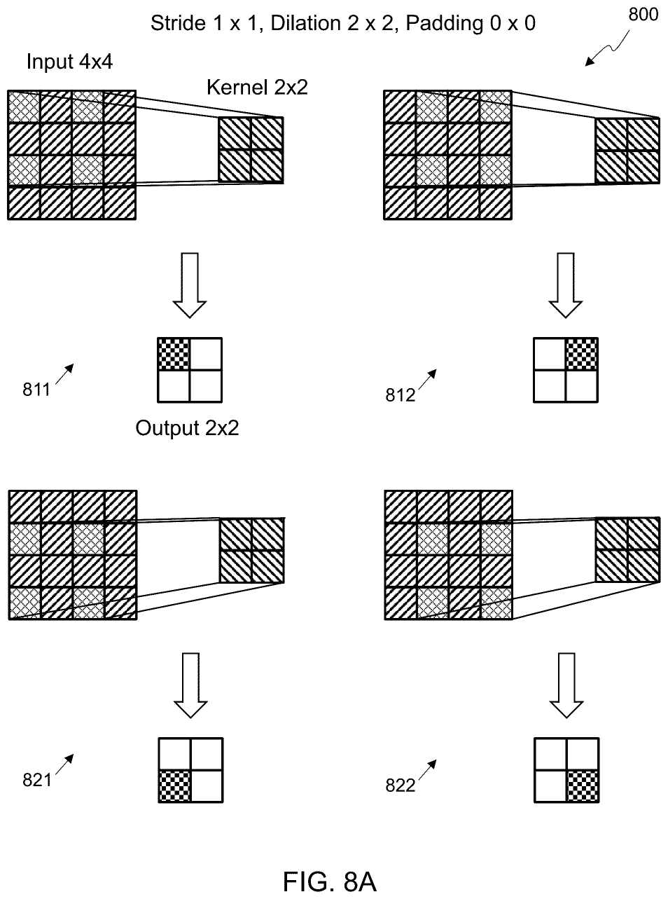

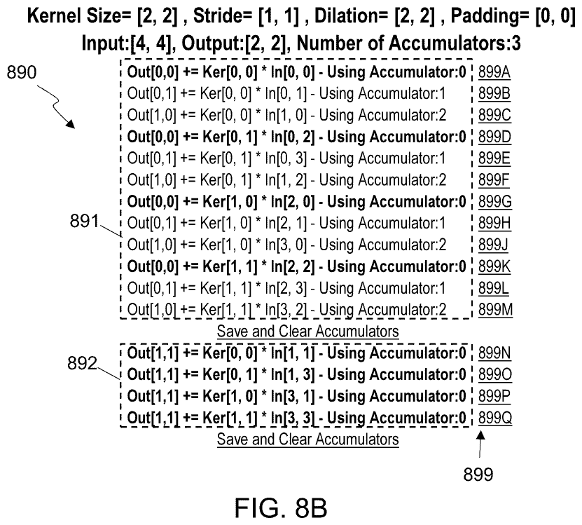

FIG. 8A provides a graphical illustration 800 of a 2D convolution operation with a dilation hyperparameter of 2×2. The convolution operation has a stride of 1 in both the width and height dimension and no effective padding. The convolution operation uses a 2×2 kernel on a 4×4 input tensor to generate the 2×2 output.

The generation of each of the 4 outputs is shown in diagrams 811-822 with the calculation of Out(0,0) graphically depicted in diagram 811, the calculation of Out(0,1) graphically depicted in diagram 812, and the calculation of Out(1,0) graphically depicted in diagram 821. The calculation of Out(1,1) is graphically depicted in diagram 822. Note that the 2×2 dilation distributes the kernel over a wider receptive field of the input tensor, with some of the elements of the receptive field not used in the calculation of the output.

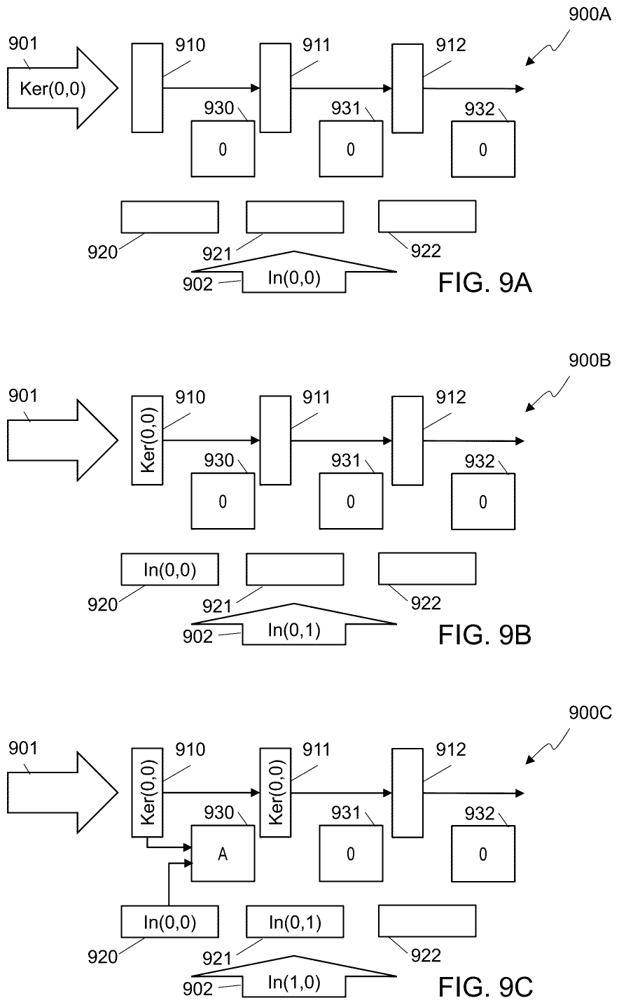

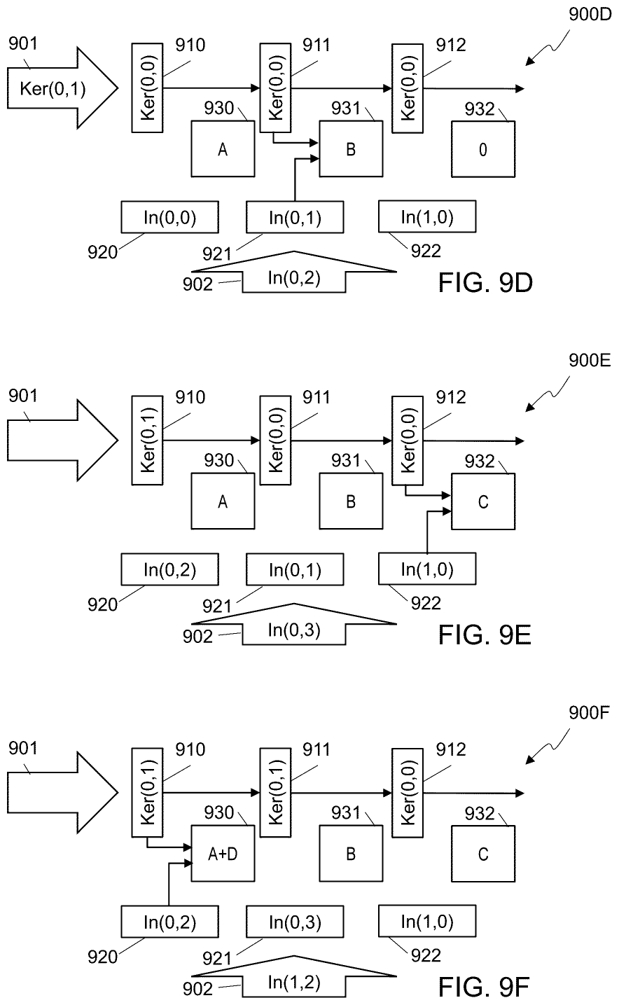

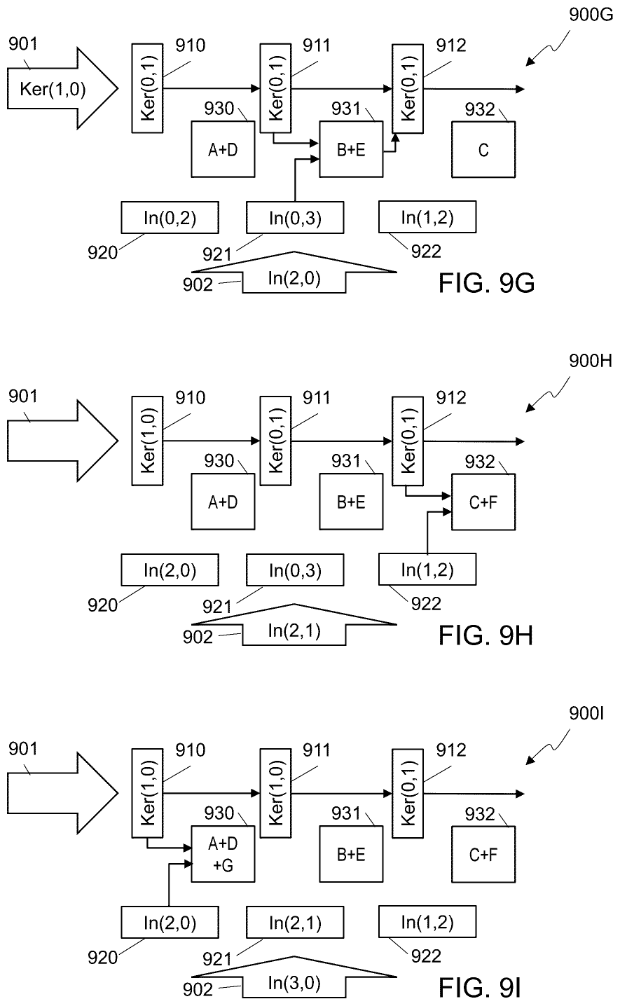

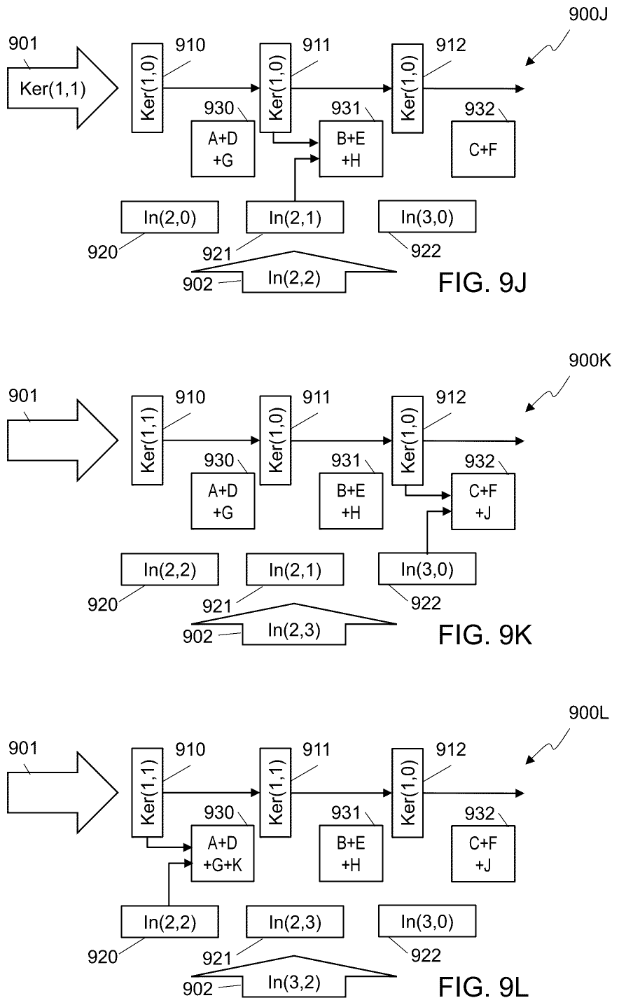

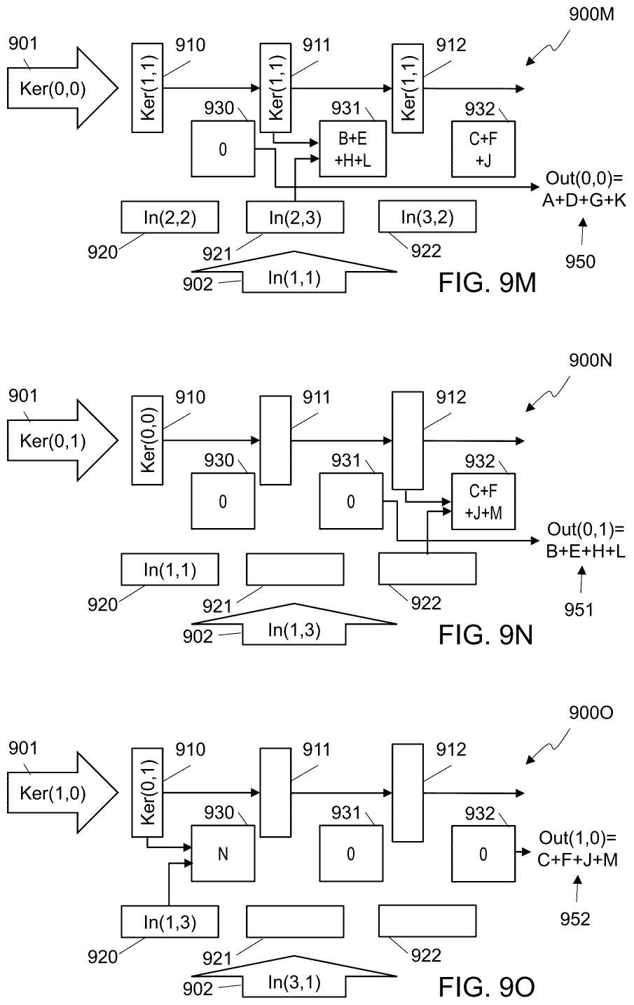

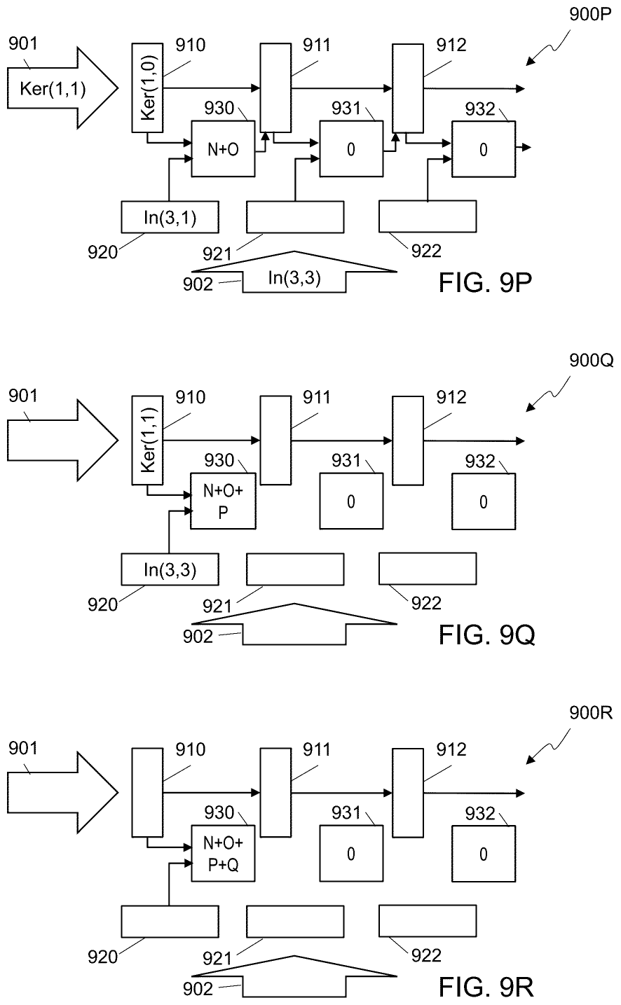

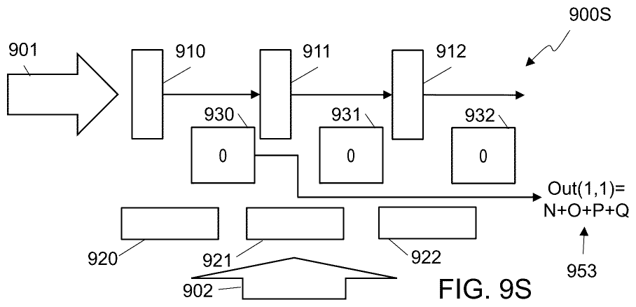

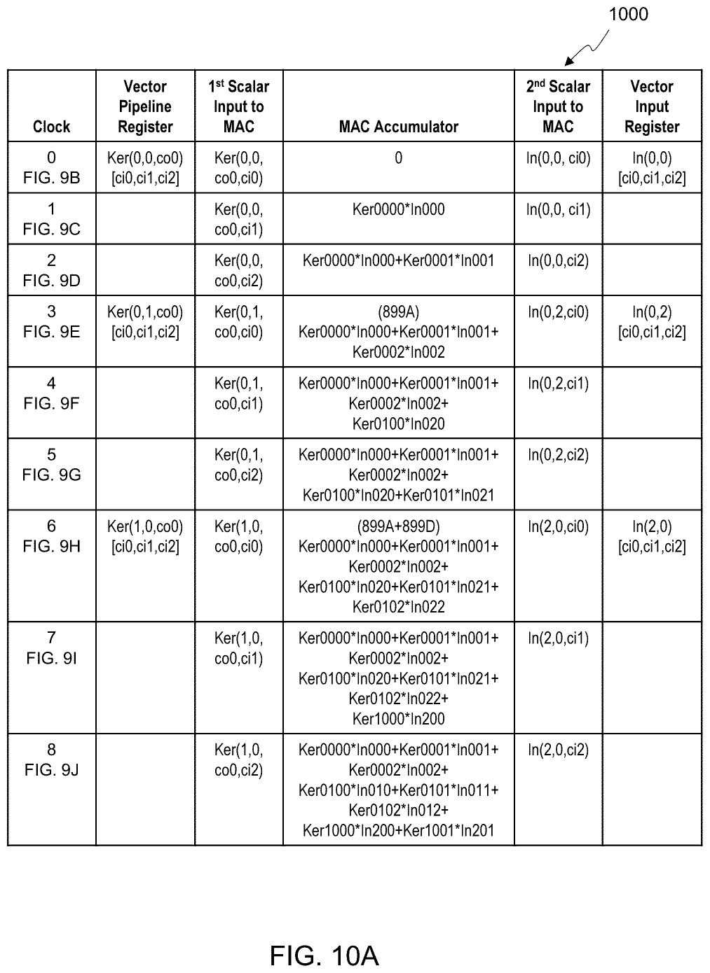

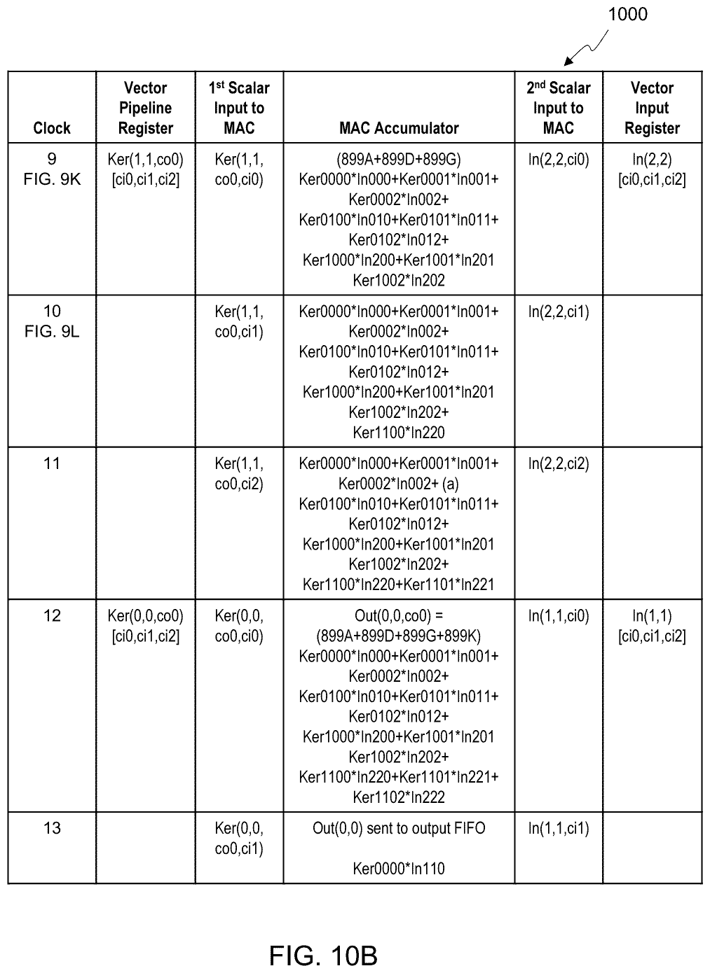

FIG. 8B is a listing of operations 890 that may be generated in an implementation of a convolution calculation engine 100 to perform the convolution operation shown in FIG. 8A using the circuit 300 shown in FIG. 3 to generate addresses for a convolution operation using 3 accumulators. The first block 891 shows the 4 sets of 3 pairs of kernel/input elements being sent to the compute unit 140 to generate the Out(0,0), Out(0,1), and Out(1,0). The reason that only 3 pairs of kernel/input elements are sent for each set is that only 3 accumulators are used in this example. Block 892 shows 4 sets of 1 pair of kernel/input elements sent to generate Out(1,1). Note that the 2×2 dilation is properly accounted for in the generation of the input locations with the receptive field of the input tensor skipping elements. Each line of the listing is given a designator 899A-899Q (skipping 899“I” for clarity). The letter designators (without the “899” number) are used in FIGS. 9A-9S to refer to a specific multiply-accumulate operation.

FIGS. 9A-9S provide a graphical illustration over time of an implementation of a pipeline of 3 multiply-accumulate circuits (MACs) in a compute unit similar to the compute unit 140 of FIG. 1 but with three MACs to perform the convolution operation shown in FIG. 8A. While the compute unit 140 is shown with only a single MAC 145, various implementations can include any number of pipelined MACs, such as the three pipelined MACs 930, 931, 932 shown in each of FIGS. 9A-9S. Referring to FIG. 9A (but the description applying equally to FIGS. 9B-9S), the compute unit includes a first input 901 and a second input 902. In some implementations, the inputs 901, 902 may be vector inputs and may include FIFO buffers to allow inputs to be received and buffered before their use.

The compute unit of FIG. 9A also includes a set of pipeline registers, including a first pipeline register 910, a second pipeline register 911, and a third pipeline register 912. The pipeline registers 910, 911, 912 may be vector pipeline registers in some implementations. The pipeline registers 910, 911, 912 may have various interconnections, but they at least allow data from the first input 901 to be loaded into the first pipeline register 910, data from the first pipeline register 910 to be loaded into the second pipeline register 911, and data from the second pipeline register 911 to be loaded into the third pipeline register 912 in a pipelined fashion. They may also be configured to hold their current contents at some times, without pipelining.

The compute unit of FIG. 9A also includes a set of input registers, including a first input register 920, a second input register 921, and a third input register 922. The input registers 920, 921, 922 may be vector pipeline registers in some implementations. The input registers 920, 921, 922 may have various interconnections, but they at least allow data from the second input 902 to be selectively loaded into any one of the input registers 920, 921, 922. They may also be configured to hold their current contents at some times, without storing data from the second input 902.

The compute unit of FIG. 9A includes a set of MACs, including a first MAC 930, a second MAC 931, and a third MAC 932. The MACs 930, 931, 932 may be specialized MAC units or may be a part of a more general purpose arithmetic logic unit (ALU) configured to perform a MAC operation. The MACs 930, 931, 932 may be configurable to accept a first input from its respective pipeline register 912, 911, 921, and a second input from its respective input register 920, 921, 922. In cases where the pipeline registers 912, 911, 921 and input registers 920, 921, 922 are vector registers, the MACs 930, 931, 932 may be configurable to accept a specific lane of the vector as its input. In some implementations, the compute unit may include multiple rows of MACs that can be coupled to different lanes of the vector pipeline registers to support further parallelism.

Referring now to the sequence of FIGS. 9A-9S showing the computation of the convolution operation of FIGS. 8A and 8B, FIG. 9A shows the compute unit 900A at a time where the first kernel element, Ker(0,0), has been received on the first input 901, and first input element, In(0,0) have been received on the second input 902. This corresponds to the kernel element and the input element used in operation 899A of FIG. 8B. Note that for implementations where the compute unit includes FIFOs on its inputs 901, 902, any number of additional inputs may have already been received and buffered in the FIFOs. This is fine as long as the order in which they are sent by the respective memory units is maintained as they are consumed by the compute unit.

At the time shown in FIG. 9B, the first kernel element, Ker(0,0), has been loaded from the first input 901 into the first pipeline register 910 and the first input element, In(0,0), has been loaded from the second input 902 into the first input register 920 in the compute unit 900B. The next input element, In(0,1), has also been received on the second input 902.

At the time shown in FIG. 9C, the first kernel element, Ker(0,0), has been loaded into the second pipeline register 911 from the first pipeline register 910 (while leaving the first kernel element in the first pipeline register 910) and the second input element, In(0,1), has been loaded from the second input 902 into the second input register 921 in the compute unit 900C. The next input element, In(1,0), has been received on the second input 902. The first MAC 930 has also computed the value of Ker(0,0)*In(0,0) and accumulated it into its accumulator (which was previously 0) as shown in line 899A of FIG. 8B and indicated with the “A” in the first MAC 930.

At the time shown in FIG. 9D, the kernel element, Ker(0,0), has been loaded into the third pipeline register 912 from the second pipeline register 911 (without disturbing the contents of the first pipeline register 910 and the second pipeline register 911) and the input element, In(1,0), has been loaded from the second input 902 into the third input register 922 in the compute unit 900D. The next kernel element, Ker(0,1), has been received on the first input 901 and the next input element, In(0,2), has been received on the second input 902. The second MAC 931 has computed the value of Ker(0,0)*In(0,1) and accumulated it into its accumulator (which was previously 0) as shown in line 899B of FIG. 8B and indicated with the “B” in the second MAC 931.

At the time shown in FIG. 9E, the kernel element, Ker(0,1), has been loaded into the first pipeline register 910 from the first input 901 and the input element, In(0,2), has been loaded from the second input 902 into the first input register 920 in the compute unit 900E. The next input element, In(0,3), has been received on the second input 902. The third MAC 932 has also computed the value of Ker(0,0)*In(1,0) and accumulated it into its accumulator (which was previously 0) as shown in line 899C of FIG. 8B and indicated with the “C” in the third MAC 932.

At the time shown in FIG. 9F, the kernel element, Ker(0,1), has been loaded into the second pipeline register 911 from the first pipeline register 910 and the input element, In(0,3), has been loaded from the second input 902 into the second input register 921 in the compute unit 900F. The next input element, In(1,2), has been received on the second input 902. The first MAC 930 has also computed the value of Ker(0,1)*In(0,2) and accumulated it into its accumulator (which was previously the value of 899A) as shown in line 899D of FIG. 8B and indicated with the “A+D” in the first MAC 930.

At the time shown in FIG. 9G, the kernel element, Ker(0,1), has been loaded into the third pipeline register 912 from the second pipeline register 911 and the input element, In(1,2), has been loaded from the second input 902 into the third input register 922 in the compute unit 900G. The next kernel element, Ker(1,0), has been received on the first input 901 and the next input element, In(2,0), has been received on the second input 902. The second MAC 931 has computed the value of Ker(0,1)*In(0,3) and accumulated it into its accumulator (which was previously the value of 899B) as shown in line 899E of FIG. 8B and indicated with the “B+E” in the second MAC 931.

At the time shown in FIG. 9H, the kernel element, Ker(1,0), has been loaded into the first pipeline register 910 from the first input 901 and the input element, In(2,0), has been loaded from the second input 902 into the first input register 920 in the compute unit 900H. The next input element, In(2,1), has been received on the second input 902. The third MAC 932 has also computed the value of Ker(0,1)*In(1,2) and accumulated it into its accumulator (which was previously the value of 899C) as shown in line 899F of FIG. 8B and indicated with the “C+F” in the third MAC 932.

At the time shown in FIG. 9I, the kernel element, Ker(1,0), has been loaded into the second pipeline register 911 from the first pipeline register 910 and the input element, In(2,1), has been loaded from the second input 902 into the second input register 921 in the compute unit 900I. The next input element, In(3,0), has been received on the second input 902. The first MAC 930 has also computed the value of Ker(1,0)*In(2,0) and accumulated it into its accumulator (which was previously the value of 899A+899D) as shown in line 899G of FIG. 8B and indicated with the “A+D+G” in the first MAC 930.

At the time shown in FIG. 9J, the kernel element, Ker(1,0), has been loaded into the third pipeline register 912 from the second pipeline register 911 and the input element, In(3,0), has been loaded from the second input 902 into the third input register 922 in the compute unit 900J. The next kernel element, Ker(1,1), has been received on the first input 901 and the next input element, In(2,2), has been received on the second input 902. The second MAC 931 has computed the value of Ker(1,0)*In(2,1) and accumulated it into its accumulator (which was previously the value of 899B+899E) as shown in line 899H of FIG. 8B and indicated with the “B+E+H” in the second MAC 931.

At the time shown in FIG. 9K, the kernel element, Ker(1,1), has been loaded into the first pipeline register 910 from the first input 901 and the input element, In(2,2), has been loaded from the second input 902 into the first input register 920 in the compute unit 900K. The next input element, In(2,3), has been received on the second input 902. The third MAC 932 has also computed the value of Ker(1,0)*In(3,0) and accumulated it into its accumulator (which was previously the value of 899C+899F) as shown in line 899J of FIG. 8B and indicated with the “C+F+J” in the third MAC 932.

At the time shown in FIG. 9L, the kernel element, Ker(1,1), has been loaded into the second pipeline register 911 from the first pipeline register 910 and the input element, In(2,3), has been loaded from the second input 902 into the second input register 921 in the compute unit 900L. The next input element, In(3,2), has been received on the second input 902. The first MAC 930 has also computed the value of Ker(1,1)*In(2,2) and accumulated it into its accumulator (which was previously the value of 899A+899D+899G) as shown in line 899K of FIG. 8B and indicated with the “A+D+G+K” in the first MAC 930.

At the time shown in FIG. 9M, the first output element, Out(0,0) 950, is sent from the accumulator in the first MAC 930 to the third memory unit 130 for storage. The accumulator of first MAC 930 is also cleared to have a 0 value. The kernel element, Ker(1,1), has been loaded into the third pipeline register 912 from the second pipeline register 911 and the input element, In(3,2), has been loaded from the second input 902 into the third input register 922 in the compute unit 900M. The second MAC 931 has also computed the value of Ker(1,1)*In(2,3) and accumulated it into its accumulator (which was previously the value of 899B+899E+899H) as shown in line 899L of FIG. 8B and indicated with the “B+E+H+L” in the second MAC 931.

At the time shown in FIG. 9N, the second output element, Out(0,1) 951, is sent from the accumulator in the second MAC 931 to the third memory unit 130 for storage. The accumulator of second MAC 931 is also cleared to have a 0 value. The third MAC 932 has also computed the value of Ker(1,1)*In(3,2) and accumulated it into its accumulator (which was previously the value of 899C+899F+899J) as shown in line 899M of FIG. 8B and indicated with the “C+F+J+M” in the third MAC 932. And, at the time shown in FIG. 9O, the third output element, Out(1,0) 952, is sent from the accumulator in the third MAC 932 to the third memory unit 130 for storage and the accumulator of the third MAC 932 cleared.

In some implementations, the input pipeline may be paused to let each of the accumulators finish their calculations and to send each of the outputs from the MACs to the third memory unit 130 as discussed above before accepting inputs for the next round of accumulations. But in other implementations, such as the one shown in FIGS. 9A-9S, inputs for the next set of accumulations may be received while the accumulation for the previous set of outputs is completing. So, also at the time shown in FIG. 9M, The first kernel element, Ker(0,0), has been received again on the first input 901 and the next input element, In(1,1), has been received on the second input 902 of the compute unit 900M.

Also at the time shown in FIG. 9N, the kernel element, Ker(0,0), has been loaded into the first pipeline register 910 from the first input 901 and the input element, In(2,2), has been loaded from the second input 902 into the first input register 920 in the compute unit 900K. Note that because the number of output elements is not equally divisible by the number of accumulators used, the final set of accumulations does not use all three accumulators. Only one accumulator is used to calculate the final output, Out(2,2), as can be seen in block 892 of FIG. 8B. The kernel element, Ker(0,1), has been received on the first input 901 and the input element, In(1,3), has been received on the second input 902. Note that because the second and third pipeline registers 911, 912 and the second and third input registers 921, 922 will not be used for the final set of accumulations, no value is provided for them in FIGS. 9N-9S. They may retain a previous value or may be set to any other value, depending on the implementation.

At the time shown in FIG. 9O, the first MAC 930 has computed the value of Ker(0,0)*In(1,1) and accumulated it into its accumulator (which was previously cleared to 0) as shown in line 899N of FIG. 8B. At the same pipeline clock, the kernel element, Ker(0,1), was loaded into the first pipeline register 910 and the input element, In(1,3), was loaded from the second input 902 into the first input register 920 in the compute unit 9000. The kernel element, Ker(1,0), and the input element, In(3,1), are also respectively available from the first input 901 and the second input 902.

At the time shown in FIG. 9P, the first MAC 930 has computed the value of Ker(0,1)*In(1,3) and accumulated it into its accumulator (which previously had a value of 899N) as shown in line 899O of FIG. 8B. The kernel element, Ker(1,0), has been loaded into the first pipeline register 910 and the input element, In(3,1), has been loaded from the second input 902 into the first input register 920 in the compute unit 900P. The final kernel element, Ker(1,1), and the final input element, In(3,3), are also respectively available from the first input 901 and the second input 902.

At the time shown in FIG. 9O, the first MAC 930 has computed the value of Ker(1,0)*In(3,1) and accumulated it into its accumulator (which previously had a value of 899N+899O) as shown in line 899P of FIG. 8B. The kernel element, Ker(1,1), has been loaded into the first pipeline register 910 and the input element, In(3,3), has been loaded from the second input 902 into the first input register 920 in the compute unit 900Q.

At the time shown in FIG. 9R, the first MAC 930 of compute unit 900R has computed the value of Ker(1,1)*In(3,3) and accumulated it into its accumulator (which previously had a value of 899N+899O+899P) as shown in line 899Q of FIG. 8B. and in FIG. 9S, the final output element, Out(1,1) 953, is sent from the accumulator in the first MAC 930 of the compute unit 900S to the third memory unit 130 for storage.

FIGS. 10A and 10B show a table 1000 providing more detail of the operation of the first MAC 930 shown in FIGS. 9A-9S performing the convolution operation shown in FIG. 8A for an implementation where the input tensor has multiple components per element. In the example shown in FIGS. 9A-9S, the input tensor, the kernel, and the output had only one component. In that example, the limiting factor for the speed of the computation was the bandwidth of interconnect 127 for sending the input tensor from the second memory unit 120 to the compute unit, because there is one multiply per input tensor element, so the full bandwidth of the three MACs cannot be utilized.

For the purposes of the example shown in FIG. 10A-10B, the input tensor has three components (ci0, ci1, ci2) for each element of the tensor and all three components of an element of the input tensor can be sent simultaneously from the second memory unit 120 of FIG. 1 over interconnect 127 to the compute unit. The kernel has the two dimensions shown in FIG. 8A, but there is a separate kernel for each output component to be computed (where the output has multiple components) and there is a separate kernel value to be used for each input component. All three components of an element of the kernel for a specific output component can be send simultaneously from the first memory unit 110 of FIG. 1 over interconnect 117 to the compute unit 140 concurrently with all three components of an element of the input tensor being sent simultaneously from the second memory unit 120 over interconnect 127 to the compute unit 140. This can be said to vectorize the channels/components of the kernel and input tensor. Thus, to calculate the first value of Ker(0,0)*In(0,0) as shown on line 899A of FIG. 8B, three multiply-accumulate operations are required:

Ker(0,0,co0,ci0)*In(0,0,ci0)+Ker(0,0,co0,ci1)*In(0,0,ci1)+Ker(0,0,co0,ci2)*In(0,0,ci2)

where the first two indices are the two dimensions of the kernel/input tensor shown in FIG. 8A, the final index is the input component, and the kernel has another index for the output component. Because there are now three multiplies required for every input element, it is possible to more fully utilize the bandwidth of the multipliers. In some implementations, the computation may be vectorized as well.

The table 1000 has five columns. The first column is for a clock counter. In various implementations, the actual execution clock may correspond to the relative clock numbers shown, but in others the clock shown may be slower clock than the actual execution clock of the circuit, or the clocks shown may represent specific enables on the execution clock. Also shown in the first column is a corresponding figure of FIGS. 9A-9S where applicable. While the details of the MAC operation are different between FIG. 9A-9S and the table 1000, the operation of the first pipeline register 910 and the first input register 920 are the same, at least for the first few clock cycles.

The second column labeled “Vector Pipeline Register” shows new data clocked into the first pipeline register 910 of FIGS. 9A-9S and the third column labeled “1^{st} Scalar Input to MAC” shows the scalar data from the first pipeline register 910 selected to be sent to an input of the first MAC 930. The far right column labeled “Vector Input Register” shows new data clocked into the first input register 920 and the second column from the right labeled “2^{nd} Scalar Input to MAC” shows the scalar data from the first input register 920 selected to be sent to another input of the first MAC 930. The column labeled “MAC Accumulator” shows the value of the accumulator in the first MAC 930. In the table 1000, the square brackets (i.e. “[” and “]”) indicate vector data that is included in a vector register and parentheses indicate indices of the kernel or input tensor. In the MAC accumulator column, the parentheses for the indices and commas between the indices have been omitted to save space.

Starting with the row of table 1000 for clock 0 which corresponds to FIG. 9B, the first kernel element, including components corresponding to each component of the input tensor, are loaded into the first vector pipeline register 910, and the first input element, including each component, are loaded into the first vector input register 920. The row also shows that the kernel value for the input component ci0 is selected as the first scalar input to the MAC and component ci of the input element is selected as the second scalar input to the MAC. The computation shown in table 1000 is for one output component (co0). In various implementations, other output components (coX) using the kernel for those output components, may be calculated serially after the computation for the output component co0 or may be calculated in parallel using another compute unit or in additional lanes of MACs in the same compute unit.

The row for clock 1 corresponds to FIG. 9C, but with the difference that a first partial calculation for the input component ci0 for the calculation shown as line 899A of FIG. 8B is accumulated into the MAC 930 instead of the full computation of Ker(0,0)*In(0,0) due to having multiple input components. Note that to save space, the indices for the kernel and input are listed without parentheses or commas in the MAC Accumulator column. In addition, the kernel value for input component ci1 is selected for the first input to the MAC and the value for the input component ci1 is selected for the second input to the MAC. In the row for clock 2, which corresponds to FIG. 9D (except for the detailed behavior of the MAC), a partial calculation for the input component ci1 is accumulated in the MAC 930 and the kernel and input elements for ci2 are selected as inputs to the MAC.

In the row for clock 3 (roughly corresponding to FIG. 9E), the MAC 930 accumulates the final partial value for ci2 so that the accumulator holds the value shown in line 899A of FIG. 8B. In addition, the next vector kernel element (all three values for the three input components for Ker(0,1) for co0) is loaded into the first vector pipeline register 910 with the value for ci0 selected as the first input for the MAC and the next input element (with all three input components) is loaded into the first input register 920 with the value for ci0 selected as the second input for the MAC. The row for clock 4 (roughly corresponding to FIG. 9F) shows the accumulation of that kernel element and input element for ci0 into the MAC 930 and the selection of ci1 for the MAC inputs. Similarly, the row for clock 5 (roughly corresponding to FIG. 9G) shows the accumulation of Ker(0,1,co0,ci1)*In(0,2,ci1) into the MAC 930 and the selection of ci2 for the MAC inputs. The full accumulation of the value of rows 899A and 899D from FIG. 8B is done in the row for clock 6.

Ker(1,0) and In(2,0) are respectively loaded into the first pipeline register 910 and the first input register 920 at clock 6 with similar behavior during clocks 7-9 to accumulate the value for line 899G into the accumulator of MAC 930 as was shown in for the calculation of the value for line 899D during clocks 4-6. Similarly, Ker(1,1) and In(2,2) are respectively loaded into the first pipeline register 910 and the first input register 920 at clock 9 with similar behavior during clocks 10-12 to accumulate the value for line 899K and generate the final value for Out(0,0), which can then be put into an output FIFO at to be sent to the third memory unit 930.

Note that starting at clock 11, the example in table 1000 diverges from the example of FIGS. 9M-9S. In the single component example, the calculation of the final output, Out(2,2), can be done in 4 pipeline cycles after loading the first kernel/input pair into the pipeline and input registers. In the 3 input component example in table 1000, the calculation of Out(2,2) requires 12 clock cycles, the first two of which are shown in the rows for clock 12 and 13 in table 1000. Also, the final calculation of the first output, Out(0,0), requires 2 additional clock cycles, so while Out(0,0) is sent out in FIG. 9M (which would be equivalent to clock 11), it is not sent out in table 1000 until the 13^{th} clock cycle.

One of ordinary skill can see that while table 1000 only shows the operation of the first accumulator 930, the second stage of the pipeline using the second pipeline register 911, the second input register 921, and the second MAC 931, as well as the third stage of the pipeline using the third pipeline register 912, the third input register 922, and the third MAC 932, can operate in conjunction with the first stage as shown in FIGS. 9A-9S allowing for concurrent calculation of one output per accumulator with very high utilization of the MACs.

FIG. 11A provides a graphical illustration 1100 of a 2D convolution operation with a sparse asymmetric kernel. The convolution operation uses a 3×3 kernel on a 5×5 input tensor to generate the 2×2 output with dilation and stride of 1 in both dimensions and no padding.

The generation of each of the 4 outputs is shown in diagrams 1111-1122 with the calculation of Out(0,0) graphically depicted in diagram 1111, the calculation of Out(0,1) graphically depicted in diagram 1112, and the calculation of Out(1,0) graphically depicted in diagram 1121. The calculation of Out(1,1) is graphically depicted in diagram 1122.

Pairs of input tensor elements and kernel elements are shown as lookup table entries 1101 for use with an implementation of the circuit 300 using the lookup tables described in FIG. 4B. Note that because the zero values of the kernel are specific for this kernel and not structural due to the hyperparameters of the convolution operation, the lookup tables would need to be custom generated for the specific kernel; the code 450 shown in FIG. 4B could not be used to generate the LUTs in this example.

FIG. 11B is a listing of operations 1190 that may be generated in an implementation of a convolution calculation engine 100 to perform the convolution operation shown in FIG. 11A using the circuit 300 shown in FIG. 3 to generate addresses for a convolution operation using a look-up table and having 4 accumulators. The lookup table is populated with the values 1101 shown in FIG. 11A. The operations 1190 include 4 sets of 4 pairs of kernel/input offsets each, allowing or concurrent calculation of the 4 outputs in the four accumulators. Even though the kernel is nominally 3×3, which would lead to 9 multiplies per component using the circuit 300 configured to act like the pseudocode 400A of FIG. 4A, only 4 multiplies are performed for each output corresponding to the 4 non-zero elements of the kernel. This is accomplished by pre-calculating the relative input offset values to use for the offset_lut and the kernel offset values to use for the kernel_lut and providing the circuit 300 with the number of non-zero values (as num_kernel_entries) to use for the convolution operation. Alternatively, to support such kernels, the kernel may be stored without the zero values and the kernel_lut left out of the design, to just use the kernel values in the order that they are stored for calculation with the input values calculated using the offset_lut.

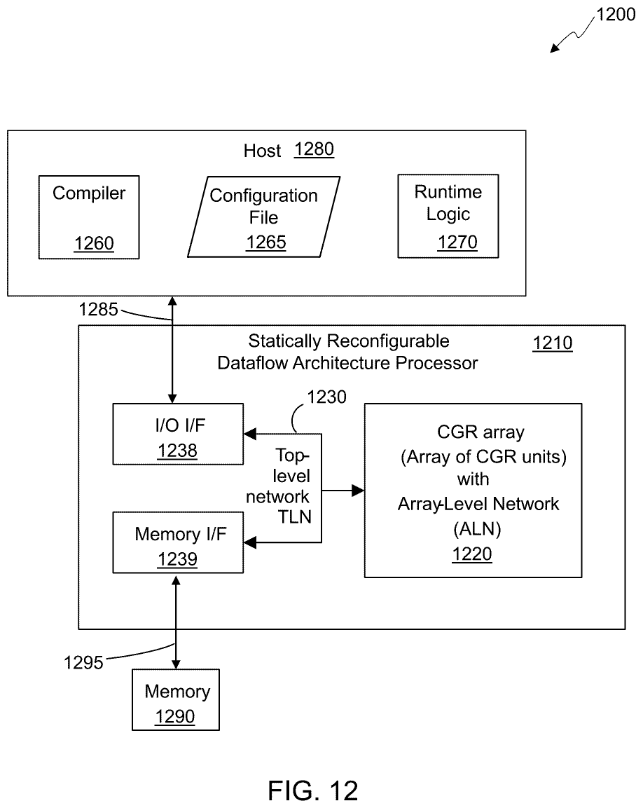

FIG. 12 illustrates an example system 1200 including a statically reconfigurable dataflow architecture processor 1210, a host 1280, and a memory 1290. The statically reconfigurable dataflow architecture processor 1210 has a coarse-grained reconfigurable architecture (CGRA) and includes an array of CGR units 1220 such as a CGR array. The statically reconfigurable dataflow architecture processor 1210 further includes an I/O interface 1238, and a memory interface 1239. The array of CGR units 1220 is coupled with I/O interface 1238 and memory interface 1239 via data bus 1230 which may be part of a top-level network (TLN). Host 1280 communicates with I/O interface 1238 via system data bus 1285, and memory interface 1239 communicates with memory 1290 via memory bus 1295. The array of CGR units 1220 may further include compute units and memory units that are coupled together with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of the statically reconfigurable dataflow architecture processor 1210. In some implementations, the statically reconfigurable dataflow architecture processor 1210 may include one or more ICs. In other implementations, a single IC may span multiple statically reconfigurable dataflow architecture processors. In further implementations, statically reconfigurable dataflow architecture processor 1210 may include one or more units of array of CGR units 1220.

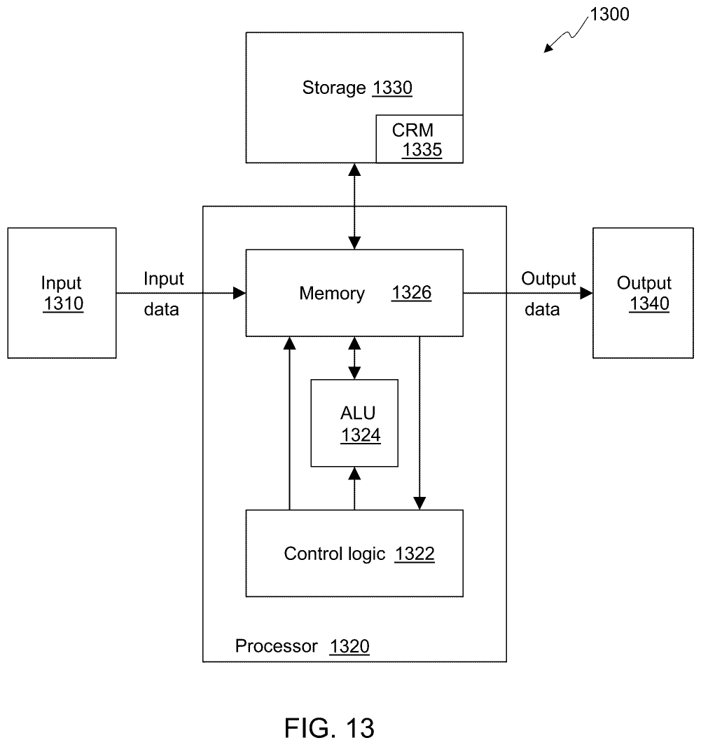

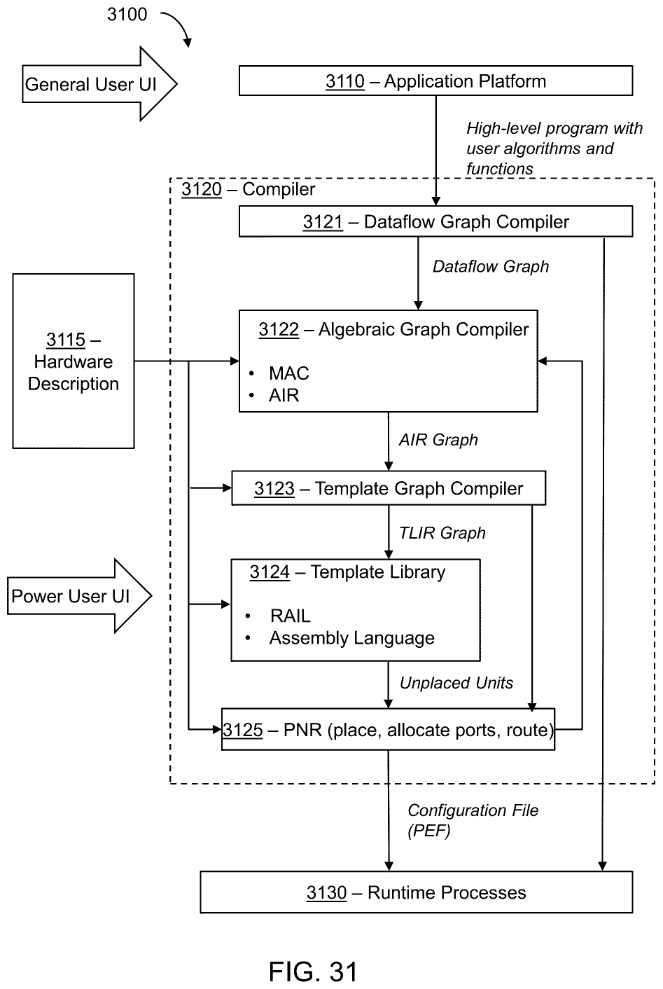

Host 1280 may be, or include, a computer such as further described with reference to FIG. 13. Host 1280 runs runtime processes 1270, as further referenced herein, and may also be used to run computer programs, such as the compiler 1260 further described herein with reference to FIG. 31. In some implementations, the compiler may run on a computer that is similar to the computer described with reference to FIG. 13, but separate from host 1280.

The statically reconfigurable dataflow architecture processor 1210 may accomplish computational tasks by executing a configuration file 1265 (for example, a PEF file). For the purposes of this description, a configuration file 1265 corresponds to a dataflow graph, or a translation of a dataflow graph, and may further include initialization data. A compiler 1260 compiles the high-level program to provide the configuration file 1265. Runtime processes 1270 may install the configuration file 1265 in the statically reconfigurable dataflow architecture processor 1210. In some implementations described herein, a CGR array is configured by programming one or more configuration stores with all or parts of the configuration file 1265. A single configuration store may be at the level of the statically reconfigurable dataflow architecture processor 1210 or the CGR array 1220, or a CGR unit may include an individual configuration store. The configuration file 1265 may include configuration data for the CGR array 1220 and CGR units in the CGR array 1220, and link the computation graph to the CGR array 1220. Execution of the configuration file 1265 by the statically reconfigurable dataflow architecture processor 1210 causes the CGR array 1220 to implement the user algorithms and functions in the dataflow graph.

The statically reconfigurable dataflow architecture processor 1210 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 13 illustrates an example of a computer 1300, including an input device 1310, a processor 1320, a storage device 1330, and an output device 1340. Although the example computer 1300 is drawn with a single processor, other implementations may have multiple processors. Input device 1310 may comprise a mouse, a keyboard, a sensor, an input port (for example, a universal serial bus (USB) port), and any other input device known in the art. Output device 1340 may comprise a monitor, printer, and any other output device known in the art. Furthermore, part or all of input device 1310 and output device 1340 may be combined in a network interface, such as a Peripheral Component Interconnect Express (PCIe) interface suitable for communicating with the statically reconfigurable dataflow architecture processor 1210. Input device 1310 is coupled with processor 1320 to provide input data, which an implementation may store in memory 1326. Processor 1320 is coupled with output device 1340 to provide output data from memory 1326 to output device 1340. Processor 1320 further includes control logic 1322, operable to control memory 1326 and arithmetic and logic unit (ALU) 1324, and to receive program and configuration data from memory 1326. Control logic 1322 further controls exchange of data between memory 1326 and storage device 1330. Memory 1326 typically comprises memory with fast access, such as static random-access memory (SRAM), whereas storage device 1330 typically comprises memory with slow access, such as dynamic random-access memory (DRAM), flash memory, magnetic disks, optical disks, and any other memory type known in the art. At least a part of the memory in storage device 1330 includes a non-transitory computer-readable medium (CRM 1335), such as used for storing computer programs.

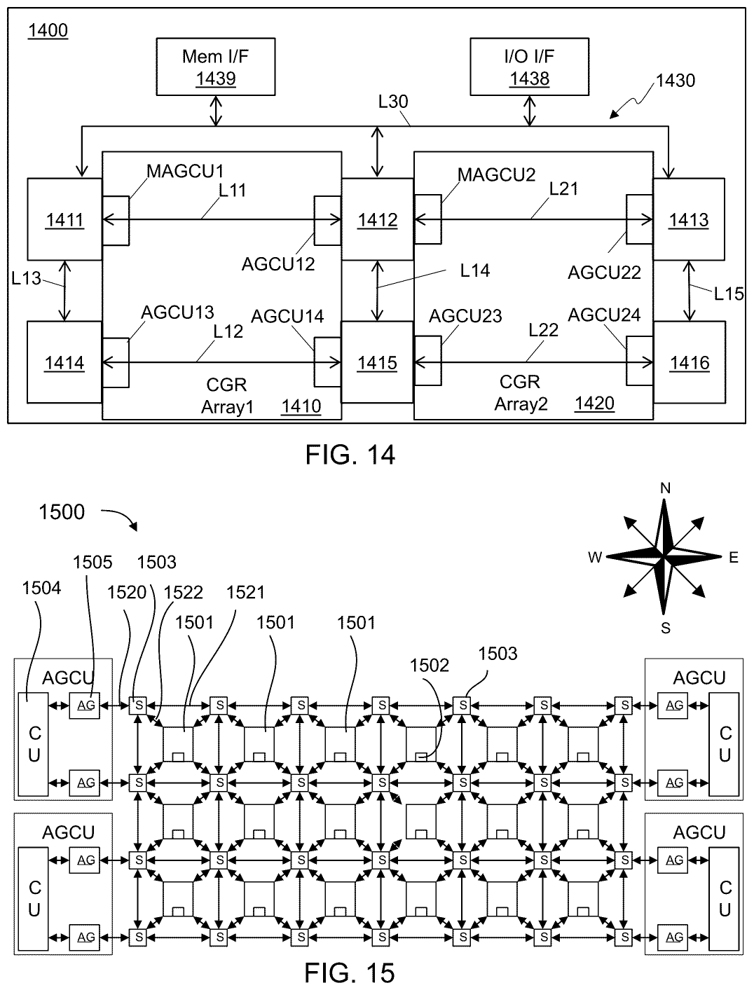

FIG. 14 illustrates example details of a CGR architecture 1400 including a top-level network (TLN 1430) and two CGR arrays (CGR array 1410 and CGR array 1420). A CGR array comprises an array of CGR units (e.g., PMUs, PCUs, FCMUs) coupled via an array-level network (ALN), e.g., a bus system. The ALN is coupled with the TLN 1430 through several AGCUs, and consequently with I/O interface 1438 (or any number of interfaces) and memory interface 1439. Other implementations may use different bus or communication architectures.

Circuits on the TLN in this example include one or more external I/O interfaces, including I/O interface 1438 and memory interface 1439. The interfaces to external devices include circuits for routing data among circuits coupled with the TLN and external devices, such as high-capacity memory, host processors, other statically reconfigurable dataflow architecture processors, FPGA devices, and so on, that are coupled with the interfaces.

Each depicted CGR array has four AGCUs (e.g., MAGCU1, AGCU12, AGCU13, and AGCU14 in CGR array 1410). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 1410, and MAGCU2 includes a configuration load/unload controller for CGR array 1420. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 1411, switch 1412, switch 1413, switch 1414, switch 1415, and switch 1416) coupled with each other as well as with other circuits on the TLN, including the AGCUs, memory interface 1439, and external I/O interface 1438. The TLN includes links (e.g., L11, L12, L13, L14, L15, L21, L22, L30) coupling the top-level switches. Data may travel in packets between the top-level switches on the links, and from the switches to the circuits on the network coupled with the switches. For example, switch 1411 and switch 1412 are coupled by link L11, switch 1414 and switch 1415 are coupled by link L12, switch 1411 and switch 1414 are coupled by link L13, and switch 1412 and switch 1413 are coupled by link L21. The links can include one or more buses and supporting control lines, including for example a chunk-wide bus (vector bus). For example, the top-level network can include data, request and response channels operable in coordination for transfer of data in any manner known in the art.

FIG. 15 illustrates an example CGR array 1500, including an array of CGR units in an ALN. CGR array 1500 may include several types of CGR unit 1501, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017 Jun. 24-28, 2017, Toronto, ON, Canada. Each of the CGR units may include a configuration store 1502 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 1501 comprises an FCMU. In other implementations, the array comprises both PMUs and PCUs, or memory units and compute units, arranged in a checkerboard pattern. In yet other implementations, CGR units may be arranged in different patterns. The ALN includes switch units 1503 (S), and AGCUs (each including two address generators 1505 (AG) and a shared coalescing unit 1504 (CU)). Switch units 1503 are connected among themselves via interconnects 1521 and to a CGR unit 1501 with interconnects 1522. Switch units 1503 may be coupled with address generators 1505 via interconnects 1520. In some implementations, communication channels can be configured as end-to-end connections, and switch units 1503 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 1521 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 1501 may have four ports (as drawn) to interface with switch units 1503, or any other number of ports suitable for an ALN. Each port may be suitable for receiving and transmitting data, or a port may be suitable for only receiving or only transmitting data.

A switch unit, as shown in the example of FIG. 15, may have eight interfaces. The North, South, East and West interfaces of a switch unit may be used for links between switch units using interconnects 1521. The Northeast, Southeast, Northwest and Southwest interfaces of a switch unit may each be used to make a link with an FCMU, PCU or PMU instance using one of the interconnects 1522. Two switch units in each CGR array quadrant have links to an AGCU using interconnects 1520. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 1500, and any number of other CGR arrays coupled with CGR array 1500.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 16 illustrates an example 1600 of a reconfigurable memory unit, such as a pattern memory unit (PMU) 1610, and a reconfigurable compute unit, such as a pattern compute unit (PCU) 1620, which may be combined in a fused compute and memory unit (FCMU) 1630. PMU 1610 may be directly coupled to PCU 1620 through one or more ALN links 1523, or optionally via links through one or more switches. The FCMU 1630 includes multiple ALN interconnects, such as NW ALN interconnect 1522A and SW ALN interconnect 1522B, which may connect to PMU 1610, and SE ALN interconnect 1522C and NE ALN interconnect 1522D, which may connect to PCU 1620. The NW ALN interconnect 1522A, SW ALN interconnect 1522B, SE ALN interconnect 1522C, and NE ALN interconnect 1522D connect to switches 1503 as shown in FIG. 15. Each ALN interconnect 1522A-1522C, 1523 includes one or more scalar interconnects, one or more vector interconnects, and one or more control interconnects where an individual interconnect may be unidirectional into the FCMU 1630, unidirectional out of the FCMU 1630 or bidirectional. The FCMU 1630 can include FIFOs to buffer data entering and/or leaving the FCMU 1630 on the interconnects.

PMU 1610 includes configuration store 1618 which provides configuration data for the PMU 1610. The configuration store 1618 can be loaded from a program running on the host 1280 (as shown in FIG. 12) and can configure the data path 1614 to generate address information for a scratchpad memory 1615, based on data received through one or more of the ALN interconnects 1522A, 1522B, 1523. In addition, the PMU 1610 may include a convolution address generator 1613 to generate addresses for a convolution operation. Data received through one or more ALN interconnects 1522A, 1522B, 1523 may be written to the scratchpad memory 1615 at addresses generated by the data path 1614 and/or data read from the scratchpad memory 1615 at addresses generated by the data path 1614 may be sent out on the one or more ALN interconnects 1522A, 1522B, 1523 to the PCU 1620 and/or to one or more other CGR units in the CGR array 1500.

PCU 1620 includes one or more processor stages, such as SIMD 1621 through SIMD 1626, and configuration store 1628. The processor stages may include ALUs, or SIMDs, as drawn, or any other reconfigurable stages that can process data. Data may be received through one or more ALN interconnects 1522C, 1522D, 1523, processed by the one or more processor stages, SIMD 1621-SIMD 1626 and then sent out to the PMU 1610 or another CGR unit of the CGR array 1500 through one or more ALN interconnects 1522C, 1522D, 1523. The SIMD 1621 through SIMD 1626 may have a number of lanes of processing that is equal to the number of lanes of data provided by a vector interconnect of the ALN interconnects 1522C, 1522D, 1523. Each stage in PCU 1620 may also hold one or more registers (not drawn) for short-term storage of parameters. Short-term storage, for example during one to several clock cycles or unit delays, allows for synchronization of data in the PCU pipeline.

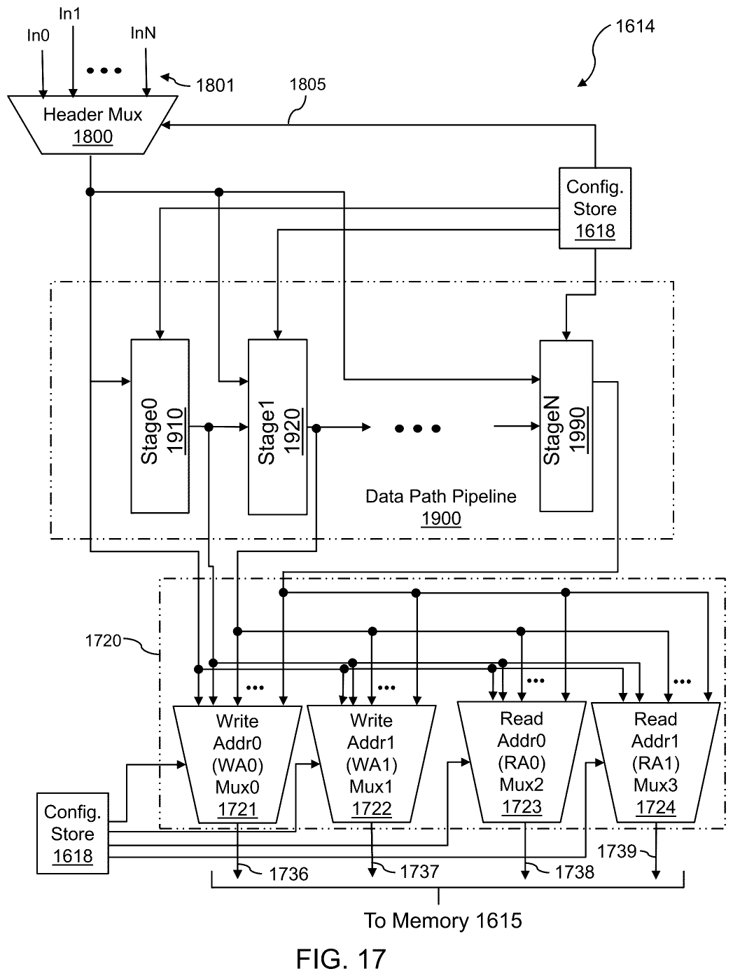

FIG. 17 illustrates an example implementation of a fracturable data path 1614 in a PMU 1610 including a data path pipeline 1900, hereinafter “pipeline 1900”, further including a plurality of stages. Any number of stages, N, may be supported, depending on the implementation, including, but not limited to, any integer value between 4 and 32, such as 8, 12, or 16.

In one example, the pipeline 1900 can be used for memory address computation. As shown the pipeline 1900 includes multiple stages stage0 1910, stage1 1920, up to stageN 1990 formed in such a way that the output of one stage is coupled the input of the next stage. Also shown in FIG. 17 are an input header multiplexer 1800, the configuration store 1618 (previous shown in FIG. 16), and four output multiplexers 1720 including a write address0 (WA0) multiplexer mux0 1721 providing the first output 1736, a write address1 (WA1) multiplexer mux1 1722 providing the second output 1737, a read address0 (RA0) multiplexer mux2 1723 providing the third output 1738, and a read address1 (RA1) multiplexer mux3 1724 providing the fourth output 1739. The inputs of the output multiplexers 1720 may be the same for each of the multiplexers 1721-1724 and include outputs of each of the stages of the data path pipeline 1900, although in some cases the inputs of the different multiplexers 1721-1724 may be different, such as being limited only to header outputs related to an operation associated with that multiplexer's output. The inputs of the output multiplexers 1720 may be coupled to outputs of each sub-path of each stage of the pipeline 1900, or may be coupled to a subset of the outputs of the sub-paths of the stages of the pipeline 1900, such as only coupling to outputs of a first sub-path of each stage of the pipeline 1900. The inputs of the output multiplexers 1720 may also include the outputs of the header mux 1800 to effectively bypass the pipeline 1900 in some implementations. The outputs 1736-1739 are respectively coupled to the write and read address inputs of the memory 1615.

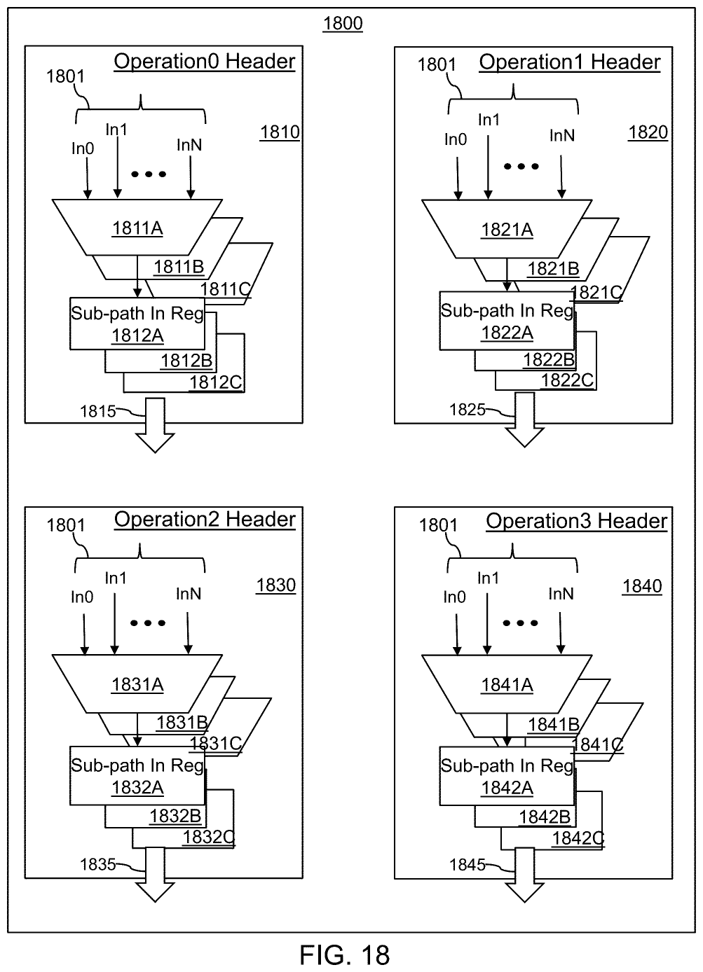

As shown, each stage 1910-1990 is configured to receive configuration data from configuration store 1618. Each stage is further configured to receive inputs from the header mux 1800 and configured to provide an output to the next stage and also to each of the output multiplexers 1721, 1722, 1723, and 1724 (collectively output multiplexers 1720). The header mux 1800, which may include multiple multiplexers and registers (as shown in FIG. 18), allows inputs to the fracturable data path 1614 to be selected for use by the pipeline 1900 under control of configuration information 1805 from the configuration store 1618. Inputs In0-InN 1801 to the header mux 1800 can include outputs of one or more Scalar FIFOs coupled to different scalar bus input ports 1522A, 1522B to the configurable unit 1610, outputs of one or more lanes of one or more vector FIFOs coupled to different vector bus input ports 1522A, 1522B to the configurable unit 1610, outputs of the convolution address generator 1613, and outputs of one or more counters in the configurable unit 1610. Other implementations may include other inputs and/or exclude one or more of the inputs to the header mux 1800 listed above. The header mux 1800 may also provide different inputs to the different sub-paths of the pipeline 1900.

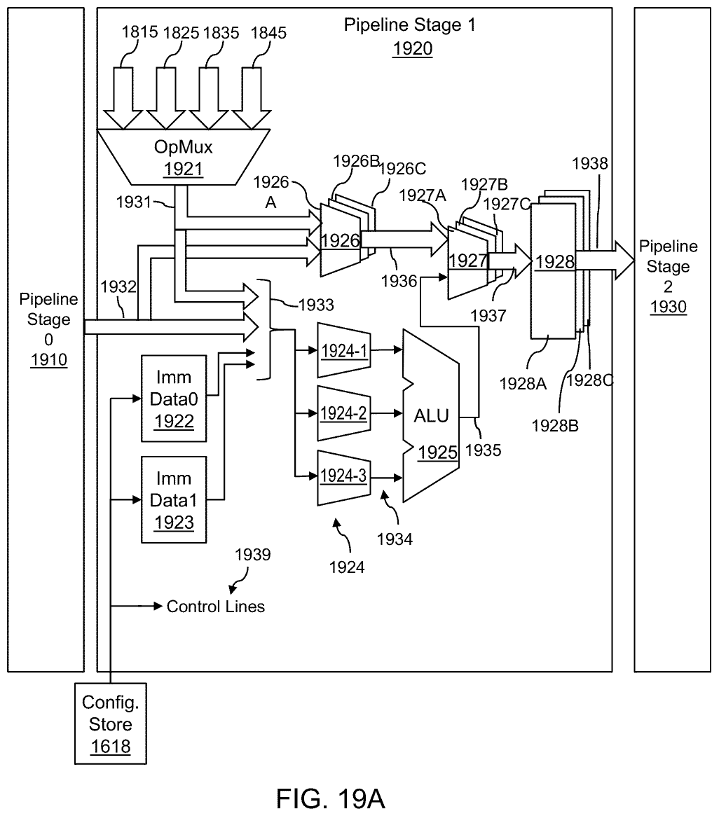

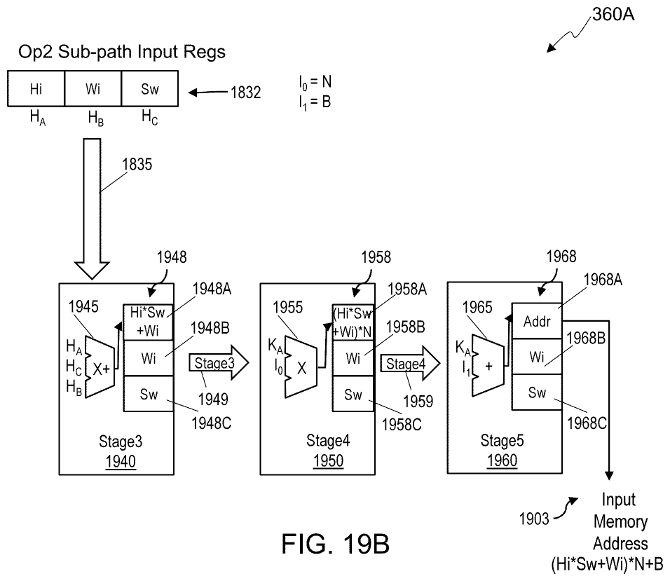

The pipeline 1900 is configured to calculate addresses for accesses to the scratchpad memory 530 of the configurable unit 500. Each stage 1910-1990 includes an arithmetic logic unit that can perform arithmetic, Boolean, and/or logical operations on inputs to the stage, and an output pipeline register as is shown in more detail in FIG. 19A. The address computation process may require many arithmetic and logic operations to be performed by the memory address computation pipeline 1900. In implementations, each of these operations can be assigned to a separate and independent set of stages from the plurality of stages. So, depending on the number of ALU operations required for a particular address calculation, a different number of stages can be assigned to the set of stages for that operation. A higher number of stages increases the latency in calculating the address, as each stage of the pipeline included in the set of stages for the operation adds one pipeline clock of delay.

The pipeline 1900 may be divided into multiple sub-paths where a sub-path is a portion of the width of the data passed through the pipeline. The pipeline 1900 can have any data width and can be divided into any number of sub-paths, although the width of each sub-path can impact the size of memory which can be addresses using data from a single sub-path. In one example, the pipeline 1900 may be 192 bits wide and broken into 8 sub-paths that are each 24 bits wide allowing up to 16 megabytes (MB) of memory to be addressed. In another example, the 192 bit wide pipeline 1900 may be divided into 6 sub-paths that are each 32 bits wide allowing for full 32 bit addressing. Another implementation may utilize a 256 bit wide pipeline with four 64 bit wide sub-paths. Some implementations may include non-homogenous sub-paths having different widths, such as a specialized sub-path to support predication.

FIG. 18 illustrates an example implementation of the header mux 1800. Implementations may include one set of multiplexers and registers for each address calculation to be concurrently calculated. In one example, the header mux 1800 can further include four operation headers, operation0 header 1810, operation1 header 1820, operation 2 header 1830, and operation4 header 1840, to support four concurrent address calculations by the fracturable data path 1614. Each of these headers 1810, 1820, 1830, 1840 can include a multiplexer and register for each sub-path of the pipeline 1900, so that there is a set of input multiplexers and a set of sub-path input registers for each operation. As was discussed above, the pipeline 1900 can have any number of sub-paths, but only 3 sub-paths are shown in the examples of FIGS. 18-19. Each multiplexer for each sub-path in each operation header may be provided with the same set of inputs in0-inN 1801, but some implementations may provide different inputs to the different multiplexers. The inputs 1801 can include one or more outputs of the convolution address generation unit 1613.

In the example shown, the operation0 header 1810 includes a first set of three input multiplexers 1811A, 1811B, 1811C, each coupled to receive the plurality of inputs in1-inN 1801 and having outputs respectively coupled to a first set of three sub-path input registers 1812A, 1812B, 1812C. Similarly, the operation1 header 1820 includes a second set of three multiplexers 1821A, 1821B, 1821C, each coupled to receive the plurality of inputs in1-inN 1801 and having outputs respectively coupled to a second set of three sub-path input registers 1822A, 1822B, and 1822C. The operation2 header 1830 includes a third set of three multiplexers 1831A, 1831B, 1831C, each coupled to receive the plurality of inputs in1-inN 1801 having outputs respectively coupled to a third set of three sub-path input registers 1832A, 1832B, 1832C. The operation3 header 1840 includes a fourth set of three multiplexers 1841A, 1841B, 1841C, each coupled to receive the plurality of inputs in1-inN 1801 having outputs respectively coupled to a fourth set of three sub-path input registers 1842A, 1842B, 1842C. Each of the 12 multiplexers in the header 1800 may be individually controlled by configuration information 1805 from the configuration store 1618. Some implementations may, however, have shared control of one or more of the multiplexers, depending on the implementation.

As those skilled in the art can appreciate, each multiplexer 1811A/B/C in the operation0 header 1810, can independently select one of the inputs in1-inN 1801 to couple the selected input to its corresponding sub-path input register 1812A/B/C, which further provides the registered selected inputs to the output 1815 of the operation0 header 1810. The other operation headers, operation1 header 1820, operation2 header 1830, and operation4 header 1840 are all also configured as explained above. The output 1815 can be collectively referred to as operation0 header output, the output 1825 can be collectively referred to as operation1 header output, the output 1825 can be collectively referred to as operation2 header output, and the output 1835 can be collectively referred to as operation3 header output. The header outputs 1815, 1825, 1835, 1845 each provide data for each sub-path of the pipeline 1900. More particularly, as will be explained in more detail with regard to FIG. 19A, each of these header outputs 1815, 1825, 1835, 1845 allow any combination of the inputs in1-inN 1801 to be provided to the different sub-paths of the pipeline 1900 to be operated upon by the ALUs in a pipelined fashion. In addition, some implementations provide the header outputs 1815, 1825, 1835, 1845 to the output multiplexers 1720. This allows an output 1736-1739 of the fracturable data path 1614 to provide one of the inputs in1-inN 1801 directly (with a 1 clock delay for the sub-path input register) as the output without using any of the stages of the data path pipeline 1900. In some implementations, the outputs of only one operation's the sub-path input registers may be provided to a particular output multiplexer. So, for example, the operation0 header output 1815 may be provided to the write address0 multiplexer 1721 without being provided to the other output multiplexers 1722-1724. Similarly, the operation1 header output 1825 may only be provided to the write address1 multiplexer 1722, the operation2 header output 1835 may only be provided to the read address0 multiplexer 1723, and the operation3 header output 1845 may only be provided to the read address1 multiplexer 1724.

FIG. 19A illustrates details of stage 1 1920 in the pipeline 1900 shown in FIG. 17, according to an implementation of the present disclosure. Each stage of the pipeline 1900 may be similar to the stage 1 1920. As shown, the stage 1 1920 includes an operation multiplexer 1921 coupled to receive the operation header outputs 1815, 1825, 1835, 1845. The operation multiplexer 1921 can be controlled by control lines 1939 from the configuration store 1618 and can select the appropriate operation header output based on which operation has been assigned to stage 1 1920. So if stage 1 1920 is being used for a calculation of operation 0, the operation0 header output 1815 is selected by the operation multiplexer 1921 for use by stage 1 1920 as header data 1931. Note that in the implementation shown, each sub-path of stage 1 1920 is provided with header data 1931 from the same operation header, but other implementations may allow different sub-paths to receive data from different operation headers.

Stage 1 1920 also includes an ALU 1925, a set 1924 of ALU input multiplexers 1924-1, 1924-2, and 1924-3, a set 1926 of pipeline/header selection multiplexers 1926A, 1926B, 1926C, a set 1927 of ALU bypass multiplexers 1927A, 1927B, and 1927C, and a pipeline register 1928 containing sup-path pipeline registers 1928A, 1928B, and 1928C. The operations mux 1921 and the set 1924 of ALU input multiplexers may together be referred to as the selection logic. The set 1924 of ALU input multiplexers, the set 1926 of pipeline/header selection multiplexers, and the set 1927 of ALU bypass multiplexers are controlled by control lines 1939 from the configuration store 1618.

In one example implementation, the ALU 1925 is a three input ALU and each of the ALU inputs is coupled to receive data 1934 selected from a set of possible ALU inputs 1933 via the first set of multiplexers 1924. The set of possible ALU inputs include the three sub-paths of the selected operation header data 1931 from the operation multiplexer 1921, the outputs of the three sub-path pipeline registers 1932 of the immediately preceding pipeline stage 0 1910, and immediate data0 1922 and immediate data1 from the configuration store 1618. Implementations may not provide all of the inputs listed for each stage and/or may provide additional inputs such as additional immediate registers or other operation header data. For example, the initial stage, stage0 1910, of the pipeline 1900 does not have an immediately preceding stage so it cannot select sub-path registers from the immediately preceding stage. Thus, the selection logic in the one or more intermediate stages 1920 and the final stage 1990 may be adapted to select from at least outputs of the sub-path pipeline registers of an immediately preceding stage, outputs of the first set of sub-path input registers 1812A/B/C, and the plurality of immediate data fields associated with that stage and provided by the configuration store 1618, while the selection logic in the initial stage 1910 may be adapted to select from the outputs of the first set of sub-path input registers 1812A/B/C and the plurality of immediate data fields associated with the initial stage and provided by the configuration store 1618. In addition, the selection logic may be adapted to allow selection between the first set 1812A/B/C of sub-path input registers and the second set 1822A/B/C of sub-path input registers based on whether the stage is associated with the first calculation or the second calculation. The selection logic may also be configurable to provide a first immediate data field 1922 to the first input of the ALU 1925 of the stage and a second immediate data field 1923 to the second input of the ALU 1925 of the stage.

The data 1934 provided to the three inputs to the ALU 1925 by the selection logic 1924 are operands on which the ALU can perform arithmetic, Boolean, and/or logical operations. The ALU 1925 may be able to perform a wide variety of operations that may have different numbers of operands, depending on the implementation. In one example, the ALU 1925 may be able to perform one or more of the following operations on a number of operands provided in paratheses: unsigned integer addition (2 or 3), unsigned integer subtraction (2), signed integer multiplication (2), unsigned multiply and add (3), signed integer addition (2 or 3), signed integer subtraction (2), unsigned integer multiplication (2), signed multiply and add (3), bitwise AND (2 or 3), bitwise OR (2 or 3), bitwise XOR (2 or 3), bitwise NOT (1), logical AND (2 or 3), logical OR (2 or 3), logical XOR (2 or 3), clamp (3), select (3), compare (2), shift right (2), shift left (2), rotate right (2), and/or rotate left (2). Different implementations may include all or some of the previously listed operations and may or may not include other operations. The ALU operation of each stage is controlled by control lines 1939 from the configuration store 1618 and the result of the ALU operation is provided at the ALU output 1935.

Additionally, each multiplexer of the set 1926 of pipeline/header selection multiplexers is coupled to output either a selected operation header data 1931 or corresponding data 1932 from the sub-path pipeline registers previous pipeline stage 0 1910. In some implementations each of the multiplexers 1926A, 1926B, 1926C of the set 1926 of the pipeline/header selection multiplexers may be controlled together, so that each multiplexer 1926A, 1926B, 1926C selects the selected header data 1932 or each multiplexer 1926A, 1926B, 1926C selects the data 1932 from the previous pipeline stage 0 1910. For example, in one example operation, the operation multiplexer 1921 may select the output 1815 of the operation0 header 1810 and provide that data 1931 as one input to each pipeline/header selection multiplexer 1926A, 1926B, 1926C, with the data 1932 from the sub-path pipeline registers of the previous pipeline stage 0 1910 as another input. As explained previously, 1815 is the output of operation0 header 1810 and can include any combination of the input data in1-inN 1801. As such, the multiplexers 1926 are coupled to output either a portion of the input data in1-inN 1801 or data from the previous stage sub-path pipeline registers.

In this example, the outputs 1936 of the three multiplexers 1926 are further provided to each of the ALU bypass multiplexers 1927A, 1927B, 1927C along with the ALU output 1935. The output of the set 1927 of ALU bypass multiplexers are used as inputs to the pipeline register 1928. The ALU bypass multiplexers 1927A, 1927B, 1927C may be individually controlled so that one of them selects the ALU output 1935 and the others select the corresponding output 1936 of the set 1926 of pipeline/header selection multiplexers. As such, bypass logic (including the set 1926 of pipeline/header selection multiplexers and the set 1927 of ALU bypass multiplexers) is configurable to select a first sub-path pipeline register (e.g. sub-path pipeline register 1928A) to receive an output of the ALU as its input, and to select a second sub-path pipeline register (e.g. sub-path pipeline register 1928B) to receive an output 1932 of a corresponding sub-path pipeline register of an immediately preceding stage 1910 or an output 1931 of a corresponding sub-path input register of the first set of sub-path input registers (e.g. sub-path input registers 1812A/B/C). The output 1937 of the bypass logic is provided to the pipeline register 1928. An output 1938 of the pipeline register is then provided to the next stage of the pipeline, stage2 1930.

As can be seen, the Imm Data0 1922 and Imm Data1 1923 are data received from the configuration store 1618. Also received from the config store is a set of control lines 1939 which can provide the necessary control for the various multiplexers and the ALU 1925. Additionally, although the example shows two instances of immediate data 1922 and 1923, there can be as many instances as is required by the design needs, such as three separate immediate data fields for each stage. In other implementations, there may be a set of immediate data fields dedicated for each operation instead of or in addition to those dedicated to each stage. Some implementations may also include global immediate data fields useable by any stage for any operation. As such, it may be appreciated that the ALU in each stage can receive a plurality of operands selected from among any of the plurality of immediate data, any of the plurality of previous stage sub-path pipeline registers, and any of the plurality of the header data. Each stage can further provide any combination of the ALU data, the header data, and the previous stage pipeline data to the next stage.

The fracturable data path 1614 may be divided into separate sets of contiguous stages to allow concurrent calculation of multiple addresses using separate address calculations. The configuration data in the configuration store 1618 provides the information needed to perform the operations. While the fracturable data path 1614 may be configured in many different ways, the pipeline 1900 may be broken into contiguous sets of stages, with one set of stages assigned to each concurrent operation. The operation mux 1921 may be set to select the operation header output associated with the assigned operation for that stage.

For some operations, a single stage may be sufficient for the necessary calculation, so some sets of stages may include a single stage. Thus, in such cases, the starting stage and the ending stage are the same stage. For a single stage set, the necessary inputs are selected using the multiplexers of the appropriate operation header, with one sub-path input register used for each necessary input and the operation mux configured to pass the appropriate operation header output into the stage. The ALU input multiplexers 1924 can then be used to select those inputs for the ALU operation which is then directed into one of the sub-path pipeline registers, such as sub-path pipeline register 1928A where it can then be selected as an address for the memory using one of the output multiplexers 1720. In some implementations, inputs of the output multiplexers are coupled only to a predetermined sub-path pipeline register of each stage for simplicity.

For other operations, the set of stages assigned to the operation includes a starting stage and an ending stage. If the set of stages includes more than 2 stages, there may be one or more transitional stages positioned between the starting stage and the ending stage. The necessary inputs are selected using the multiplexers of the appropriate operation header, with one sub-path input register used for each necessary input and the operation mux configured to pass the appropriate operation header output into at least the starting stage. In many implementations, the ending stage and any transitional stages won't utilize data from the operation mux 1921 to avoid complicating the pipelining of data through the set of stages. The selection logic of the starting stage avoids selecting an output of the sub-path pipeline registers of an immediately preceding stage as any input of the two or more inputs to the ALU of the first starting stage as the stage immediately preceding the starting stage is not a part of the set of stages for the operation being performed. The operation may be broken into steps that can be performed by an ALU in one clock cycle and the proper inputs for that ALU selected from the selected operation header output or the immediate fields for that stage and the ALU performs the operation and the bypass logic directs that ALU output to one of the sub-path pipeline registers while directing the selected operation header sub-path data to the other sub-path pipeline registers in the starting stage, while directing the previous stage sub-path pipeline registers into the other sub-path pipeline registers in the ending stage and any transitional stages. This allows the selected header inputs from the same clock to be used throughout the calculation, simplifying the pipelining. In some implementations, the output multiplexers are configured to only select between a predetermined sub-path pipeline register of each stage for simplicity, so the ending stage would direct the ALU output to that predetermined sub-path pipeline register. The output multiplexers 1720 can be configured to provide data from that sub-path pipeline register of the first ending stage for the output associated with the operation.

A second set of contiguous stages of the plurality of stages may be assigned to another operation, the second set of contiguous stages may be adjacent to and disjoint from the first set of contiguous stages, although other configurations are possible. The second set of contiguous stages includes a second starting stage immediately following the first ending stage, and a second ending stage. The selection logic of the second starting stage is configured to not select an output of the sub-path pipeline registers of the first ending stage as any input of the two or more inputs to the ALU of the second starting stage, and to configure the second output to provide data from the sub-path pipeline register of the second ending stage as the second data.

Note that the set of sub-path pipeline registers in a set of stages can be thought of as a register bank for the operation, where instead of using the same register location each time an instruction needs to use that register, the sub-path pipeline registers each represent the state of those registers at a specific point in time. Thus, the number of sub-paths becomes equivalent to the number of registers available for an operation. If an operation used three stages, and the first input is received at clock 1, the second input received at clock 2, the third input received at clock 3, and the result of the calculation for the first input available at clock 4, the sub-path pipeline registers each have data from a different one of the three calculations. The sub-path pipeline registers of the ending stage has the result of the calculation using the first input, the sub-path pipeline registers of the transitional stage has the partial results of the calculation using the second input, and the sub-path pipeline registers of the staring stage has partial results of the calculation using the third input.

FIG. 19B illustrates example operations performed the fracturable data path 1900 shown in FIG. 17, in an implementation of the present disclosure, while configured as an address calculation circuit 360A performing an address calculation for a convolution operation. The example circuit 360A utilizes three contiguous stages of the pipeline 1900 of the data path 1614 of PMU 1610 to generate a linear memory address for the memory 1615 from an input location received from the convolution address generator 1613.

In this example, three stages (stage3 1940, stage4 1950, and stage5 1960) are assigned to generate the input address. These stages can be examples of the stages shown in FIG. 17 and the ALUs 1945, 1955, and 1965 can be examples of the ALU 1925 shown in FIG. 19A. Also shown in stage3 1940 are sub-path pipeline registers 1948A, 1948B, and 1948C collectively referred to as pipeline register 1948; in stage4 1950 are sub-path pipeline registers 1958A, 1958B, and 1958C collectively referred to as pipeline register 1958; and in stage5 1960 are sub-path pipeline registers 1968A, 1968B, and 1968C collectively referred to as pipeline register 1968. The pipeline registers 1948, 1958, 1968 can be examples of the pipeline register 1928 shown in FIG. 19A.

The stage3 1940, stage4 1945, and stage5 1955 together are configured to calculate an input memory address 1903. The stage3 1940 in this example is a starting stage and stages stage4 1950 and stage5 1960 are subsequent stages with stage4 1950 being a transitional stage and stage5 1960 being an ending stage. The starting stage stage3 1940 configured to receive the header data from the operation2 sub-path input registers 1832 as operation2 header output 1835 with sub-paths of H_{A}, H_{B}, and H_{C} through the operation multiplexer (an example of the operation multiplexer 1921 in FIG. 19A). The operation2 header multiplexers can be configured to deliver the values “Hi”, “Wi”, and “Sw” from the inputs in0-inN 1801. The Hi value and Wi value may be received from the convolution address generator 1613, representing a height (i.e. a row number) and a width (column number) of the input element in a 2D input tensor for which a linear address is to be generated. The Sw value may be received from a scalar input and represent a number of elements per row in the input tensor. Other implementations may provide the Sw value as an input from the convolution address generator 1613, as an immediate value from the configuration store 1618, a control register, or from any other source. In addition, Immediate value 0 (I₀) is set to be an address space increment between elements in the input tensor, and Immediate value 1 (I₁) is set to a base address for the input tensor. Other implementations may provide these values from other sources. The stages 1940, 1950, 1960 are configured to generate the input address of (Hi*Sw+Wi)*N+B using three pipeline cycles.

The ALU 1945 in this example is configured to perform a multiply and add operation on the operands indicated as H_{A}, H_{C}, H_{B} to calculate Hi*Sw+Wi and provide it to the sub-path pipeline register 1948A. The remaining two pipeline registers 1948B and 1948C can receive the values “Wi” and “Sw” received from H_{B} and H_{C}, respectively. The values Hi*Sw+Wi, Wi, and Sw from the pipeline registers 1948A, 1948B, and 1948C respectively can then be provided to the stage4 1950 as the output 1949 of stage3 1940.

At stage4 1950, the ALU 1955 is configured to perform a multiply operation on two operands indicated as K_{A} and I₀ (with value Hi*Sw+Wi of the previous clock from 1948A) and I₀ (which is set to N). The third input will be ignored by the ALU 1955 for this operation and can be set to any value. The ALU 1955 can then perform the multiply operation and provide (Hi*Sw+Wi)*N to the pipeline register 1958A. The output of the pipeline registers 1958 is provided to the next stage stage5 1960 as stage4 output 1959.

In the stage5 1960, the ALU 1965 is configured to perform an addition operation on K_{A} ((Hi*Sw+Wi)*N from the register 1958A), I₁ (set to B). The ALU 1965 can perform the addition and provide its result of (Hi*Sw+Wi)*N+B to register 1968A as the address (Addr). The value (Hi*Sw+Wi)*N+B of the input memory address 1903 in register 1968A can be provided to the output multiplexers 1720 shown in FIG. 17 and then sent to the memory 1615 to read the element from the input tensor.

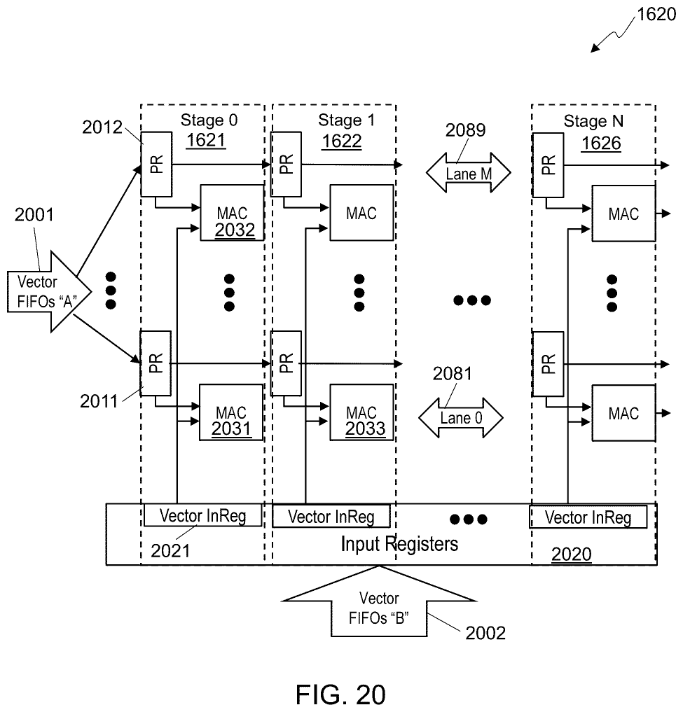

FIG. 20 illustrates example hardware for a reconfigurable compute unit 1620 as shown in FIG. 16, in an implementation of the present disclosure. As discussed earlier, the reconfigurable compute unit (e.g., a PCU) includes N stages including stage 0 1620, stage 1 1622, and stage N 1626, where N can be any integer, but can be 3, 6, 8, 16, or any other number suitable for the application. Note that while both the fracturable data path 1614 in the PMU 1610 and the PCU 1620 have pipelines with N stages, they may or may not have the same number of stages and can have very different computational characteristics. In the PCU 1620, for example, each stage has a plurality of lanes, such as lane 0 2081 and lane M 2089 to allow parallel processing of data across the lanes 2081-2089.

As shown in FIG. 16, the reconfigurable compute unit 1620 has multiple interconnects 1522C, 1522D, 1523 with vector interconnects. One or more of the vector interconnects may be coupled to first vector FIFOs 2001 or second vector FIFOs 2002 to provide data to the stages 1621-1626. Each stage has a vector input register 2021 and a set of pipeline registers 2011-2012 with at least one pipeline register for each lane, such as pipeline register 2011 for lane 0 2018 of stage 0 1621 and pipeline register 2012 for lane M 2089 of stage 0 1621. Each lane of each stage also includes at least one multiply-accumulate circuit (MAC), such as MAC 2031 for lane 0 2018 of stage 0 1621 and pipeline MAC 2032 for lane M 2089 of stage 0 1621. The MACs may be dedicated MAC units or may be a part of a more general purpose ALU. The reconfigurable compute unit 1620 also includes input registers 2020 with a least one vector input register per stage of the pipeline, such as vector input register 2021 in stage 0 1621.

The reconfigurable compute unit 1620 can support a configuration similar to that shown in FIGS. 9A-9R. To support this type of operation, data from the first vector FIFOs may be routable to one or more of the pipeline registers 2011, 2012 of stage 0 1621 and data from the second vector FIFOs 2002 may be routable to one or more of the vector input registers 2020. To support the vector operations shown in table 1000, the pipeline registers 2011-2012 and vector input registers 2020 can provide a single scalar component of their vector value to the appropriate MAC. Thus, the statically reconfigurable dataflow architecture processor 1210, when properly configured, can be used as a convolution computation engine.

As shown in FIG. 20, the reconfigurable compute units respectively include an array of multiply-accumulate circuits (MACs) having a plurality of lanes and a plurality of stages. The statically reconfigurable memory units include a memory array, a general address calculation unit, and a convolution address compute unit. The convolution address compute units in the statically reconfigurable memory units can be any one of the units described herein.

The statically reconfigurable dataflow architecture processor 1210 can be configured to act as the convolution computation engine 100 of FIG. 1. In such a configuration, one or more PMUs 1610 can be configured to act as the first memory unit 110 with the convolution address generation unit 1613 and data path 1614 of the PMU(s) 1610 acting as the kernel address compute unit 112 and the memory 1615 of the PMU 1610 acting as the kernel memory 115. One or more PMUs 1610 can be configured to act as the second memory unit 120 with the convolution address generation unit 1613 and data path 1614 of the PMU(s) 1610 acting as the input address compute unit 122 and the memory 1615 of the PMU(s) 1610 acting as the input memory 125. One or more PCUs 1620 can be configured to act as the compute unit 140 with the MAC of one or more stages in the PCU(s) acting as the MAC 145. One or more PMUs 1610 can be configured to act as the third memory unit 130 with the convolution address generation unit 1613 and data path 1614 of the PMU(s) 1610 acting as the output address compute unit 132 and the memory 1615 of the PMU(s) 1610 acting as the output memory 135. The ALN of the CGR array 1220 can act as the interconnects 117, 127, and 147 to transport the kernel data, the input data, and the output data, respectively.

So, an example statically reconfigurable dataflow architecture processor 1210 includes an array of coarse-grained reconfigurable (CGR) units 1220 including statically reconfigurable memory units (e.g., PMUs 1610), statically reconfigurable compute units (e.g., PCUs 1620), statically reconfigurable switches (e.g. switches 1503), and links (e.g. interconnects 1521, 1522) that respectively connect two of the CGR units. The links can include a vector link. The statically reconfigurable compute units including an array of multiply-accumulate circuits (MACs) having multiple lanes with multiple stages. The statically reconfigurable memory units 1610 include a memory array 1615, a general address calculation unit 1614, and a convolution address compute unit 1613.

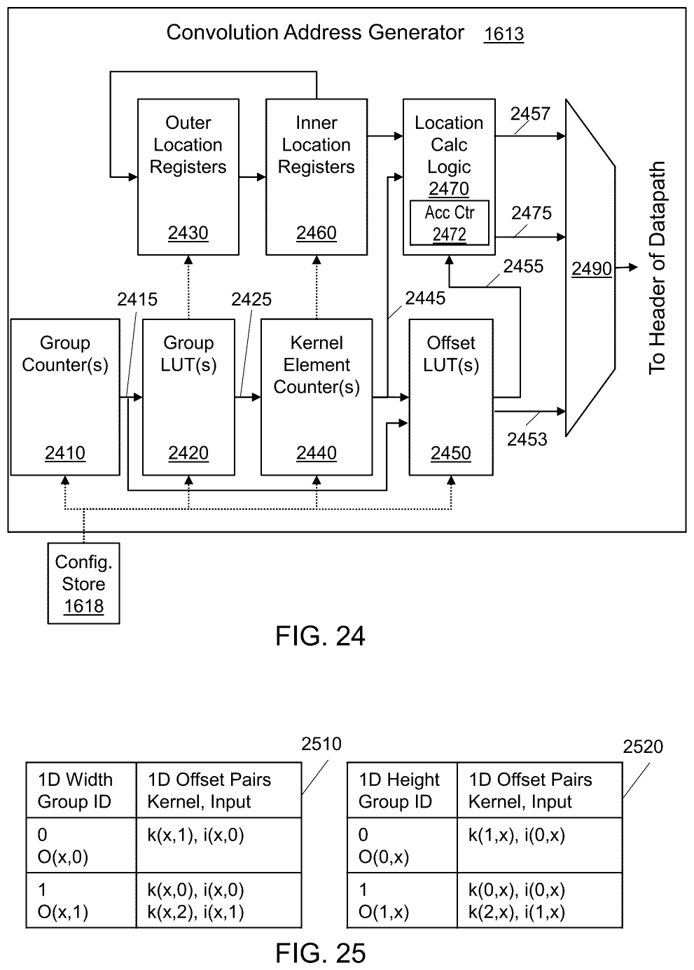

The convolution address compute units 1613 of the statically reconfigurable memory units may be similar to the circuit 300 of FIG. 3 configured to perform similarly to the pseudocode 400A of FIG. 4A with or without the modifications of the pseudocode 400B of FIG. 4B, or the convolution address compute units 1613 may be the convolution address generator shown in FIG. 24. The convolution address compute units 1613 can include an outer output base location register to provide an outer output base location for a convolution operation and an outer input base location register to provide an outer input base location for the convolution operation. The convolution address compute units 1613 can also include a kernel element counter that starts to count from an initial kernel count value to a maximum kernel count value in response to a change in the outer output base location, a kernel offset generator to generate a kernel offset based on an output of the kernel element counter, and inner location logic to calculate an output location based on the outer output base location and an input location based on the outer input base location and the output of the kernel element counter.

The inner location logic may include an inner input base register to provide an inner input base location, an accumulator counter, input location calculation logic, and an inner output register to provide the output location. The accumulator counter resets to an initial accumulator value in response to a change in the kernel element counter and increments in response to a new input location being calculated, until reaching a maximum accumulator count value. The input location calculation logic calculates the input location based on the inner input base register and the output of the kernel element counter. The inner output register increments in response to the accumulator counter incrementing and loads the outer output base location in response to the kernel element counter changing. The kernel element counter increments in response to the accumulator counter reaching the maximum accumulator count value. The inner input base register increments in response to the new input location being calculated and loads the outer input base location in response to the kernel element counter wrapping back to the initial kernel count value.

In some implementations, the example statically reconfigurable dataflow architecture configures a first statically reconfigurable memory unit 1610 to use its general address calculation unit 1614 to calculate a first kernel memory address based on the kernel offset received from its convolution address generation unit 1613 during a first period where the accumulator counter has a first value, use the first kernel memory address to read a first kernel vector element from its memory array 1615, and send the first kernel vector element to a first statically reconfigurable compute unit 1620. A second statically reconfigurable memory unit 1610 is configured to use its general address calculation unit 1614 to calculate a first input memory address based on the input location received from its convolution address generation unit 1613 during the first period, use the first input memory address to read a first input vector element from its memory array 1615, and send the first input vector element to the first statically reconfigurable compute unit 1620. The first statically reconfigurable compute unit 1620 is configured to calculate a first dot product of the first kernel vector element and the first input vector element in a first MAC 2031 in first stage 1621 of the pipeline and accumulate a result of the first dot product with a previous value of an accumulator of the first MAC 2031.

The second statically reconfigurable memory unit 1610 is further configured to use its general address calculation unit 1614 to calculate a second input memory address based on the input location received from its convolution address generation unit 1613 during the second period, use the second input memory address to read a second input vector element from its memory array 1615, and send the second input vector element to the first statically reconfigurable compute unit 1620. The first statically reconfigurable compute unit 1620 is further configured to calculate a second dot product of the first kernel vector element and the second input vector element in a second MAC 2033 in second stage of the pipeline, and accumulate a result of the second dot product with a previous value of an accumulator of the second MAC 2033, wherein the calculation of the second dot product in the second MAC 2033 occurs in parallel with the calculation of the first dot product in the first MAC 2031. The first statically reconfigurable compute unit 1620 is further configured to process K input vector elements in both the first MAC 2031 and the second MAC 2033, where K is a number of active locations in a receptive field of an input for the convolution operation, and then send both a first accumulated value from the accumulator of the first MAC 2031 and a second accumulated value from the accumulator of the second MAC 2033 to a third statically reconfigurable memory unit 1610.

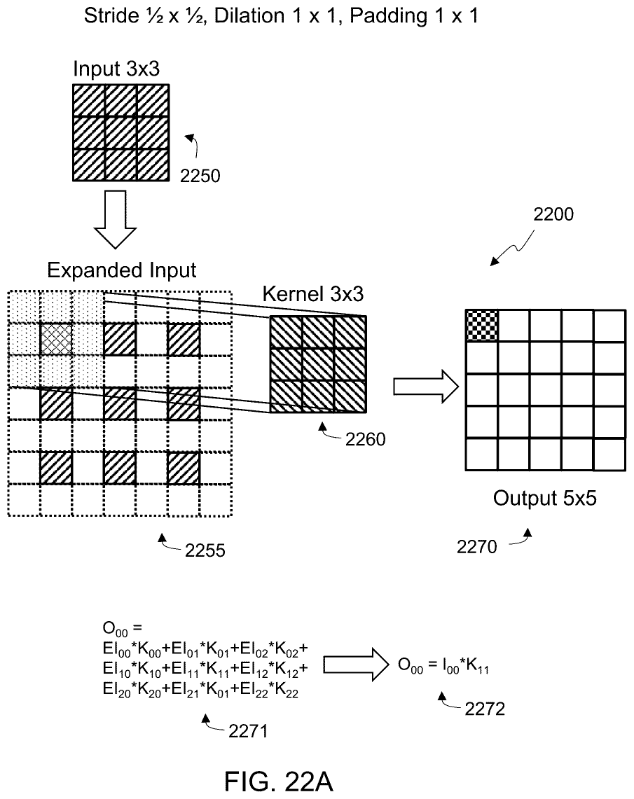

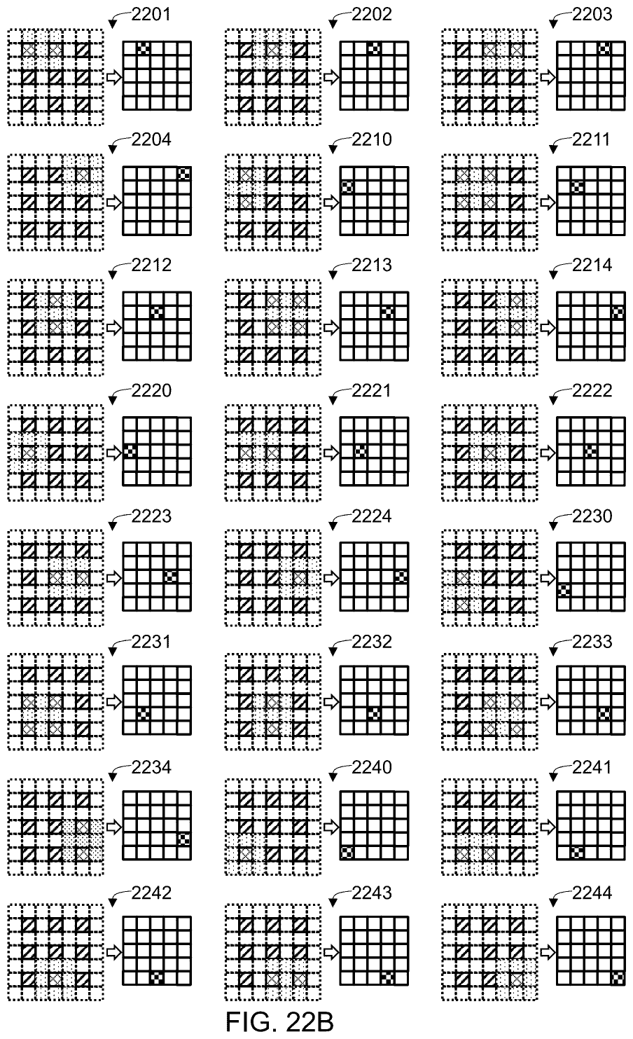

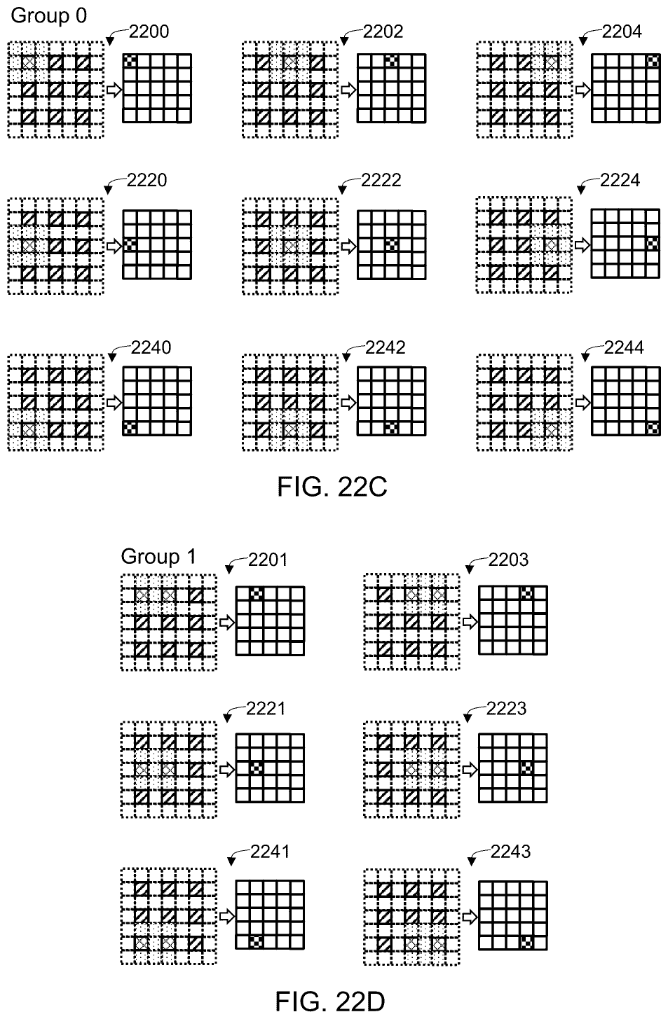

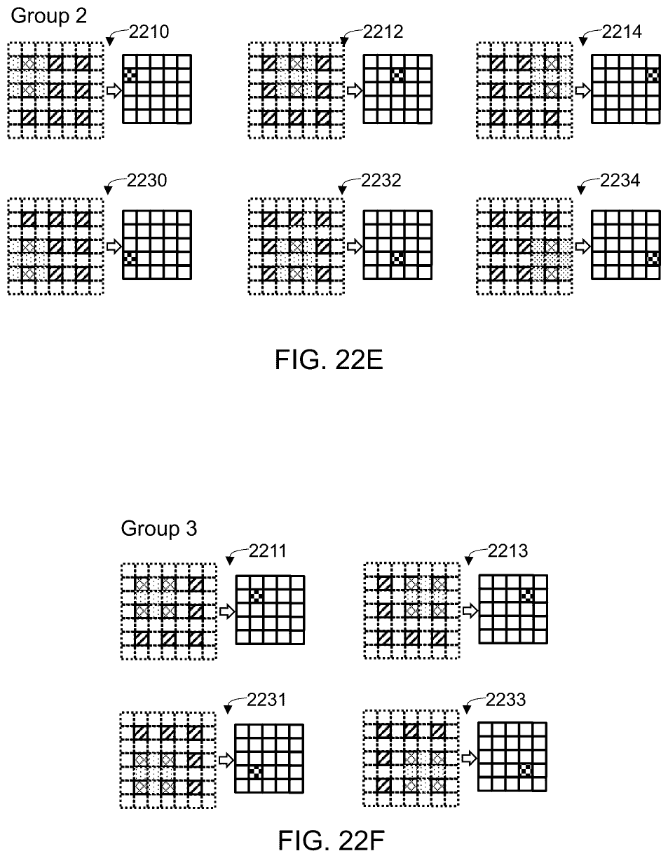

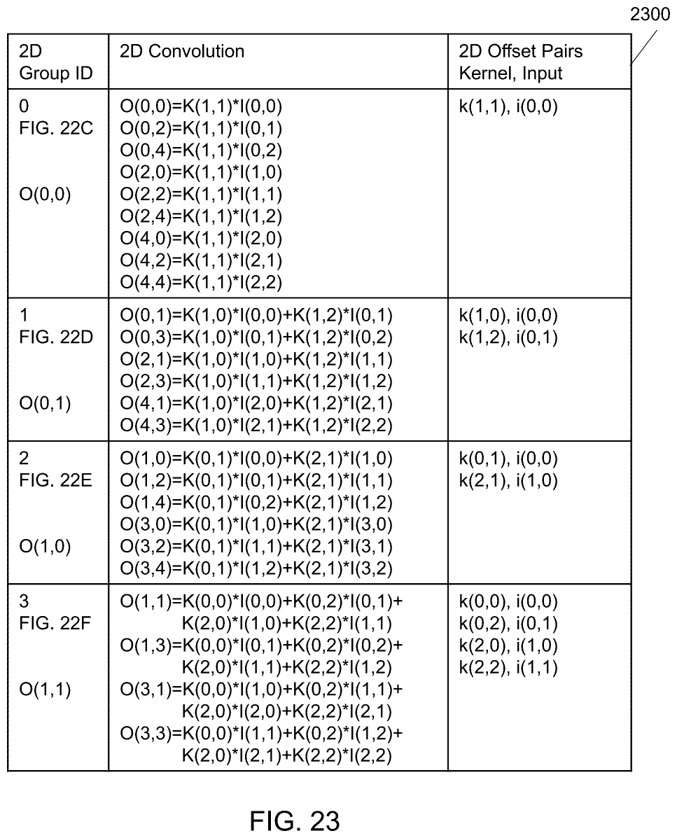

An active location in the receptive field for an output location is a location in the receptive field will be multiplied by an element of the kernel in calculating that output location. Cases where K may be less than the total number of elements in the kernel include those where a custom kernel offset LUT has been generated for a specific kernel that eliminates zero-valued locations in the kernel such as shown in FIG. 11A and effective input locations that are structurally set to zero such as for fractional stride values as will be discussed following related to the convolution operation shown in FIG. 22A-22F. Note that while padding may be thought of as structurally adding zero-valued locations to the input tensor, these may still be included in calculating a K value as these are boundary conditions that typically do not impact overall performance in a significant way due to the large size of most input tensors.

The third statically reconfigurable memory unit 1610 is configured to use its general address calculation unit 1614 to calculate a first output memory address based on the output location received from its convolution address generation unit 1613 during the first period and a second output memory address based on the output location received from its convolution address generation unit 1613 during the second period, use the first output memory address to store the first accumulated value received from the first statically reconfigurable compute unit in its memory array 1615, and use the second output memory address to store the second accumulated value received from the first statically reconfigurable compute unit in its memory array 1615.

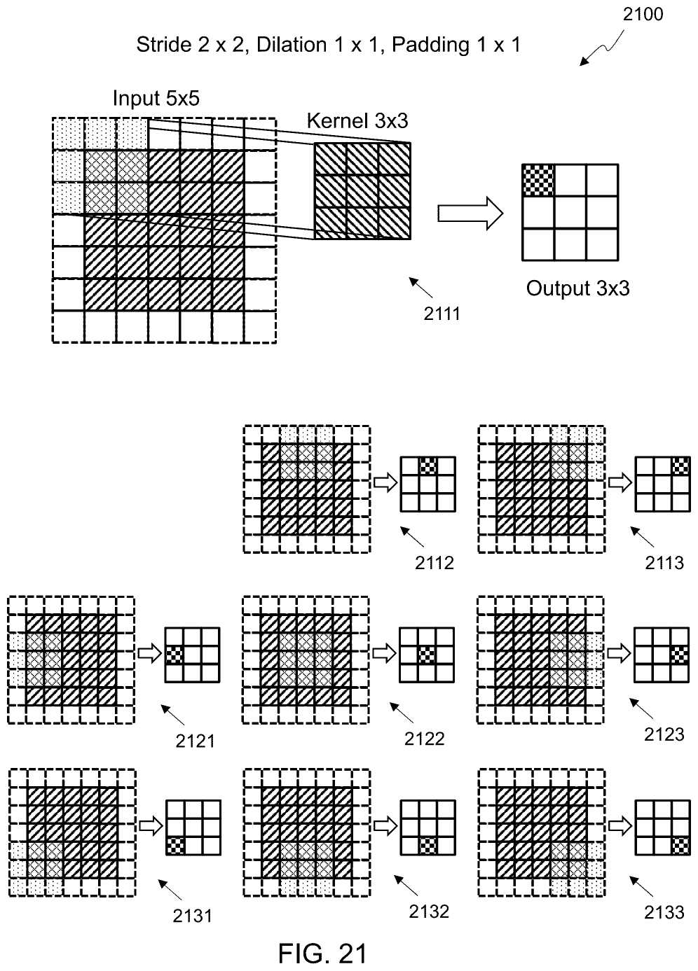

FIG. 21 provides a graphical illustration 2100 of a 2D convolution operation with a stride hyperparameter of 2 in both dimensions, a dilation hyperparameter of 1 in both dimensions, and effective padding of 1 in both dimensions. The convolution operation uses a 3×3 kernel on a 5×5 input tensor to generate the 3×3 output.

The generation of each of the 9 outputs is shown in diagrams 2111-2133 with the calculation of Out(0,0) graphically depicted in diagram 2111, the calculation of Out(0,1) graphically depicted in diagram 2112, and the calculation of Out(0,2) graphically depicted in diagram 2113. The calculation of Out(1,0) is graphically depicted in diagram 2121, the calculation of Out(1,1) is graphically depicted in diagram 2122, and the calculation of Out(1,2) is graphically depicted in diagram 2123. And lastly, the calculation of Out(2,0) is graphically depicted in diagram 2131, the calculation of Out(2,1) is graphically depicted in diagram 2132, and the calculation of Out(2,2) is graphically depicted in diagram 2133.

FIGS. 22A and 22B, provide a graphical illustration of a convolution operation with a stride hyperparameter of ½ in both dimensions, a dilation hyperparameter of 1 in both dimensions, and effective padding of 1 in both dimensions. This convolution operation is the transposed convolution of the convolution operation of FIG. 21. The input tensor 2250 is 3×3, the kernel 2260 is 3×3 and the output 2270 is 5×5. To perform a convolution operation having a fractional stride value, the input tensor is expanded by an amount equal to the denominator of the stride amount where the numerator is 1. For a stride of ½, the denominator is 2, so the input tensor is expanded to so that adjacent elements of the input tensor are treated as if they are 2 apart. Thus, for the 3×3 input tensor 2250, with the padding and expansion, the expanded input 2255 is a 7×7 matrix. This can be thought of as adding a structured sparsity to the input tensor. The calculation of Out(0,0) is shown in illustration 2200 with equation 2271 showing the calculation of the dot product between the expanded input 2255 and the kernel 2260 for Out(0,0). When the structurally zeroed values (padding and inserted spaces) are removed, only EI₁₁*K₁₁ only remains, which when translated to the proper element of the input tensor 2250, becomes I₀₀*K₁₁ as shown in equation 2272.

FIG. 22B shows graphical representations of calculating the remaining 24 output elements. Illustration 2201 shows the calculation of Out(0,1), illustration 2202 shows the calculation of Out(0,2), illustration 2203 shows the calculation of Out(0,3), and illustration 2204 shows the calculation of Out(0,4). Illustration 2210 shows the calculation of Out(1,0), illustration 2211 shows the calculation of Out(1,1), illustration 2212 shows the calculation of Out(1,2), illustration 2213 shows the calculation of Out(1,3), and illustration 2214 shows the calculation of Out(1,4). Illustration 2220 shows the calculation of Out(2,0), illustration 2221 shows the calculation of Out(2,1), illustration 2222 shows the calculation of Out(2,2), illustration 2223 shows the calculation of Out(2,3), and illustration 2224 shows the calculation of Out(2,4). Illustration 2230 shows the calculation of Out(3,0), illustration 2231 shows the calculation of Out(3,1), illustration 2232 shows the calculation of Out(3,2), illustration 2233 shows the calculation of Out(3,3), and illustration 2234 shows the calculation of Out(3,4). And finishing the calculation of the output 2270, illustration 2240 shows the calculation of Out(4,0), illustration 2241 shows the calculation of Out(4,1), illustration 2242 shows the calculation of Out(4,2), illustration 2243 shows the calculation of Out(4,3), and illustration 2244 shows the calculation of Out(4,4).

To be able to perform the fractional stride convolution operation shown in FIG. 22A-22B with the circuit 300 configured to operate as described by pseudocode 400A with or without the modification of 400B, the input tensor 2250 would need to be transformed into the expanded input 2255 which quadruples the amount of memory required to store the input tensor 2250. And even if that were to be done, a majority of the multiplies performed by the MAC(s) would be multiplication by zero, which is a huge waste of computational power. Transposed convolutions are common in the world of ML/AI so a more efficient mechanism to handle fractional strides would be helpful. Mechanisms and methods are described below that allow the multiplications by zero that are created by a fractional stride to be eliminated, which greatly reduces the amount of computation required as compared to a traditional approach. For example, in a 3D convolution using a 3×3×3 kernel where the stride is ⅓ in each of the three dimensions, a traditional approach would require 9×9×9=729 multiplications for each output element. Using the mechanisms and methods described below, the same convolution can be performed with 3×3×3=27 multiplications per output element, a 96% savings.

As was shown for the calculation of Out(0,0) not every kernel element is used to calculate every output element. But it was noticed that the output calculations can be divided into groups that use the same set of kernel elements. FIG. 22C shows group 0 which uses only Kernel(1,1) to calculate Out(0,0), Out(0,2), Out(0,4), Out(2,0), Out(2,2), Out(2,4), Out(4,0), Out(4,2), and Out(4,4). FIG. 22D shows group 1 which uses Kernel(1,0) and Kernel(1,2) to calculate Out(0,1), Out(0,3), Out(2,1), Out(2,3), Out(4,1), and Out(4,3). FIG. 22E shows group 2 which uses Kernel(0,1) and Kernel(2, 1) to calculate Out(1,0), Out(1,2), Out(1,4), Out(3,0), Out(3,2), and Out(3,4). FIG. 22F shows group 3 which uses Kernel(0,0), Kernel(0,2), Kernel(2,0) and Kernel(2,2) to calculate Out(1,1), Out(1,3), Out(3,1), and Out(3,3).

FIG. 23 shows a table 2300 of the dot products for the convolution operation of FIG. 22A-F organized into the groups identified in FIG. 22C-22F where each dot product used to calculate the outputs in that group that use the same kernel elements and have an equal number of multiply-accumulate operations. The first column provides the group ID, the associated figure showing the graphical representation of the group, and the first output element that is calculated using that group. The second column shows the full equation for each output element calculated in that group, and the third column shows pairs of kernel element and associated input element used for to calculate the first output element of that group.

Group 0 (illustrated in FIG. 22C) includes 9 of the 25 output elements. Output elements in group 0 require only a single multiplication using Kernel(1,1). Group 1 (illustrated in FIG. 22D) and group 2 (illustrated in FIG. 22E) each include 6 of the 25 output elements and require two multiply-accumulate cycles per output. Group 3 (illustrated in FIG. 22F) includes the remaining 4 output elements and each of those can be calculated with four multiply-accumulate cycles. So while a straightforward calculation for the convolution shown in FIG. 22A-22B would require 9 multiply-accumulate cycles for each of the 25 outputs, or 225 multiply-accumulate cycles along with the bandwidth to transmit the full kernel and full input data from the memory units 110, 120 to the compute unit 140, table 2300 shows that the 25 outputs can be computed using 9*1+6*2+6*2+4*4=49 multiply-accumulate cycles, a savings of over 78% compared to the 225 multiply-accumulate cycles of the brute-force approach.

Based on the observations made from the table 2300, it is clear that a technique that can eliminate the unnecessary multiply-accumulate cycles could result in significant increases in the speed of performing some convolution calculations. The look-up tables (LUTs) used in the pseudocode 400B of FIG. 4B provide the capability of reducing the number of multiply-accumulate cycles for a convolution calculation (as shown in the FIG. 11B by using 4 multiply-accumulates for a sparse 3×3 kernel), but the pseudocode of 400A, even as modified by the pseudocode 400B, uses the same number of multiply-accumulate cycles for every output element. One option would be to add a predicate in the LUT to allow additional null elements to be provided in some cases. So for the example shown in table 2300 using the pseudocode of 400A modified by pseudocode 400B, num_kernel_entries could be sent to 4, the maximum number of multiply-accumulate cycles for any group, and additional entries created in the other groups with the predicate set to indicate that a zero should be provided instead of read data for the input element, so that every group uses 4 multiply accumulate cycles. But in the example shown, this would still result in 100 multiply-accumulate cycles with 51 of them being a multiply by zero. While this is a significant savings from the 225 required by the approach shown in pseudocode 400A, it is still more than double the number of multiply-accumulate cycles that would be required by a technique that utilizes the findings shown in FIG. 23.

FIG. 24 is a block diagram of an example convolution address generator 1613 for a convolution operation that may be suitable for use in a reconfigurable memory unit 1610, as shown in FIG. 16, in an implementation of the present disclosure. While the use of the address generator 1613 is described herein for use in convolution operations, the address generator 1613 may be useful for other operations, such as pooling operations, which operate on a local region within a multidimensional tensor. For example an averaging pooling operation (AvgPool in PyTorch) can be implemented as a convolution operation having a stride equal to the kernel size with each element in the kernel set to be equal to 1/K where K is the total number of elements in the kernel. A maximum pooling operation (MaxPool) could use the same input address and output address generation as described for the average pooling operation, but with different programming of the ALUs in the PCU 1620 to calculate a max value instead of a multiply-accumulate.

The convolution address generator 1613 may receive configuration information from the configuration store 1618 to provide information about the convolution operation, such as the sizes of the input tensor, kernel, and output, hyperparameters, number of accumulators to use, or any other statically reconfigurable data for the convolution operation. Other implementations may provide the configuration information through control registers, data inputs, or any other suitable mechanism.

The convolution address generator 1613 includes a kernel element counter 2440 for a convolution operation between a kernel and an input tensor. The kernel element counter 2440 wraps back to an initial kernel count value after reaching a maximum kernel count value. The maximum kernel count value may be determined from the size of the kernel, by configuration information, or from a look-up table, depending on the implementation. The convolution address generator 1613 also includes an offset look-up table (LUT) 2450 that provides a relative input offset into the input tensor based on an output of the kernel element counter 2440. The relative input offset provided by the offset LUT is precomputed for a dilation value, an effective pad value, and/or a fractional stride value for the convolution operation.

In some implementations, the offset LUTs 2450 also include a kernel offset LUT providing a kernel offset into the kernel based on the kernel element counter 2440, or the offset LUT 2450 may include a combined LUT with separate fields for the relative input offset and kernel offset as shown in FIG. 24. In some implementations, the maximum kernel count value may be set to a value that is less than a size of the kernel and the offset LUT omits entries corresponding to elements of the kernel that would be multiplied by a zero value of the input for the convolution operation. This may occur due to a due to a fractional stride value for the convolution operation.

The convolution address generator 1613 also has location calculation logic 2470 that includes input location calculation logic to provide an input location within an input tensor for the convolution operation based on the relative input offset provided by the offset LUT 2450. The convolution address generator 1613 may also include outer location registers 2430, including an outer output base location register to provide an outer output base location register to provide an outer output base location for the convolution operation and, in some implementations, an outer input base location register to provide an outer input base location for the input tensor. In such implementations, the convolution address generator 1613 includes inner location registers 2460 which may include an inner input base register to provide an inner input base location for the input tensor and/or an inner output register to provide an output location 2457. The inner input base register is configured to load the outer input base location in response to the kernel element counter 2440 wrapping back to the initial kernel count value. The location calculation logic 2470 may include an adder in the input location calculation logic with a first input coupled to an output of the inner input base register, a second input coupled to an output 2455 of the offset LUT 2450, and an output to provide the input location 2475 as a sum of the inner input base location and the relative input offset 2455 provided by the offset LUT 2450. In some implementations, input location calculation logic includes circuitry to check the input location 2475 against bounds for the input tensor, and in response to determining that the input location 2475 is outside of the bounds, to set a predicate (such as an additional tag of one or more bits that is associated with the input location 2475) for the input location 2475 to indicate that no memory read should be performed and that a value of zero should be provided in place of data read from memory for the input location 2475.

In some implementations, the location calculation logic 2470 includes an accumulator counter 2472 configured to be reset to an initial accumulator value in response to a change in the kernel element counter 2440 and increment in response to a new input location 2475 being calculated, until reaching a maximum accumulator count value. The maximum accumulator count value can be based on the number of accumulators being used for calculating the output. In implementations with an accumulator counter 2472, several other circuit elements take action based on the accumulator counter 2472. The inner input base register is configured to increment in response to the accumulator counter 2472 wrapping back to the initial accumulator value and increment in response to the accumulator counter 2472 incrementing. The kernel element counter 2440 is configured to increment in response to the accumulator counter 2472 reaching the maximum accumulator count value. The inner output register is configured to increment in response to the accumulator counter 2472 incrementing and to load the outer output base location in response to the kernel element counter changing.

Implementations may include a group counter 2410 to provide a group number 2415. The group number 2415 is used to divide the output calculations into groups where each output included in the group has the same number of multiply-accumulate operations, which may be designated as “K.” In some cases, the groups may be further divided so that each output uses the same set of kernel values, as shown in FIG. 23. A group LUT 2420 may also be provided that provides a value K 2425 based on the group number 2415. The kernel element counter 2440 then uses the value K as the maximum kernel count value until the group number 2415 changes and the offset LUT 2450 provides the relative input offset 2455 further based on both the group number 2415 and the output 2445 kernel element counter 2440. The kernel offset 2453 from the kernel LUT is also based on both the output 2445 of the kernel element counter 2440 and the group number 2415.

There may be cases where, due to a fractional stride, a group of outputs may always be zero, i.e., the K value for that group is 0 and no multiplications need be performed for outputs in that group. Some implementations may include support for cases such as that by providing a predicate in the output 2455 of the offset LUT 2450 to indicate, for the relative input offset 2455 provided by the offset LUT 2450, whether (a) a memory read should be performed and data read from memory provided as data for the input tensor or (b) a value of zero should be provided as the data for the input tensor. Note that if that is done, the group LUT 2420 would provide a K value of 1 for those groups. The compute units would proceed to compute those outputs using the values of zero for the input tensor values without any changes to their design or configuration.

The convolution address generator 1613 also may include an output mux 2490 to select which of the kernel offset 2457, the input location 2475, and the output location 2457, to send to the header mux 1800 of the data path 1614 of the PMU 1610. In some implementations, however, the kernel offset 2457, the input location 2475, and the output location 2457, may all be provided to the header mux 1800 to be included in the inputs In0-InN 1801.

FIG. 25 shows two tables 2510, 2520 with the dot products for the convolution operation of FIG. 22A-F organized into separate groups having equal numbers of multiply-accumulate operations for each dimension of the convolution operation. This can be done because all of the hyperparameters for a particular convolution operation work symmetrically over a single dimension. Note that for the asymmetric kernel shown in FIG. 11A, this technique could not be used. Table 2510 shows the width dimension groups and table 2520 shows the height dimension groups. Tables 2510, 2520 provide the same information as shown in table 2300 but in a way that takes less storage space. Assume, for example, that each kernel offset value and relative input offset value requires 1 byte of storage. Storing the data in table 2300 would require 1 LUT location with 4 bytes of data for each 2D offset pair. That would be 9 LUT locations each holding 4 bytes of data, and in a general case, the LUT may have enough locations to be addressed by the number of bits required to address each element of the kernel plus the number of bits in the maximum group number. Storing the data for table 2510 requires 3 location each storing 2 bytes with the same amount for table 2520, or a total of 6 locations each storing 2 bytes, and in a general case, the LUT for a single dimension may have enough locations to be addressed by the number of bits required to hold the maximum size of the kernel in that dimension plus the number of groups in that dimension, which is a significant savings, especially for systems supporting 3 or more dimensions.

It can be shown that the information of table 2300 can be generated from the tables 2510, 2520 by generating all possibilities from the two tables 2510, 2520, which could be generated by addressing the two LUTs with two cascaded counters for the kernel element counter 2440. So the first group in table 2510 combined with the first group of table 2520 generates O(0,0) with a single pair of kernel/input offsets, k(1,1)/i(0,0) which is the same as group 0 in table 2300. Combining group 1 of table 2510 with group 0 of table 2520 generates O(0,1) with 2 pairs of kernel/input offsets, k(1,0)/i(0,0) and k(1,2)/i(0,1), which is the same as group 1 of table 2300. Combining group 0 of table 2510 with group 1 of table 2520 generates the same 2 pairs of kernel/input offsets as group 2 of table 2300 and combining group 1 of table 2510 with group 1 of table 2520 generates the same 4 pairs of pairs of kernel/input offsets as group 3 of table 2300.

So, in a convolution address generator 1613 supporting a multidimensional convolution, aspects of the calculation of the kernel offsets, the input locations, and the output locations may be split into separate elements per dimension, so that a counter becomes a chain of cascaded modulo counters, with individual counters per dimension the wrap at a maximum value for that dimension, and registers are broken into separate registers per dimension. A multidimensional convolution address generator 1613 can include a first dimension outer input base location register to provide an outer input base location for a first dimension of the input tensor and a second dimension outer input base location register to provide an outer input base location for a second dimension of the input tensor. It can also include a first dimension kernel counter of the kernel element counter for the first dimension of the kernel and a second dimension kernel counter of the kernel element counter for a second dimension of the kernel that is configured to increment in response to the first dimension kernel counter wrapping to its initial value from a maximum first dimension kernel count value. It can also include a first dimension offset LUT, indexed by an output of the first dimension kernel counter, that provides a first dimension relative input offset for a first dimension of the input tensor, and a second dimension offset LUT indexed by an output of the second dimension kernel counter that provides a second dimension relative input offset for a second dimension of the input tensor. Some other circuitry may also be divided by dimension, such as a first adder in the input location calculation logic with inputs coupled to the first dimension outer input base location register and the first dimension offset LUT, having an output to provide a first dimension of the input location, and a second adder in the input location calculation logic with inputs coupled to the second dimension outer input base location register and the second dimension offset LUT, having an output to provide a second dimension of the input location. Other implementations may support any number of dimensions and it should be clear to one of ordinary skill that the techniques described herein can be extended to provide an implementation supporting three dimensional convolutions, four dimensional convolutions, five dimensional convolutions, or any number of dimensions depending on the application and the implementation.

For a multi-dimensional implementation, the size of the LUTs for each dimension is dependent upon the maximum size of the kernel supported for that dimension, not the size of the input. Thus, if an implementation wants to support a maximum kernel size of 16×16, it would need to provide 16 valid entries for each dimension offset LUT, not a LUT of 16×16=256 entries. The maximum number of groups is dependent upon the maximum stride to be supported, so if the maximum supported stride is 8×8, each dimension offset LUT would need to support 8 groups. To support the general case, where one group uses all 16 entries and the other 7 groups are null but still need an entry to indicate that a zero should be provided for this group, each offset LUT would need to have a number of entries equal to the maximum supported kernel size+the maximum supported stride minus 1, or 16+8−1=23 entries in this example. The maximum size of each entry depends upon the maximum dilation and kernel size to be supported, so to support dilation of up to 8×8 with a maximum kernel of 16×16, the largest offset would be 16×8=128 which requires 7 bits to represent. In addition, a bit for predication may be included in the offset LUTs 2450 so the 2D example described would have two 128×8 bit LUTs. The group LUTs 2420 simply need enough entries for the number of groups and enough bits per entry to represent the maximum stride, so for the example described 8 entries with 4 bits per entry, or two 8×4 bit LUTs which might could be implemented with memory device loadable with data or with combinatorial logic (e.g., multiplexors) to select the appropriate bits directly from the configuration store or CSRs to provide the K value for each group.

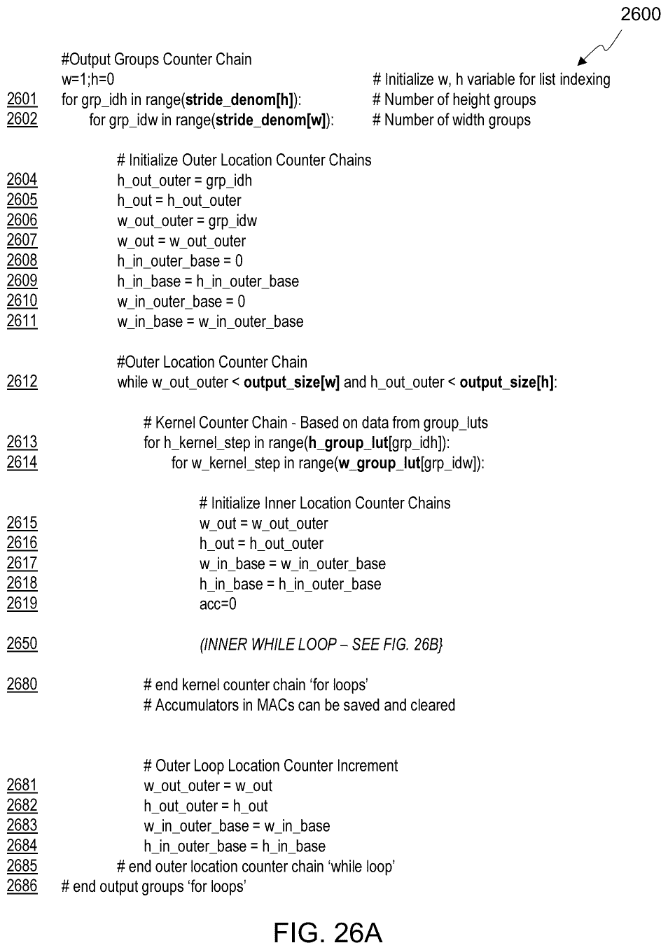

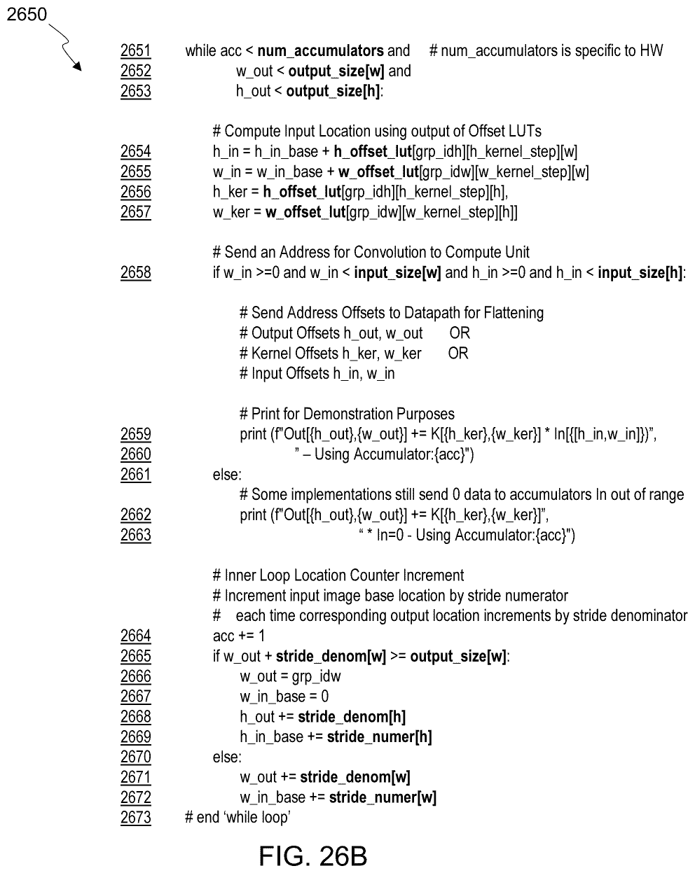

FIGS. 26A and 26B combine to be a pseudocode listing 2600 showing more detail of the operation of an implementation of the circuit 1613 shown in FIG. 24 to generate addresses for a convolution operation. The pseudocode 2600 is written in Python but it should be noted that while the Python code is normally executed in a sequential fashion, its purpose here is to illustrate the functionality of the circuit 1613 which has different blocks of circuitry that can operate in parallel and/or in a cascaded fashion where the function of one block of hardware is dependent upon an output of another block of hardware. Thus, the linear functionality of the pseudocode 400A should not be seen as limiting on implementations. Note that the pseudocode 2600 shows a 2D convolution but could easily be extended to higher dimensions by one of ordinary skill in the art. Also note that bolded variables (and immediate values) may be received in a CSR or configuration bits for the particular convolution operation. The portion of pseudocode 2600 shown in FIG. 26A includes an inner ‘while loop’ in line 2650 which can be replaced by the pseudocode 2650 shown in FIG. 26B to fully create pseudocode 2600.

As can be seen in the pseudocode 2600 as it applies to the convolution address generator 1613, to initiate the generation of the sequence of addresses for a convolution operation, the group counters 2410 (grp_idh, grp_idw), the kernel element counters 2440 (h_kernel_step, w_kernel_step), outer location registers 2430 (h_out_outer, w_out_outer, h_in_outer_base, w_in_outer_base), inner location registers 2460 including the inner input base register (h_in_base, w_in_base) and the inner output register (h_out, w_out), and the accumulator counter 2472 (acc) are all initialized. This is shown in lines 2601-2619 of the pseudocode 2600. In some implementations, the counters/registers may be initialized to zero and a base address added into the memory address by the general address calculation data path 1614. This description discusses the various elements of the convolution address generator 1613 as if they were a single register or counter, while the pseudocode 2600 is written for a two dimensional implementation, and implementations for 3D convolution or higher dimensionality are envisioned. One of ordinary skill can understand how cascading modulo counters for each dimension and separate registers for each dimension of a general register can function similarly to the discussion of a single dimension. As this description continues, a leading “h_” or “w_” or a trailing “h” or “w” may be omitted from variable names to indicate the discussion refers to the combined multidimensional counter/register (i.e., grp_id refers to the cascaded group counters 2410 represented by variables grp_idh and grp_idw).

The number of elements (K) 2425 for the first group (group 0) is accessed from the group LUT 2420 (group_lut) and used as the modulo value (i.e., the wrap value) for the kernel element counter 2440 as shown in lines 2613-2614. Note that for convolutions having integer stride values, there will be only one group so the functionality of the pseudocode 2600 and the functionality of the pseudocode 400A as modified by pseudocode 400B is essentially the same for such convolution operations. With the value of the kernel element counter 2440 (kernel_step) kept constant, the accumulator counter 2472 (acc) counts from its initial value (e.g., 0) to num_accumulators (represented by the inner ‘while loop’ 2650 with line 2664 showing acc being incremented) and for each value of the accumulator counter 2472 (acc), the offset LUT 2450 (offset_lut) is accessed and added to the inner input base register (in_base) to generate an input location 2475 (in), as shown in lines 2654-2655, which is sent to the data path 1614 to generate the linear address for the input tensor element, which is represented by lines 2659-2660 as a placeholder for that action which takes place outside of the convolution address generator 2613. Note that if the input location exceeds the bounds of the input tensor (line 2658), a predicate may be added to the input location (represented by lines 2661-2663 as a placeholder) to indicate that no read should be performed but that a value of 0 should be provided for that element of the input tensor. The kernel offset 2453 (ker) may also be accessed from the offset LUT 2450 (offset_lut) as shown in lines 2656-2657, and sent to data path 1614 in a PMU 1610 that is providing kernel elements to the PCU 1620. In a PMU 1610 that is generating output locations (out), the K value in from the group LUT (group_lut) may be set to 1 for all groups to generate the correct number of output locations in the correct order.

As the accumulator counter 2472 is incremented (acc), represented at line 2664, the inner output register (out) is incremented by the stride numerator (stride_numer) (i.e., 1 for a fractional stride and the stride value for an integer stride), the inner input base register is incremented by the denominator (stride_denom) of the stride value (i.e. 1 for an integer stride value and the denominator for a fractional stride amount-two if the stride value is ½ for example) for use with the new accumulator value in calculating the next input location 2475 (in). Note that for a multidimensional implementation, the dimensional registers are cascaded. In the 2D implementation shown in pseudocode 2600, the width registers (w_out, w_in_base) are incremented using the stride values as described above (using stride_denom [w] and stride_numer [w]) and if the width inner output register (w_out) is larger than the output width (output_size[w]), it is reset to the current width group counter value (grp_idw) and the height inner output register (h_out) is incremented. The inner input base registers (in_base) are handled in a similar manner when the width inner output register (w_out) exceeds the output size (output_size[w]). This is represented by lines 2665-2672, which are structured somewhat differently than the discussion due to the differences between the linearly executed code and hardware but have the same result.

Because the stride denominator and stride numerator are implemented separately for each dimension, each dimension can have a unique stride value that can be either an integer stride or a fractional stride (with the numerator equal to 1). So for example, a convolution with a stride of 2 in the width dimension and a stride of ¼ in the height dimension is supported by the disclosed implementation.

Once the accumulator (acc) reaches its maximum value, the kernel element counter 2440 (kernel_step) is incremented at lines 2613-2614, the inner output register (out) is set back to the outer output register (out_outer) at lines 2615-2616, the inner input base register (in_base) is reset to the value of the outer input base register (in_outer_base) at lines 2617-2618, and the accumulator counter 2472 (acc) is reset at line 2619. The inner ‘while loop’ 2650 actions are then performed again with the new output 2445 of the kernel element counter 2440 (kernel_step). Note that if the inner output register (out) exceeds the expected size of the output (output_size), the accumulator counter 2472 (acc) stops counting and things proceed as if the accumulator counter 2472 had reached its maximum value as described above.

When the kernel element counter (kernel_step) 2440 reaches its maximum value as determined by the output of the group LUT (group_lut) 2420 (signified by exiting the ‘for loop’ at line 2680), all of the locations in the receptive fields of input tensor used for the output elements being concurrently accumulated in the MACs have been generated and sent, so the outer output base location register (out_outer) is updated with the last value of the inner output register (out) at lines 2681-2682 and the outer input base register (in_outer_base) is updated with the value of the inner input base register (in_base) at lines 2683-2684. The outer ‘while loop’ which extends from line 2612 through line 2685 (and includes the inner ‘while loop’ 2650) represents a check of the outer output base location register (out_outer) to detect when all of the outputs included in a group have been processed. If the outer output base location register (out_outer) has exceeded the size of the output (output_size), the outer ‘while loop’ exits at line 2685 and the group counter 2410 (grp_id) is incremented to a new value (lines 2601-2602). Then the process of counting through the accumulator values for each value of the kernel element counter (kernel_step) 2440 to generate the input locations repeats for that group.

With the updated group number 2415 from the group counter 2410 (grp_id), the kernel element counter 2440 (kernel_step), outer input base register 2430 (in_outer_base), the inner input base register (in_base), and the accumulator counter 2472 (acc) are all re-initialized at lines 2608-2611. The outer output base location register (out_outer) and the inner output register (out) are set to the updated group number 2415 from the group counter 2410 (grp_id) at lines 2604-2607. This represents the first output element for the group. The inner ‘while loop’ 2650 is entered and a new input location is generated for each value of the accumulator counter 2472 (acc) as it increments from 0 to num_accumulators as discussed above with the same handling of the inner location registers 2460 (in_outer_base, in_base). This repeats for each new value of the kernel element counter 2440 (kernel_step) until ‘K’ 2425 for that group is reached when the group counter 2410 (grp_id) increments again. Once all of the groups have been processed, all of the addresses for the convolution operation have been generated and the convolution address generator 1613 can enter a quiescent state and wait for the next convolution operation, as indicated by exiting the output group ‘for loops’ at line 2686. Note that the number of groups is equal to the denominator of the stride hyperparameter for the convolution operation.

In some implementations, one or more dimensions may be configured to operate in a bypass mode where the offset LUT is bypassed and the offsets are calculated in real-time by hardware based on the hyperparameters. This may allow a wider range of certain hyperparameters to be accommodated.

Thus, the pseudocode 2600, as applied to the convolution address generator 1613, shows a method for use in a convolution operation between a kernel and an input tensor that includes counting, using a kernel element counter 2440 from an initial kernel count value to a maximum kernel count value before wrapping back to the initial kernel count value, using an offset look-up table (LUT) 2450 to look up a relative input offset 2455 into the input tensor based on an output 2445 of the kernel element counter 2440, and calculating an input location 2475 within an input tensor for the convolution operation based on the relative input offset 2455 provided by the offset LUT 2450. The relative input offset 2455 provided by the offset LUT 2450 can be precomputed for a dilation value, an effective pad value, and/or a fractional stride value for the convolution operation.

The method may also include providing a group number 2415 from a group counter 2410, obtaining a value K 2425 from a group LUT 2420 based on the group number 2415, and using the value K as the maximum kernel count value for the kernel element counter 2440 until the group number 2415 changes. The group number 2415 may also be used as a further index into the offset LUT 2450 to look up the relative input offset 2455.

In some implementations, the method includes initializing an outer output base location register to provide an outer output base location for the convolution operation, initializing an outer input base location register to provide an outer input base location for the convolution operation, and calculating an input location 2475 based on the outer input base location and the output 2445 of the kernel element counter 2440. An accumulator counter 2472 may be reset to an initial accumulator value in response to a change in the kernel element counter 2440 and incremented in response to a new input location being calculated. The kernel element counter 2440 may be incremented in response to the accumulator counter 2472 reaching the maximum accumulator count value. An inner input base register can be incremented in response to the accumulator counter 2472 being incrementing to provide the inner input base location, and the inner input base register can also be incremented in response to the accumulator counter 2472 wrapping back to the initial accumulator value. The outer input base location is loaded into the inner input base register in response to the kernel element counter 2440 wrapping back to the initial kernel count value and the input location is calculated based on the inner input base location and the output 2445 of the kernel element counter 2440.

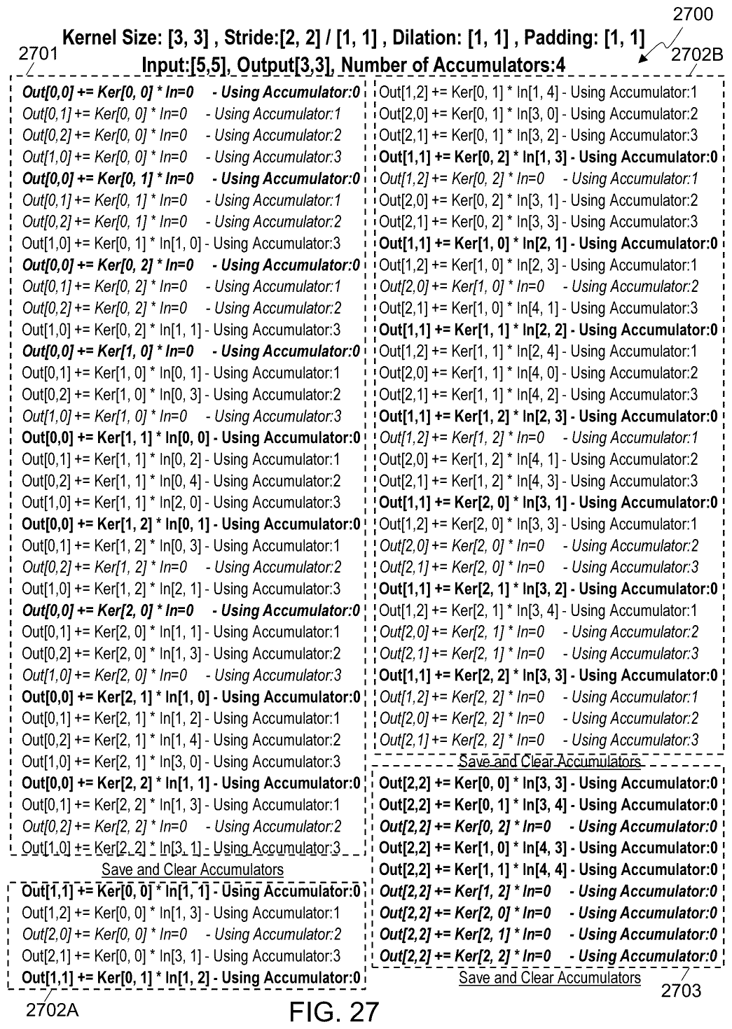

FIG. 27 is listing of operations 2700 that may be generated in an implementation of a convolution calculation engine to perform the convolution operation shown in FIG. 21 using example convolution address generator 1613 shown in FIG. 24 using 4 accumulators. Note that the 2×2 stride is properly accounted for in the generation of the input locations with the receptive field of the input tensor for Out(1,1) being 2 elements to the right and down as compared to the receptive field of the input tensor for Out(0,0). The first block 2701 shows 9 sets of 4 pairs of kernel/input elements being sent to the compute unit to generate the Out(0,0), Out(0,1), Out(0,2) and Out(1,0) using the four accumulators. The next block 2702A-2702B shows 9 sets of 4 pairs of kernel/input elements being sent to the compute unit to generate the Out(1,1), Out(1,2), Out(2,0) and Out(2,1) using the four accumulators with the final block 2703 generating 9 pairs of kernel/input elements for a single accumulator to calculate the final output, Out(2,2).

This convolution calculation was generated using the 2D convolution calculation engine simulated in pseudocode 2600 with cascaded kernel counters and separate registers for each dimension for the outer location registers 2430 and inner location register 2460. Separate group LUTs 2420 and offset LUTs 2450 are also provided for each dimension. Because the stride denominator for the convolution operation is 1 with a stride numerator of 2 (in each dimension), there is only one group in each dimension, so the width group LUT and the height group LUT 2420 each have a K value of 3 (the size of the kernel in that dimension) at location 0. The width offset LUT and the height offset LUT 2450 each have three entries for the group 0 portion of the LUTs 2450. Any other entries of the offset LUTs 2450 ae unused and can have any data.

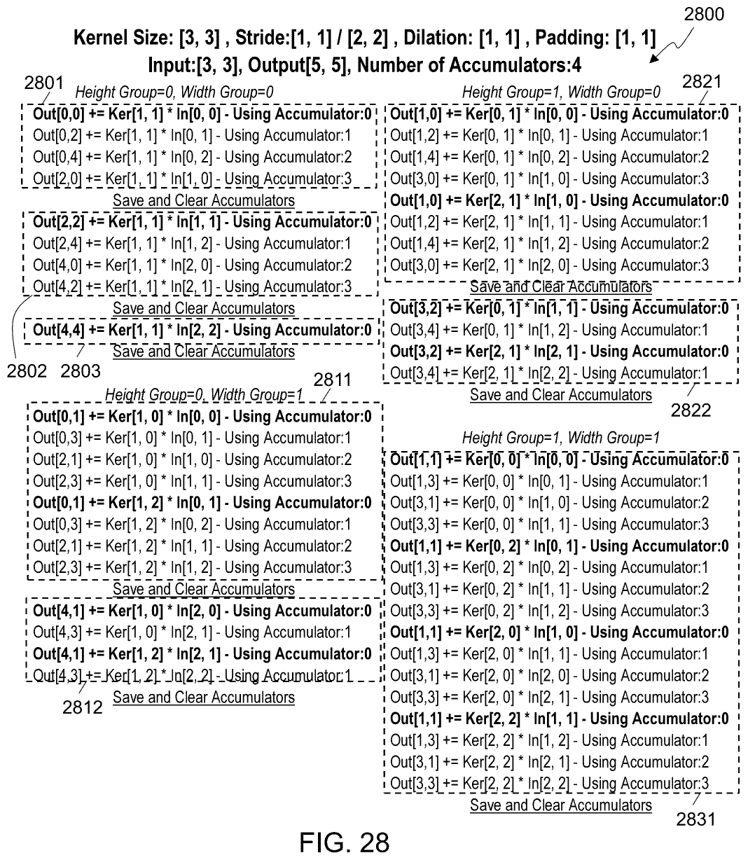

FIG. 28 is listing of operations 2800 that may be generated in an implementation of a convolution calculation engine to perform the convolution operation shown in FIG. 22A-22F using example convolution address generator 1613 shown in FIG. 24 using 4 accumulators. The convolution address generator 1613 supports the two dimensional convolution as described in pseudocode 2600 in FIG. 26A-26B with the two group LUTs 2420 each loaded with a “1” for group 0 and “2” for group 1. The offset LUTs 2450 (the width offset LUT and the height offset LUT) are loaded with pairs of kernel offsets and input offset pairs as shown in FIG. 25, each LUT having one entry in group 0 with a kernel offset of 1 and relative input offset of 0, and two entries in group 1 with (0,0) and (2,1) as the pairs of kernel/input offsets.

The first three blocks of operations 2801, 2802, 2803 show the pairs of kernel offsets and relative input offsets for the outputs in both the first height group and the first width group, group (0,0). Because group (0,0) outputs require only a single pair of kernel/input offsets using the same kernel offset, block 2801 shows the calculation of the first four group (0,0) outputs as 4 sets of a single kernel/input pair using the four accumulators. Block 2802 shows the calculation of the next four outputs of group (0,0), and block 2803 shows the calculation of the ninth and final group (0,0) output, using a single accumulator.

The next two blocks of operations 2811, 2812 show the pairs of kernel offsets and relative input offsets for the outputs in group (0,1). Each output in group (0,1) uses two multiply-accumulate operations using two kernel/input pairs so block 2811 shows two sets of four kernel/input pairs using the four accumulators to generate four outputs of group (0,1) and block 2812 shows two sets of two kernel/input pairs using two accumulators to generate the last two outputs of group (0,1). Block 2821 and block 2822 show similar behavior for the calculation of the outputs of group (1,0). The four outputs of group (1,1) are all generated, using all 4 accumulators, in block 2831, with four sets of four kernel/input pairs used to generate the four multiply-accumulate operations needed for the each of the outputs of group (1,1).

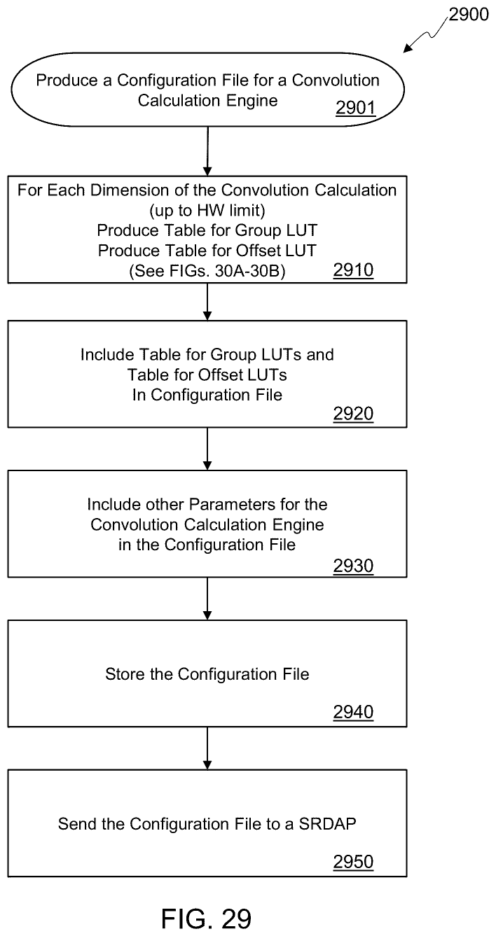

FIG. 29 shows a flowchart 2900 of a method for use by a compiler to produce 2901 a configuration file to configure a convolution calculation engine in an implementation of the present disclosure. The convolution calculation engine may be included in a statically reconfigurable unit in an array of coarse-grained reconfigurable (CGR) units of a statically reconfigurable dataflow architecture processor. The convolution calculation engine can generate an address sequence for a convolution operation between an input tensor and a filter kernel. The convolution operation has a dilation value, an effective padding value, and a stride value.

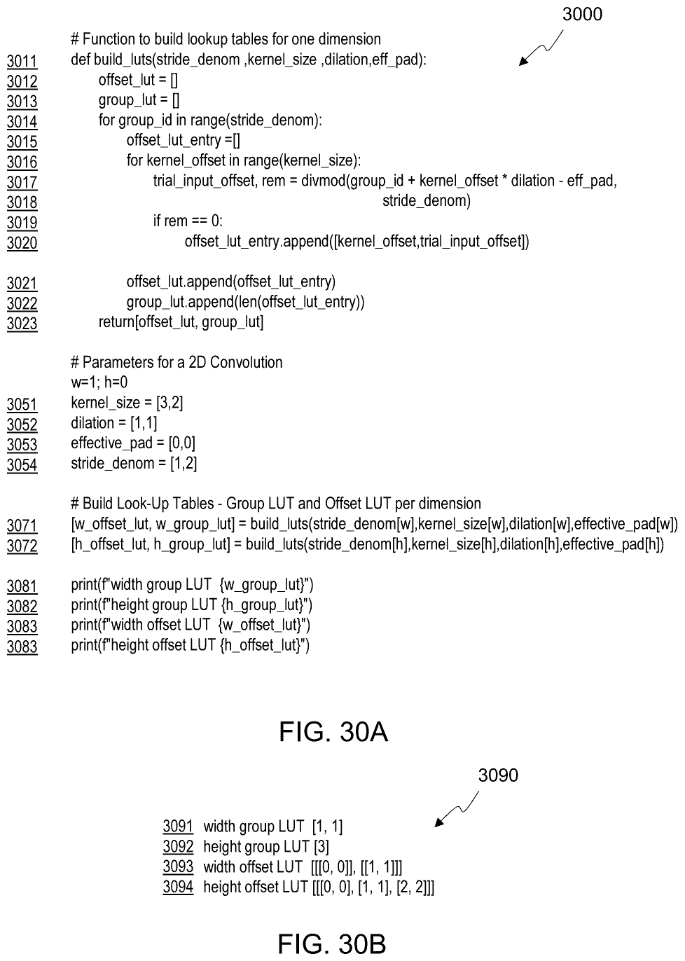

The method continues by producing 2910 a group table to be loaded into a group LUT 2420 and an offset table to be loaded into an offset LUT 2450 of a convolution address generator 1613 of the convolution calculation engine. In some implementations, a separate group table and offset table may be produced for each dimension supported by the convolution calculation engine. Python code 3000 shown in FIG. 30A provides more detail on how the tables may be produced and FIG. 30B shows example tables to be loaded into group LUTs and offset LUTs.

The group table(s) and offset table(s) are then included 2920 in a configuration file for the convolution calculation engine and other parameters for the convolution calculation engine are also included 2930 in the configuration file. Other parameters may include such things as hyperparameters for the convolution operation (e.g., stride denominator, stride numerator, input tensor size, kernel size, and/or output size). The other parameters may also include a number of accumulators to be used for the convolution operation, and a selection value to determine whether a kernel element is to be read from memory of the CGR unit and sent to CGR compute unit, an input tensor element is to be read from memory of the CGR unit and sent to CGR compute unit, or the CGR unit is to receive an output element and write the output element to memory at an output address in the CGR unit.

The configuration file may have additional configuration information for the CGR unit added before it is stored 2940 for later use. The configuration file can be considered computer instructions to cause the convolution calculation engine to perform a method to calculate a convolution operation. The method may conclude by sending 2950 the configuration file to a CGR unit, which may be in a statically reconfigurable dataflow architecture processor (SRDAP), to configure at least a portion of the SRDAP to act as a convolution calculation engine.

FIG. 30A is a Python listing 3000 of operations for a compiler to generate configuration information for an implementation of the present disclosure. While the listing 3000 is written in Python, it could be implemented in any suitable computer language. Note that the listing 3000 does not purport to be a full compiler, but only includes a snippet of code to produce lookup tables for an implementation of a convolution address generator circuit such as the convolution address generator 1613 shown in FIG. 24. The listing 3000 is representative of an implementation of generating lookup tables in a compiler as shown in block 2910 of FIG. 29. The compiler can be directed toward any type of configurable hardware to implement the convolution calculation engine, but implementations may be directed to convolution calculation engine using one or more statically reconfigurable units in an array of coarse-grained reconfigurable (CGR) units of a statically reconfigurable dataflow architecture processor.

The Python listing 3000 has four sections. The first section of lines 3011-3023 is a function to build two lookup tables for a single dimension of a convolution operation. Note that this section will not execute until called by a later section of the listing 3000. The second section of lines 3051-3054 simply initializes hyperparameters for a particular convolution operation that are needed to generate the LUTs. In the example shown in listing 3000, the hyperparameters are for a convolution that has different hyperparameters for each dimension. The third section of lines 3071-3072 builds the lookup tables by calling the function shown in first section of lines 3011-3024. The function is called two times, one time for each dimension, with appropriate parameters to generate an offset LUT for width (w_offset_lut), a group LUT for width (w_group_LUT), an offset LUT for height (h_offset_lut), and a group LUT for height (h_group_LUT). Other implementations may generate a table for a single offset LUT the provides outputs for multiple dimensions rather than generating a separate table for each dimension. The final section of the listing 3000 simply prints out the data in the LUTs in lines 3081-3083. This output is shown as tables 3090 in FIG. 30B. In an actual compiler, the tables would be included as appropriate in the configuration file and not simply printed.

At line 3071, the compiler code snippet calls the build_luts function for the width dimension of the convolution operation with parameters matching hyperparameters for the convolution operation denoting a fractional stride amount (stride_denom-set to 1 for integer stride values or the denominator of a fractional stride amount with a numerator of 1), a kernel size (kernel_size), a dilation value (dilation) and an effective padding value (effective_pad)—each of the parameters is for the dimension of the offset table, e.g., the width dimension in line 3071.

The build_luts function, starting at line 3011 and using the parameters for the dimension called, builds two tables (each represented by a Python list in the example shown), offset_lut and group_lut, which are initialized in lines 3012-3013. It is known that the number of groups will be equal to the stride denominator of the stride value for a dimension (where at least one of the stride numerator and denominator is 1), so the ‘for loop’ at line 3014 and ending at line 3022 is used to increment the group_id variable from 0 to stride_denom−1. The group_id for a dimension can also be thought of as an offset into the expanded input tensor in that dimension for a fractional stride (see FIG. 25), which is why the number of groups is determined by the denominator of the stride value.

The offset_lut table is configured as a list of lists of lists where the inner dimension is list of two items, the kernel offset and relative input offset, that will be provided as different fields of the output of the hardware offset LUTs 2450 in parallel. The outer dimension is indexed by the group number (group_id) and the middle dimension is indexed by a position within the K elements provided for that group. This corresponds to the kernel element count output 2445 of the hardware 1613. So, in the hardware 1613, the group number 2415 will be coupled to upper address bits of the offset LUTs 2450 and the output 2445 of the corresponding dimension kernel element counter 2440 will be coupled to the lower address bits of the offset LUTs 2450. Note that because different groups may have different numbers of pairs of kernel offset/relative input offset, not all of the storage locations in the offset LUTs 2450 may be used for all groups. While not shown in the listing 3000, some implementations may fill the unused locations in the table (one or both of unused groups and unused locations within a group) with a value, such as 0, to fully populate the memory device used for the offset LUTs 2450 in the hardware of the convolution address generator 1613.

Within the group ‘for loop’, a list is built for each group which is initialized at line 3015. Another ‘for loop’ (lines 3016-3020) is used to walk through all possible kernel offsets (kernel_offset) based on the size of the kernel (kernel_size). For each possible kernel offset, it is determined whether the relative input offset for a location of that kernel offset added to the group number is divisible by the denominator of the stride value. In the example of FIG. 30, this is done using the Python divmod function in lines 3017-3018 with the relative input offset calculated based on the dilation and effective padding values for the convolution operation. If the remainder is 0 (as tested in line 3019), then the relative input offset added to the group number is included in the offset_lut table along with the kernel offset. In line 3020. Once all of the possible kernel offsets have been checked, that ‘for loop’ exits to line 3021 where the list of pairs of kernel offsets and relative input offsets are added to the offset_lut table for the current group (group_id). The number of pairs of kernel offsets and relative input offsets for the current group is added to the group_lut table in line 3022. Once the kernel offsets and relative input offsets for each group have been generated, the ‘for loop’ for the group counter exits and the function returns the offset_lut table and group_lut table at line 3023.

The tables 3090 produced by the code 3000 can be seen in FIG. 30B. The width group LUT 3091 includes two entries corresponding to the two groups (the stride denominator value for width) and indicate that both group 0 and group 1 have a K value of 1. The height group LUT 3092 includes a single entry for group 0 and indicates that it has a K value of 3.

The width offset LUT 3093 shows a single entry for both the first group and the second group. The single entry for group 0 is k(0), i(0) and the entry for group 1 is k(1), i(1). The three entries for group 0 in the height offset LUT 3094 are k(0), i(0); k(1), i(1); and k(2), i(2).

Thus, a computer-implemented method for producing a configuration file to configure a convolution calculation engine can include determining a first group of relative input offsets into the input tensor for an output element of an output of the convolution operation based on the dilation value, and the effective padding value, generating an offset table including the first group of relative input offsets to load into an offset look-up table (LUT) in the convolution calculation engine, the offset table indexable by an index count, and including the offset table in the configuration file. The convolution calculation engine may use one or more statically reconfigurable units in an array of coarse-grained reconfigurable (CGR) units of a statically reconfigurable dataflow architecture processor to generate an address sequence for a convolution operation between an input tensor and a kernel.

The method can also include determining a first group of kernel offsets for the output element corresponding to the first group of relative input offsets. In some cases the stride value is a fractional stride value with a stride numerator of 1 and a stride denominator that is a positive integer and the method includes determining a number of groups of pairs of kernel offsets and relative input offsets for the convolution operation, with the number of groups equal to the stride denominator. Each of the groups of pairs of kernel offsets and relative input offsets are then included in the offset table, with the offset table also indexable by a group number in addition to the index count. The method then goes on to determine a number of pairs of kernel offsets and relative input offsets in each group of the number of groups and generate a group table including the number of pairs in each group to load into a group LUT in the convolution calculation engine, with the group table indexable by the group number. The group table is also included in the configuration file. Any combination of a size of the output of the convolution operation, a number of accumulators to use for the convolution operation, a size of the input tensor, and/or the stride value (which may include a stride numerator value and a stride denominator value) in the configuration file can be included in the configuration file for use by the convolution calculation engine.

The method can also include determining a first group of kernel offsets for the output element corresponding to the first group of relative input offsets and determining a first index count based on a first kernel offset in the first group of kernel offsets. A first relative input offset in the offset table corresponding to the first kernel offset is then calculated by multiplying the first kernel offset by the dilation value and subtracting the effective padding value. The first relative input offset can then be stored in the offset table at a location indexed by the first index count. A kernel table can also be generated that includes the first group of kernel offsets to load a kernel LUT in the convolution calculation engine. The kernel table is indexable by the index count so that for a given index count, the relative input offset in the offset table corresponds to the kernel offset in the kernel table and in some cases, the offset table and kernel table are separate fields of a common table stored in a combined offset LUT. The kernel table of the kernel offsets can also be included in the configuration file.

The method may multiply the first kernel offset by the dilation value, add the first group number and subtract the effective padding value, and then divide that result by the stride denominator to obtain an integer quotient and a remainder. The integer quotient may then, in response to the remainder being 0, be added as the first relative input offset to the offset table and the first kernel offset may be added to kernel table. An elements counter which is reset to zero at a start of calculating a group of the number of groups of pairs can be used as the first index count for adding both the integer quotient to the offset table and the first kernel offset to the kernel table. The elements counter can then be incremented after adding both the integer quotient to the offset table and the first kernel offset to the kernel table. The method can also include sending the configuration file to the statically reconfigurable dataflow architecture processor to configure the convolution calculation engine to generate an address sequence for a convolution operation between an input tensor and a kernel.

A non-transitory machine-readable medium can include computer instructions that, in response to being executed by a processor, cause the processor to produce a configuration file using a method for a compiler described herein. The configuration file can be used to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel.

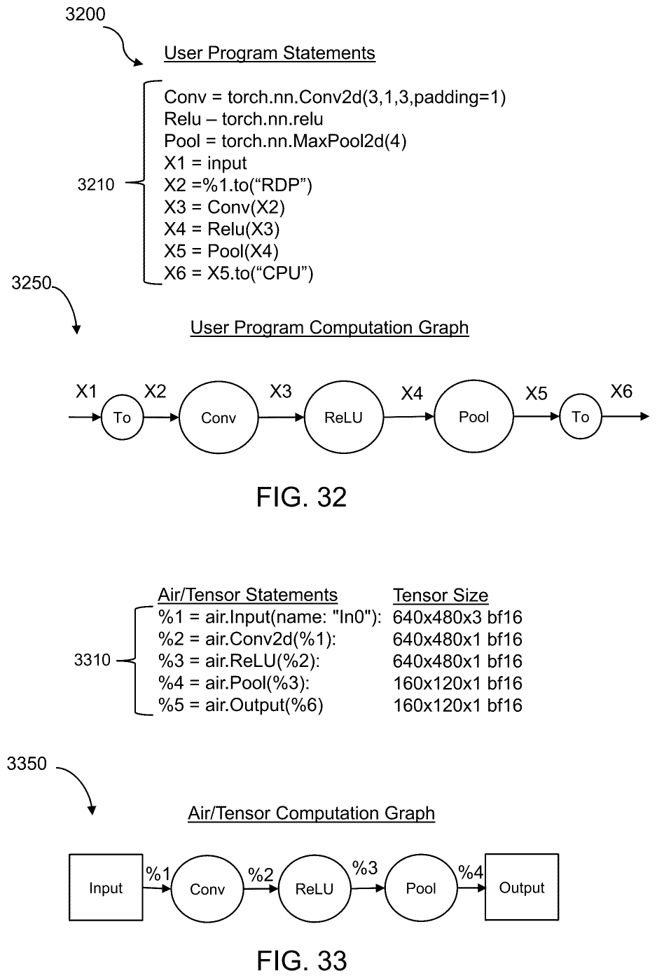

FIG. 31 is a block diagram of a compiler stack 3100 implementation suitable for generating a configuration file for a statically reconfigurable dataflow architecture processor. FIGS. 32-36 illustrate various representations of an example user program 3200 corresponding to various stages of a compiler stack such as compiler stack 3100. As depicted, compiler stack 3100 includes several stages to convert a high-level program (e.g., user program 3200) with statements 3210 that define user algorithms and functions, e.g., algebraic expressions and functions, to configuration data for the CGR units. The example user program 3200 depicted in FIG. 32 comprises statements 3210 that invoke various PyTorch functions, including Conv2d which can utilize the functionality of the convolution address generator described herein.

Compiler stack 3100 may take its input from application platform 3110, or any other source of high-level program statements suitable for parallel processing, which provides a user interface for general users. It may further receive hardware description 3115, for example defining the physical units in a reconfigurable data processor or CGRA processor. Application platform 3110 may include libraries such as PyTorch, TensorFlow, ONNX, Caffe, and Keras to provide user-selected and configured algorithms. The high level program may include a convolutional neural network (CNN) with one or more convolutional layers that can use a convolution calculation engine as described herein.

Application platform 3110 outputs a high-level program to compiler 3120, which in turn outputs a configuration file to the reconfigurable data processor or CGRA processor where it is executed in runtime processes 3130. Compiler 3120 may include dataflow graph compiler 3121, which may handle a dataflow graph, algebraic graph compiler 3122, template graph compiler 3123, template library 3124, and placer and router PNR 3125. In some implementations, template library 3124 includes RDU abstract intermediate language (RAIL) and/or assembly language interfaces for power users.

Dataflow graph compiler 3121 converts the high-level program with user algorithms and functions from application platform 3110 to one or more dataflow graphs. The high-level program may be suitable for parallel processing, and therefore parts of the nodes of the dataflow graphs may be intrinsically parallel unless an edge in the graph indicates a dependency. Dataflow graph compiler 3121 may provide code optimization steps like false data dependency elimination, dead-code elimination, and constant folding. The dataflow graphs encode the data and control dependencies of the high-level program. Dataflow graph compiler 3121 may support programming a reconfigurable data processor at higher or lower-level programming languages, for example from an application platform 3110 to C++ and assembly language. In some implementations, dataflow graph compiler 3121 allows programmers to provide code that runs directly on the reconfigurable data processor. In other implementations, dataflow graph compiler 3121 provides one or more libraries that include predefined functions like linear algebra operations, element-wise tensor operations, non-linearities, and reductions required for creating, executing, and profiling the dataflow graphs on the reconfigurable processors. Dataflow graph compiler 3121 may provide an application programming interface (API) to enhance functionality available via the application platform 3110.

A compiler stack 3100 can be configured to run on a data processing system, such as computer 1300 shown in FIG. 13. The compiler stack 3100 is configured produce a configuration file to configure a convolution calculation engine to generate an address sequence for a convolution operation between an input tensor and a filter kernel. The convolution operation has a dilation value, an effective padding value, and a stride value. The convolution calculation engine may include one or more statically reconfigurable units in an array of coarse-grained reconfigurable (CGR) units of a statically reconfigurable dataflow architecture processor. A description of how the compiler stack 3100 generates the configuration file for the convolution calculation engine has already been described above.

FIG. 32 shows an example user program 3200 in an example first stage of the compiler stack. User program 3200 receives a 2d input tensor X1. It provides the tensor to a neural network cell that performs the 2d convolution, followed by a rectified linear unit (ReLU) activation function, which is followed by a MaxPool activation function. FIG. 32 does not show the weights and bias used for the weighing function. User program 3200 corresponds with computation graph 3250.

Algebraic graph compiler 3122 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 3122 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 3122 may further include an arithmetic or algebraic intermediate representation (AIR) level that translates high-level graph and mapping decisions provided by the MAC level into explicit AIR/Tensor statements 3310 (see FIG. 33) and one or more corresponding algebraic graphs 3350. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 33 shows the user program 3200 in an example second stage of the compiler stack. At this stage, the algebraic graph compiler may replace macros by their constituents. Thus, algebraic graph compiler 3122 replaces the user program statements 3210, also shown as computation graph 3250, by AIR/Tensor statements 3310, also shown as Air/Tensor computation graph 3350.

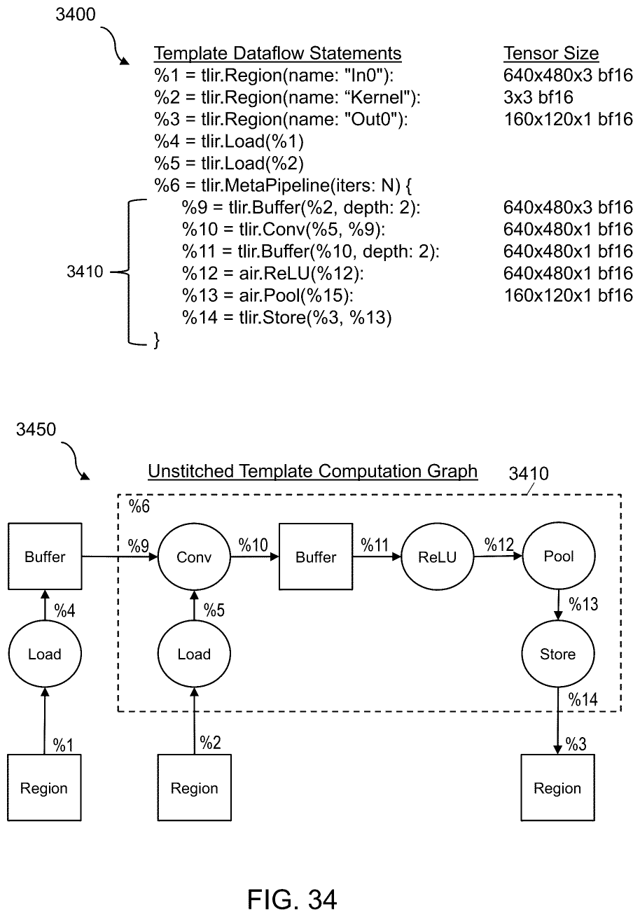

Template graph compiler 3123 may translate AIR statements and/or graphs into TLIR statements 3400 (see FIG. 34) and/or graphs (graph 3450 is shown), optimizing for the target hardware architecture into unplaced variable-sized units (referred to as logical CGR units) suitable for PNR 3125. Template graph compiler 3123 may allocate metapipelines, such as metapipeline 3410, for sections of the template dataflow statements 3400 and corresponding sections of unstitched template computation graph 3450. Template graph compiler 3123 may add further information (name, inputs, input names and dataflow description) for PNR 3125 and make the graph physically realizable through each performed step. Template graph compiler 3123 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 3124 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

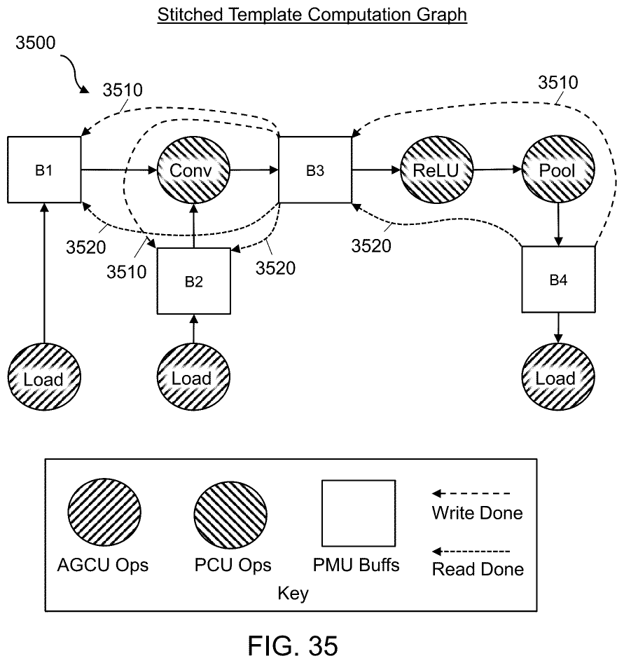

FIG. 35 shows the user program 3200 in an example fourth stage of the compiler stack. The template graph compiler 3123 may also determine the control signals 3510 and 3520 required to enable the CGR units (whether logical or physical) to coordinate dataflow between the CGR units in the CGR array of a statically reconfigurable dataflow architecture processor. This process, sometimes referred to as stitching, produces a stitched template compute graph 3500 with control signals 3510, 3520. In the example depicted in FIG. 35, the control signals include write done signals 3510 and read done signals 3520. The control signals enable coordinated dataflow between the configurable units of statically reconfigurable dataflow architecture processors such as compute units, memory units, and AGCUs.

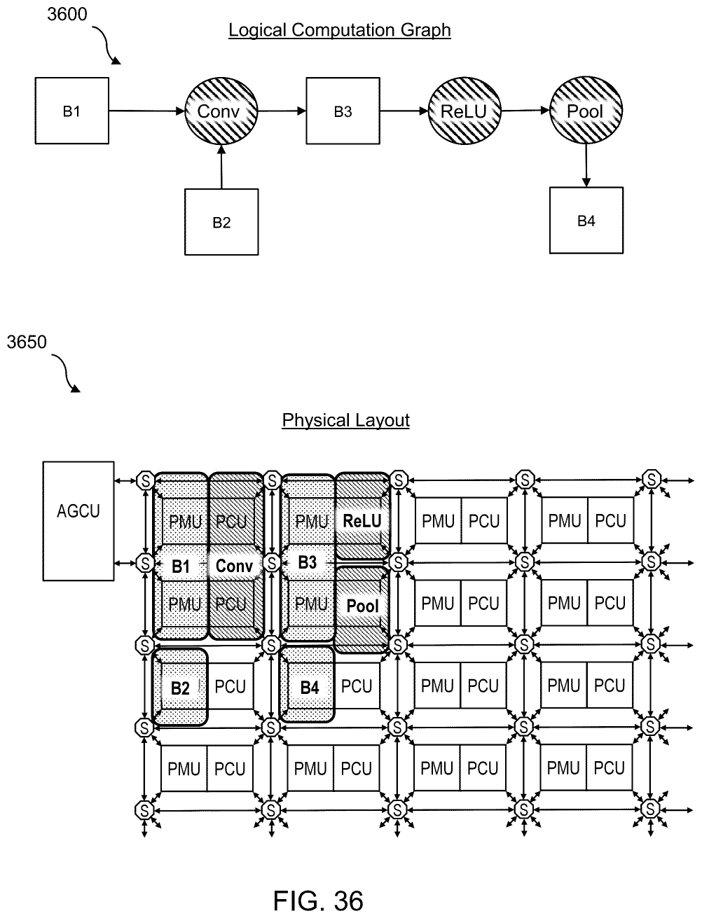

PNR 3125 translates and maps logical (i.e., unplaced physically realizable) CGR units (e.g., the nodes of the logical computation graph 3600 shown in FIG. 36) to a physical layout (e.g., the physical layout 3650 shown in FIG. 36) on the physical level, e.g., a physical array of CGR units in a semiconductor chip. PNR 3125 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 3125 may provide its functionality in multiple steps and may include multiple modules (not shown in FIG. 31) to provide the multiple steps, e.g., a placer, a router, a port allocator, and a PEF file generator. PNR 3125 may receive its input data in various ways. For example, it may receive parts of its input data from any of the earlier modules (dataflow graph compiler 3121, algebraic graph compiler 3122, template graph compiler 3123, and/or template library 3124). In some implementations, an earlier module, such as template graph compiler 3123, may have the task of preparing all information for PNR 3125 and no other units provide PNR input data directly.

Further implementations of compiler 3120 provide for an iterative process, for example by feeding information from PNR 3125 back to an earlier module, so that the earlier module can execute a new compilation step in which it uses physically realized results rather than estimates of or placeholders for physically realizable circuits. For example, PNR 3125 may feed information regarding the physically realized circuits back to algebraic graph compiler 3122.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 3120 binds memory allocations to unplaced memory units and binds operations specified by operation nodes in the dataflow graph to unplaced compute units, and these bindings may be specified in the configuration data. In some implementations, compiler 3120 partitions parts of a dataflow graph into memory subgraphs and compute subgraphs and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 3120 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 36 shows the logical computation graph 3600 and an example physical layout 3650 of the user program on a statically reconfigurable dataflow architecture processor with an array of coarse-grained reconfigurable (CGR) units including statically reconfigurable memory units (e.g., PMUs), statically reconfigurable compute units (e.g. PCUs), statically reconfigurable switches, and a links that respectively connect two of the CGR units, and respectively include a vector link. In the example shown 3650, the buffer B1 (holding the input tensor) has been split across two PMUs due to its size and two PCUs have been used for the convolution operation to allow for concurrent operation of the two PMUs of buffer B1. Buffer B3 (for the output of the convolution operation) has also been split across two PMUs but buffer B2 (which only holds a 3×3 kernel) and buffer B4 (which has greatly reduced storage needs due to the pooling operation) are assigned a to a single PMU each. Similarly, the ReLu function and the Pooling function are assigned to one PCU each.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), statically reconfigurable dataflow architecture processor ICs, graphics processing units (GPUs), FPGAS, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

### Additional Examples

Additional features of the technology may be reflected in the following examples.

Example A1. A statically reconfigurable dataflow architecture processor comprising: an array of coarse-grained reconfigurable (CGR) units including a plurality of statically reconfigurable memory units, a plurality of statically reconfigurable compute units, a plurality of statically reconfigurable switches, and a plurality of links that respectively connect two of the CGR units, and respectively include a vector link; the plurality of statically reconfigurable compute units respectively including an array of multiply-accumulate circuits (MACs) having a plurality of lanes and a plurality of stages, the plurality of statically reconfigurable compute units including a first statically reconfigurable compute unit; the plurality of statically reconfigurable memory units respectively including a memory array, a general address calculation unit, and a convolution address compute unit, the plurality of statically reconfigurable memory units including a first statically reconfigurable memory unit, a second statically reconfigurable memory unit, and a third statically reconfigurable memory unit; and the convolution address compute units of the plurality of statically reconfigurable memory units respectively comprising: an outer output base location register to provide an outer output base location for a convolution operation; an outer input base location register to provide an outer input base location for the convolution operation; a kernel element counter that starts to count from an initial kernel count value to a maximum kernel count value in response to a change in the outer output base location; a kernel offset generator to generate a kernel offset based on an output of the kernel element counter; and inner location logic to calculate an output location based on the outer output base location and an input location based on the outer input base location and the output of the kernel element counter.

Example A2. The statically reconfigurable dataflow architecture processor of example A1, wherein the convolution address compute units are configured to update the input location in response to an update of the kernel element counter.

Example A3. The statically reconfigurable dataflow architecture processor of example A1, wherein the input location is calculated further based on a dilation value and/or an effective pad value for the convolution operation.

Example A4. The statically reconfigurable dataflow architecture processor of example A1, wherein the outer output base location register includes a first dimension outer output base location register for a first dimension of an output of the convolution operation and a second dimension outer output base location register for a second dimension of the output of the convolution operation; the outer input base location register includes a first dimension outer input base location register for a first dimension of an input to the convolution operation and a second dimension outer input base location register for a second dimension of the input to the convolution operation; a kernel offset generator generates a first dimension kernel offset for a first dimension of a kernel for the convolution operation and a second dimension kernel offset for a second dimension of the kernel for the convolution operation; the inner location logic calculates a first dimension input location for the first dimension of the input to the convolution operation, a second dimension input location for the second dimension of the input to the convolution operation, a first dimension output location for the first dimension of the output of the convolution operation, a second dimension output location for the second dimension of the output of the convolution operation; and the convolution operation is a multidimensional convolution operation.

Example A5. The statically reconfigurable dataflow architecture processor of example A4, the kernel element counter including a first dimension kernel counter for the first dimension of the kernel and a second dimension kernel counter for the second dimension of the kernel, the second dimension kernel counter configured to increment in response to the first dimension kernel counter wrapping to its initial value from a maximum first dimension kernel count value.

Example A6. The statically reconfigurable dataflow architecture processor of example A4, wherein the outer output base location register includes a third dimension outer output base location register for a third dimension of the output of the convolution operation; the outer input base location register includes a third dimension outer input base location register for a third dimension of the input to the convolution operation; the kernel offset generator generates a third dimension kernel offset for a third dimension of the kernel for the convolution operation; the inner location logic calculates a third dimension input location for the third dimension of the input to the convolution operation, and a third dimension output location for the third dimension of the output of the convolution operation; and the convolution operation is a three-dimensional convolution operation.

Example A7. The statically reconfigurable dataflow architecture processor of example A6, the kernel element counter including a first dimension kernel counter for the first dimension of the kernel, a second dimension kernel counter for the second dimension of the kernel, and a third dimension kernel counter for a third dimension of the kernel, the third dimension kernel counter configured to increment in response to the second dimension kernel counter wrapping to its initial value from a maximum second dimension kernel count value, the second dimension kernel counter configured to increment in response to the first dimension kernel counter wrapping to its initial value from a maximum first dimension kernel count value.

Example A8. The statically reconfigurable dataflow architecture processor of example A1, wherein the kernel element counter wraps back to the initial kernel count value from the maximum kernel count value; and the outer output base location register, and the outer input base location register are updated in response to the kernel element counter wrapping back to the initial kernel count value.

Example A9. The statically reconfigurable dataflow architecture processor of example A1, the inner location logic comprising: an inner input base register to provide an inner input base location; an accumulator counter configured to be reset to an initial accumulator value in response to a change in the kernel element counter and increment in response to a new input location being calculated, until reaching a maximum accumulator count value; input location calculation logic configured to calculate the input location based on the inner input base register and the output of the kernel element counter; and an inner output register to provide the output location, the inner output register configured to increment in response to the accumulator counter incrementing and to load the outer output base location in response to the kernel element counter changing; wherein the kernel element counter is configured to increment in response to the accumulator counter reaching the maximum accumulator count value; and the inner input base register is configured to increment in response to the new input location being calculated, and to load the outer input base location in response to the kernel element counter wrapping back to the initial kernel count value.

Example A10. The statically reconfigurable dataflow architecture processor of example A9, wherein the first statically reconfigurable memory unit is configured to use its general address calculation unit to calculate a first kernel memory address based on the kernel offset during a first period where the accumulator counter has a first value, use the first kernel memory address to read a first kernel vector element from its memory array, and send the first kernel vector element to the first statically reconfigurable compute unit; the second statically reconfigurable memory unit is configured to use its general address calculation unit to calculate a first input memory address based on the input location during the first period, use the first input memory address to read a first input vector element from its memory array, and send the first input vector element to the first statically reconfigurable compute unit; the first statically reconfigurable compute unit is configured to calculate a first dot product of the first kernel vector element and the first input vector element in a first MAC in first stage of the array of MACs, and accumulate a result of the first dot product with a previous value of an accumulator of the first MAC; the second statically reconfigurable memory unit is further configured to use its general address calculation unit to calculate a second input memory address based on the input location during a second period where the accumulator counter has a second value, use the second input memory address to read a second input vector element from its memory array, and send the second input vector element to the first statically reconfigurable compute unit; the first statically reconfigurable compute unit is further configured to calculate a second dot product of the first kernel vector element and the second input vector element in a second MAC in second stage of the array of MACs, and accumulate a result of the second dot product with a previous value of an accumulator of the second MAC, wherein the calculation of the second dot product in the second MAC occurs at least partly overlaps in time with the calculation of the first dot product in the first MAC; the first statically reconfigurable compute unit is further configured to process K input vector elements in both the first MAC and the second MAC, where K is a number of active locations in a receptive field of an input for the convolution operation, and then send both a first accumulated value from the accumulator of the first MAC and a second accumulated value from the accumulator of the second MAC to the third statically reconfigurable memory unit; and the third statically reconfigurable memory unit is configured to use its general address calculation unit to calculate a first output memory address based on the output location during the first period and a second output memory address based on the output location during the second period, use the first output memory address to store the first accumulated value received from the first statically reconfigurable compute unit in its memory array, and use the second output memory address to store the second accumulated value received from the first statically reconfigurable compute unit in its memory array.

Example A11. The statically reconfigurable dataflow architecture processor of example A9, wherein the inner input base register, when incremented, increments by a stride amount for the convolution operation.

Example A12. The statically reconfigurable dataflow architecture processor of example A9, wherein the input location calculation logic is configured to calculate the input location by multiplying the output of the kernel element counter by a dilation value for the convolution operation and adding a difference between the inner input base register and an effective pad value for the convolution operation.

Example A13. The statically reconfigurable dataflow architecture processor of example A12, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A14. The statically reconfigurable dataflow architecture processor of example A9, the inner location logic further comprising: an offset lookup table, indexed by the output of the kernel element counter, and outputting an input offset value; wherein the input location calculation logic is configured to calculate the input location by adding the inner input base location to the input offset value.

Example A15. The statically reconfigurable dataflow architecture processor of example A14, wherein the input location calculation logic is further configured to check the input location against bounds for the input to the convolution operation, and in response to determining that the input location is outside of the bounds, to set a predicate for the input location to indicate that no memory read should be performed and that a value of zero should be provided in place of data read from memory for the input location.

Example A16. The statically reconfigurable dataflow architecture processor of example A14, wherein the kernel offset generator includes a portion of the offset lookup table, and the offset lookup table further outputs the kernel offset.

Example A17. The statically reconfigurable dataflow architecture processor of example A1, wherein the kernel offset generator includes an offset lookup table, indexed by the output of the kernel element counter, and outputting the kernel offset.

Example A18. The statically reconfigurable dataflow architecture processor of example A1, wherein the first statically reconfigurable memory unit is configured to use its general address calculation unit to calculate a kernel memory address based on the kernel offset, use the kernel memory address to read kernel data from its memory array, and send the kernel data as a first element of a pair of values of a plurality of pairs of values to the first statically reconfigurable compute unit of the plurality of statically reconfigurable compute units; the second statically reconfigurable memory unit is configured to use its general address calculation unit to calculate an input memory address based on the input location, use the input memory address to read input data from its memory array, and send the input data as a second element of the pair of values of the plurality of pairs of values to the first statically reconfigurable compute unit; the first statically reconfigurable compute unit is configured to (a) receive the plurality of pairs of values respectively from the first statically reconfigurable memory unit and the second statically reconfigurable memory unit, (b) multiply and accumulate the plurality of pairs of values in a MAC unit in the array of MAC units as an accumulated value, and (c) send the accumulated value to the third statically reconfigurable memory unit; and the third statically reconfigurable memory unit is configured to use its general address calculation unit to calculate an output memory address based on the output location and use the output memory address to store the accumulated value received from the first statically reconfigurable compute unit in its memory array.

Example A19. The statically reconfigurable dataflow architecture processor of example A18, the first statically reconfigurable memory unit, the second statically reconfigurable memory unit, and the third statically reconfigurable memory unit each respectively further comprising: a selection register to store an indication of whether the convolution address compute unit is in the first statically reconfigurable memory unit, second statically reconfigurable memory unit, or third statically reconfigurable memory unit.

Example A20. A convolution calculation engine to perform a convolution operation comprising: a first memory unit, a second memory unit, and a third memory unit, each including a memory array and a convolution address compute unit; and a first multiply-accumulate (MAC) unit communicatively coupled to the first memory unit, the second memory unit, and the third memory unit and configured to repeatedly (a) receive a plurality of pairs of values respectively from the first memory unit and the second memory unit, (b) multiply and accumulate the plurality of pairs of values, and (c) send an accumulated value to the third memory unit; the convolution address compute units of the first memory unit, the second memory unit, and the third memory unit each respectively comprising: an outer output base location register to provide an outer output base location for the convolution operation; an outer input base location register to provide an outer input base location for the convolution operation; a kernel element counter that starts to count from an initial kernel count value to a maximum kernel count value in response to a change in the outer output base location; a kernel offset generator to generate a kernel offset based on an output of the kernel element counter; and inner location logic to calculate an output location based on the outer output base location and an input location based on the outer input base location and the output of the kernel element counter; wherein the first memory unit is configured to use the kernel offset to calculate a kernel memory address, use the kernel memory address to read kernel data from its memory array, and send the kernel data as a first element of a pair of values of the plurality of pairs of values to the first MAC unit; the second memory unit is configured to use the input location to calculate an input memory address, use the input memory address to read input data from its memory array, and send the input data as a second element of the pair of values of the plurality of pairs of values to the first MAC unit; and the third memory unit is configured to use the output location to calculate an output memory address and use the output memory address to store the accumulated value received from the first MAC unit in its memory array.

Example A21. The convolution calculation engine of example A20, the first memory unit, the second memory unit, and the third memory unit each respectively further comprising: a selection register to store an indication of whether the convolution address compute unit is in the first memory unit, the second memory unit, or the third memory unit.

Example A22. The convolution calculation engine of example A20, wherein the convolution address compute units are configured to update the input location in response to an update of the kernel element counter.

Example A23. The convolution calculation engine of example A20, wherein the input location is calculated further based on a dilation value and/or an effective pad value for the convolution operation.

Example A24. The convolution calculation engine of example A20, wherein the outer output base location register includes a first dimension outer output base location register for a first dimension of an output of the convolution operation and a second dimension outer output base location register for a second dimension of the output of the convolution operation; the outer input base location register includes a first dimension outer input base location register for a first dimension of an input to the convolution operation and a second dimension outer input base location register for a second dimension of the input to the convolution operation; a kernel offset generator generates a first dimension kernel offset for a first dimension of a kernel for the convolution operation and a second dimension kernel offset for a second dimension of the kernel for the convolution operation; the inner location logic calculates a first dimension input location for the first dimension of the input to the convolution operation, a second dimension input location for the second dimension of the input to the convolution operation, a first dimension output location for the first dimension of the output of the convolution operation, a second dimension output location for the second dimension of the output of the convolution operation; and the convolution operation is a multidimensional convolution operation.

Example A25. The convolution calculation engine of example A24, the kernel element counter including a first dimension kernel counter for the first dimension of the kernel and a second dimension kernel counter for the second dimension of the kernel, the second dimension kernel counter configured to increment in response to the first dimension kernel counter wrapping to its initial value from a maximum first dimension kernel count value.

Example A26. The convolution calculation engine of example A24, wherein the outer output base location register includes a third dimension outer output base location register for a third dimension of the output of the convolution operation; the outer input base location register includes a third dimension outer input base location register for a third dimension of the input to the convolution operation; the kernel offset generator generates a third dimension kernel offset for a third dimension of the kernel for the convolution operation; the inner location logic calculates a third dimension input location for the third dimension of the input to the convolution operation, and a third dimension output location for the third dimension of the output of the convolution operation; and the convolution operation is a three-dimensional convolution operation.

Example A27. The convolution calculation engine of example A26, the kernel element counter including a first dimension kernel counter for the first dimension of the kernel, a second dimension kernel counter for the second dimension of the kernel, and a third dimension kernel counter for a third dimension of the kernel, the third dimension kernel counter configured to increment in response to the second dimension kernel counter wrapping to its initial value from a maximum second dimension kernel count value, the second dimension kernel counter configured to increment in response to the first dimension kernel counter wrapping to its initial value from a maximum first dimension kernel count value.

Example A28. The convolution calculation engine of example A20, wherein the kernel element counter wraps back to the initial kernel count value from the maximum kernel count value; and the outer output base location register, and the outer input base location register are updated in response to the kernel element counter wrapping back to the initial kernel count value.

Example A29. The convolution calculation engine of example A20, the inner location logic comprising: an inner input base register to provide an inner input base location; an accumulator counter configured to be reset to an initial accumulator value in response to a change in the kernel element counter and increment in response to a new input location being calculated, until reaching a maximum accumulator count value; input location calculation logic configured to calculate the input location based on the inner input base register and the output of the kernel element counter; and an inner output register to provide the output location, the inner output register configured to increment in response to the accumulator counter incrementing and to load the outer output base location in response to the kernel element counter changing; wherein the kernel element counter is configured to increment in response to the accumulator counter reaching the maximum accumulator count value; and the inner input base register is configured to increment in response to the new input location being calculated, and to load the outer input base location in response to the kernel element counter wrapping back to the initial kernel count value.

Example A30. The convolution calculation engine of example A29, further comprising a second MAC unit communicatively coupled to the first memory unit, the second memory unit, and the third memory unit; wherein the first memory unit is configured to calculate a first kernel memory address based on the kernel offset during a first period where the accumulator counter has a first value, use the first kernel memory address to read a first kernel vector element from its memory array, and send the first kernel vector element to the first MAC unit; the second memory unit is configured to calculate a first input memory address based on the input location during the first period, use the first input memory address to read a first input vector element from its memory array, and send the first input vector element to the first MAC unit; the first MAC unit is configured to calculate a first dot product of the first kernel vector element and the first input vector element and accumulate a result of the first dot product with a previous value of an accumulator of the first MAC unit; the second memory unit is further configured to calculate a second input memory address based on the input location during a second period, use the second input memory address to read a second input vector element from its memory array, and send the second input vector element to the second MAC unit; the second MAC unit is configured to receive the first kernel vector element from the first MAC unit, calculate a second dot product of the first kernel vector element and the second input vector element and accumulate a result of the second dot product with a previous value of an accumulator of the second MAC unit, wherein the calculation of the second dot product in the second MAC unit at least partly overlaps in time with the calculation of the first dot product in the first MAC unit; the first MAC unit is further configured to, after processing K input vector elements where K is a number of active locations in a receptive field of an input for the convolution operation, send a first accumulated value from the accumulator of the first MAC unit to the third memory unit; the second MAC unit is further configured to, after processing K input vector elements, send a second accumulated value from the accumulator of the second MAC unit to the third memory unit; and the third memory unit is configured to calculate a first output memory address based on the output location during the first period and a second output memory address based on the output location during the second period, use the first output memory address to store the first accumulated value received from the first MAC unit in its memory array, and use the second output memory address to store the second accumulated value received from the second MAC unit in its memory array.

Example A31. The convolution calculation engine of example A29, wherein the inner input base register, when incremented, increments by a stride amount for the convolution operation.

Example A32. The convolution calculation engine of example A29, wherein the input location calculation logic is configured to calculate the input location by multiplying the output of the kernel element counter by a dilation value for the convolution operation and adding a difference between the inner input base register and an effective pad value for the convolution operation.

Example A33. The convolution calculation engine of example A32, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A34. The convolution calculation engine of example A29, the inner location logic further comprising: an offset lookup table, indexed by the output of the kernel element counter, and outputting an input offset value; wherein the input location calculation logic is configured to calculate the input location by adding the inner input base location to the input offset value.

Example A35. The convolution calculation engine of example A34, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A36. The convolution calculation engine of example A34, wherein the kernel offset generator includes a portion of the offset lookup table, and the offset lookup table further outputs the kernel offset.

Example A37. The convolution calculation engine of example A20, wherein the kernel offset generator includes an offset lookup table, indexed by the output of the kernel element counter, and outputting the kernel offset.

Example A38. A circuit to generate addresses for a convolution operation comprising: an outer output base location register to provide an outer output base location for the convolution operation; an outer input base location register to provide an outer input base location for the convolution operation; a kernel element counter that starts to count from an initial kernel count value to a maximum kernel count value in response to a change in the outer output base location; a kernel offset generator to generate a kernel offset based on an output of the kernel element counter; and inner location logic to calculate an output location based on the outer output base location and an input location based on the outer input base location and the output of the kernel element counter.

Example A39. The circuit of example A38, further comprising: a selector circuit coupled to the kernel offset generator, and the inner location logic and configured to select either the kernel offset, the output location, or the input location as its output; a selection register, coupled to the selector circuit, to provide selection information to the selector circuit; and address calculation circuitry coupled to the selector circuit and configured to calculate a memory address based on the output of the selector circuit.

Example A40. The circuit of example A38, wherein the inner location logic is configured to update the input location in response to an update of the kernel element counter.

Example A41. The circuit of example A38, wherein the inner location logic is configured to calculate the input location further based on a dilation value and/or an effective pad value for the convolution operation.

Example A42. The circuit of example A38, wherein the outer output base location register includes a first dimension outer output base location register for a first dimension of an output of the convolution operation and a second dimension outer output base location register for a second dimension of the output of the convolution operation; the outer input base location register includes a first dimension outer input base location register for a first dimension of an input to the convolution operation and a second dimension outer input base location register for a second dimension of the input to the convolution operation; a kernel offset generator generates a first dimension kernel offset for a first dimension of a kernel for the convolution operation and a second dimension kernel offset for a second dimension of the kernel for the convolution operation; the inner location logic calculates a first dimension input location for the first dimension of the input to the convolution operation, a second dimension input location for the second dimension of the input to the convolution operation, a first dimension output location for the first dimension of the output of the convolution operation, a second dimension output location for the second dimension of the output of the convolution operation; and the convolution operation is a multidimensional convolution operation.

Example A43. The circuit of example A42, the kernel element counter including a first dimension kernel counter for the first dimension of the kernel and a second dimension kernel counter for the second dimension of the kernel, the second dimension kernel counter configured to increment in response to the first dimension kernel counter wrapping to its initial value from a maximum first dimension kernel count value.

Example A44. The circuit of example A42, wherein the outer output base location register includes a third dimension outer output base location register for a third dimension of the output of the convolution operation; the outer input base location register includes a third dimension outer input base location register for a third dimension of the input to the convolution operation; the kernel offset generator generates a third dimension kernel offset for a third dimension of the kernel for the convolution operation; the inner location logic calculates a third dimension input location for the third dimension of the input to the convolution operation, and a third dimension output location for the third dimension of the output of the convolution operation; and the convolution operation is a three-dimensional convolution operation.

Example A45. The circuit of example A44, the kernel element counter including a first dimension kernel counter for the first dimension of the kernel, a second dimension kernel counter for the second dimension of the kernel, and a third dimension kernel counter for a third dimension of the kernel, the third dimension kernel counter configured to increment in response to the second dimension kernel counter wrapping to its initial value from a maximum second dimension kernel count value, the second dimension kernel counter configured to increment in response to the first dimension kernel counter wrapping to its initial value from a maximum first dimension kernel count value.

Example A46. The circuit of example A38, wherein the kernel element counter wraps back to the initial kernel count value from the maximum kernel count value; and the outer output base location register, and the outer input base location register are updated in response to the kernel element counter wrapping back to the initial kernel count value.

Example A47. The circuit of example A38, the inner location logic comprising: an inner input base register to provide an inner input base location; an accumulator counter configured to be reset to an initial accumulator value in response to a change in the kernel element counter and increment in response to a new input location being calculated, until reaching a maximum accumulator count value; input location calculation logic configured to calculate the input location based on the inner input base register and the output of the kernel element counter; and an inner output register to provide the output location, the inner output register configured to increment in response to the accumulator counter incrementing and to load the outer output base location in response to the kernel element counter changing; wherein the kernel element counter is configured to increment in response to the accumulator counter reaching the maximum accumulator count value; and the inner input base register is configured to increment in response to the new input location being calculated, and to load the outer input base location in response to the kernel element counter wrapping back to the initial kernel count value.

Example A48. The circuit of example A47, wherein the inner input base register, when incremented, increments by a stride amount for the convolution operation.

Example A49. The circuit of example A47, wherein the input location calculation logic is configured to calculate the input location by multiplying the output of the kernel element counter by a dilation value for the convolution operation and adding a difference between the inner input base register and an effective pad value for the convolution operation.

Example A50. The circuit of example A49, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A51. The circuit of example A47, the inner location logic further comprising: an offset lookup table, indexed by the output of the kernel element counter, and outputting an input offset value; wherein the input location calculation logic is configured to calculate the input location by adding the inner input base location to the input offset value.

Example A52. The circuit of example A51, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A53. The circuit of example A51, wherein the kernel offset generator includes a portion of the offset lookup table, and the offset lookup table further outputs the kernel offset.

Example A54. The circuit of example A38, wherein the kernel offset generator includes an offset lookup table, indexed by the output of the kernel element counter, and outputting the kernel offset.

Example A55. A method for use in a convolution operation comprising: initializing an outer output base location register to provide an outer output base location for the convolution operation; initializing an outer input base location register to provide an outer input base location for the convolution operation; counting, with a kernel element counter, from an initial kernel count value to a maximum kernel count value in response to a change in the outer output base location; generating a kernel offset based on an output of the kernel element counter; calculating an output location based on the outer output base location; and calculating an input location based on the outer input base location and the output of the kernel element counter.

Example A56. The method of example A55, further comprising: selecting, based on selection information from a selection register, either the kernel offset, the output location, or the input location as offset information for use in accessing a memory; and calculating a memory address based on the selected offset information.

Example A57. The method of example A55, further comprising updating the input location in response to an update of the kernel element counter.

Example A58. The method of example A55, further comprising calculating the input location further based on a dilation value and/or an effective pad value for the convolution operation.

Example A59. The method of example A55, wherein the convolution operation is a multidimensional convolution operation; the outer output base location register includes a first dimension outer output base location register for a first dimension of an output of the convolution operation and a second dimension outer output base location register for a second dimension of the output of the convolution operation; and the outer input base location register includes a first dimension outer input base location register for a first dimension of an input to the convolution operation and a second dimension outer input base location register for a second dimension of the input to the convolution operation; the method further comprising: generating a first dimension kernel offset for a first dimension of a kernel for the convolution operation; generating a second dimension kernel offset for a second dimension of the kernel for the convolution operation; calculating a first dimension input location for the first dimension of the input to the convolution operation; calculating a second dimension input location for the second dimension of the input to the convolution operation; calculating a first dimension output location for the first dimension of the output of the convolution operation; and calculating a second dimension output location for the second dimension of the output of the convolution operation.

Example A60. The method of example A59, wherein the kernel element counter includes a first dimension kernel counter for the first dimension of the kernel and a second dimension kernel counter for the second dimension of the kernel; the method further comprising: incrementing the first dimension kernel counter as a part of the counting by the kernel element counter; and incrementing the second dimension kernel counter in response to the first dimension kernel counter wrapping to its initial value from a maximum first dimension kernel count value.

Example A61. The method of example A59, wherein the convolution operation is a three-dimensional convolution operation; the outer output base location register includes a third dimension outer output base location register for a third dimension of the output of the convolution operation; and the outer input base location register includes a third dimension outer input base location register for a third dimension of the input to the convolution operation; the method further comprising: generating a third dimension kernel offset for a third dimension of the kernel for the convolution operation; calculating a third dimension input location for the third dimension of the input to the convolution operation; and calculating a third dimension output location for the third dimension of the output of the convolution operation.

Example A62. The method of example A61, wherein the kernel element counter includes a first dimension kernel counter for the first dimension of the kernel, a second dimension kernel counter for the second dimension of the kernel, and a third dimension kernel counter for a third dimension of the kernel; the method further comprising: incrementing the first dimension kernel counter as a part of the counting by the kernel element counter; incrementing the second dimension kernel counter in response to the first dimension kernel counter wrapping to its initial value from a maximum first dimension kernel count value; and incrementing the third dimension kernel counter in response to the second dimension kernel counter wrapping to its initial value from a maximum second dimension kernel count value.

Example A63. The method of example A55, further comprising: wrapping the kernel element counter back to the initial kernel count value after reaching the maximum kernel count value; and updating the outer output base location register and the outer input base location register in response to the kernel element counter wrapping back to the initial kernel count value.

Example A64. The method of example A55, further comprising: resetting an accumulator counter to an initial accumulator value in response to a change in the kernel element counter; incrementing the accumulator counter in response to a new input location being calculated, until reaching a maximum accumulator count value; incrementing the kernel element counter in response to the accumulator counter reaching the maximum accumulator count value; loading the outer input base location into an inner input base register in response to the kernel element counter wrapping back to the initial kernel count value, the inner input base register to provide an inner input base location; incrementing the inner input base register in response to the accumulator counter being incremented and incrementing the inner input base register in response to the accumulator counter wrapping back to the initial accumulator value; calculating the input location based on the inner input base location and the output of the kernel element counter; incrementing an inner output register in response to the accumulator counter incrementing, the inner output register to provide the output location; and loading the outer output base location into the inner output register in response to the kernel element counter changing.

Example A65. The method of example A64, further comprising: calculating a first kernel memory address based on the kernel offset during a first period where the accumulator counter has a first value; accessing a kernel memory using the first kernel memory address to retrieve a first kernel vector element; sending the first kernel vector element to a first multiply-accumulate circuit (MAC); calculating a first input memory address based on the input location during the first period; accessing an input memory using the first input memory address to retrieve a first input vector element; sending the first input vector element to the first MAC; calculating a first dot product of the first kernel vector element and the first input vector element in the first MAC, and accumulating a result of the first dot product with a previous value of an accumulator of the first MAC; calculating a second input memory address based on the input location during a second period; accessing the input memory using the second input memory address to retrieve a second input vector element; sending the second input vector element to a second MAC; calculating a second dot product of the first kernel vector element and the second input vector element in the second MAC, and accumulating a result of the second dot product with a previous value of an accumulator of the second MAC, wherein the calculation of the second dot product in the second MAC occurs in parallel with the calculation of the first dot product in the first MAC; processing K input vector elements in both the first MAC and the second MAC, where K is a number of active locations in a receptive field of an input for the convolution operation; calculating a first output memory address based on the output offset during the first period; saving an accumulated result from the accumulator of the first MAC in an output memory using the first output memory address; calculating a second output memory address based on the output offset during the second period; and saving an accumulated result from the accumulator of the second MAC in the output memory using the second output memory address.

Example A66. The method of example A64, wherein the inner input base register, when incremented, increments by a stride amount for the convolution operation.

Example A67. The method of example A64, further comprising calculating the input location by multiplying the output of the kernel element counter by a dilation value for the convolution operation and adding a difference between the inner input base register and an effective pad value for the convolution operation.

Example A68. The method of example A67, further comprising: checking the input location against bounds for an input to the convolution operation, and setting a predicate for the input location to indicate that no memory read should be performed and that a value of zero should be provided in place of data read from memory for the input location in response to determining that the input location is outside of the bounds.

Example A69. The method of example A64, further comprising: calculating the input location by indexing into an offset lookup table using the output of the kernel element counter to obtain an input offset value; and adding a value of the inner input base register to the input offset value.

Example A70. The method of example A67, further comprising: checking the input location against bounds for an input to the convolution operation, and setting a predicate for the input location to indicate that no memory read should be performed and that a value of zero should be provided in place of data read from memory for the input location in response to determining that the input location is outside of the bounds.

Example A71. The method of example A69, further comprising generating the kernel offset by indexing into the offset lookup table using the output of the kernel element counter to obtain the kernel offset.

Example A72. The method of example A55, further comprising generating the kernel offset by indexing into an offset lookup table using the output of the kernel element counter to obtain the kernel offset.

Example A73. The method of example A55, further comprising: calculating a kernel memory address based on the kernel offset; accessing a kernel memory using the kernel memory address to retrieve a kernel element; sending the kernel element to a multiply-accumulate circuit (MAC); calculating an input memory address based on the input location; accessing an input memory using the input memory address to retrieve an input element; sending the input element to the MAC; multiplying the kernel element by the input element in the MAC and accumulating a result of the multiply into an accumulator of the MAC; calculating an output memory address based on the output offset; and after processing K input elements in the MAC, where K is a number of active locations in a receptive field of the input element for the output offset, saving an accumulated result from the accumulator in an output memory using the output memory address.

Example A74. A circuit to generate addresses for a convolution operation comprising: an outer output base location register to provide an outer output base location for the convolution operation; an outer input base location register to provide an outer input base location for the convolution operation; a kernel element counter that starts to count from an initial kernel count value to a maximum kernel count value in response to a change in the outer output base location; and inner location logic to an input location based on the outer input base location and an output of the kernel element counter.

Example A75. The circuit of example A74, wherein the kernel element counter wraps back to the initial kernel count value from the maximum kernel count value; and the outer output base location register, and the outer input base location register are updated in response to the kernel element counter wrapping back to the initial kernel count value.

Example A76. The circuit of example A74, wherein the inner location logic is configured to update the input location in response to an update of the kernel element counter.

Example A77. The circuit of example A74, wherein the inner location logic is configured to calculate the input location further based on a dilation value and/or an effective pad value for the convolution operation.

Example A78. The circuit of example A74, wherein the outer input base location register includes a first dimension outer input base location register for a first dimension of an input to the convolution operation and a second dimension outer input base location register for a second dimension of the input to the convolution operation; the inner location logic calculates a first dimension input location for the first dimension of the input to the convolution operation and a second dimension input location for the second dimension of the input to the convolution operation; and the convolution operation is a multidimensional convolution operation.

Example A79. The circuit of example A78, the kernel element counter including a first dimension kernel counter for the first dimension of a kernel for the convolution operation and a second dimension kernel counter for the second dimension of the kernel, the second dimension kernel counter configured to increment in response to the first dimension kernel counter wrapping to its initial value from a maximum first dimension kernel count value.

Example A80. The circuit of example A78, wherein the outer input base location register includes a third dimension outer input base location register for a third dimension of the input to the convolution operation; the inner location logic calculates a third dimension input location for the third dimension of the input to the convolution operation; and the convolution operation is a three-dimensional convolution operation.

Example A81. The circuit of example A80, the kernel element counter including a first dimension kernel counter for the first dimension of a kernel for the convolution operation, a second dimension kernel counter for the second dimension of the kernel, and a third dimension kernel counter for a third dimension of the kernel, the third dimension kernel counter configured to increment in response to the second dimension kernel counter wrapping to its initial value from a maximum second dimension kernel count value, the second dimension kernel counter configured to increment in response to the first dimension kernel counter wrapping to its initial value from a maximum first dimension kernel count value.

Example A82. The circuit of example A74, the inner location logic comprising: an inner input base register to provide an inner input base location; an accumulator counter configured to be reset to an initial accumulator value in response to a change in the kernel element counter and increment in response to a new input location being calculated, until reaching a maximum accumulator count value; input location calculation logic configured to calculate the input location based on the inner input base register and the output of the kernel element counter; and an inner output register to provide an output location, the inner output register configured to increment in response to the accumulator counter incrementing and to load the outer output base location in response to the kernel element counter changing; wherein the kernel element counter is configured to increment in response to the accumulator counter reaching the maximum accumulator count value; and the inner input base register is configured to increment in response to the new input location being calculated, and to load the outer input base location in response to the kernel element counter wrapping back to the initial kernel count value.

Example A83. The circuit of example A82, wherein the inner input base register, when incremented, increments by a stride amount for the convolution operation.

Example A84. The circuit of example A82, wherein the input location calculation logic is configured to calculate the input location by multiplying the output of the kernel element counter by a dilation value for the convolution operation and adding a difference between the inner input base register and an effective pad value for the convolution operation.

Example A85. The circuit of example A84, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A86. The circuit of example A82, the inner location logic further comprising: an offset lookup table, indexed by the output of the kernel element counter, and outputting an input offset value; wherein the input location calculation logic is configured to calculate the input location by adding the inner input base location to the input offset value.

Example A87. The circuit of example A86, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

Example A88. A method for use in a convolution operation comprising: initializing an outer output base location register to provide an outer output base location for the convolution operation; initializing an outer input base location register to provide an outer input base location for the convolution operation; counting, with a kernel element counter, from an initial kernel count value to a maximum kernel count value in response to a change in the outer output base location; and calculating an input location based on the outer input base location and an output of the kernel element counter.

Example A89. The method of example A88, further comprising updating the input location in response to an update of the kernel element counter.

Example A90. The method of example A88, further comprising calculating the input location further based on a dilation value and/or an effective pad value for the convolution operation.

Example A91. The method of example A88, wherein the convolution operation is a multidimensional convolution operation; the kernel element counter includes a first dimension kernel counter for a first dimension of a kernel for the convolution operation and a second dimension kernel counter for a second dimension of the kernel; and the outer input base location register includes a first dimension outer input base location register for a first dimension of an input to the convolution operation and a second dimension outer input base location register for a second dimension of the input to the convolution operation; the method further comprising: incrementing the first dimension kernel counter as a part of the counting by the kernel element counter; incrementing the second dimension kernel counter in response to the first dimension kernel counter wrapping to its initial value from a maximum first dimension kernel count value; calculating a first dimension input location for the first dimension of the input to the convolution operation; and calculating a second dimension input location for the second dimension of the input to the convolution operation.

Example A92. The method of example A88, further comprising: wrapping the kernel element counter back to the initial kernel count value after reaching the maximum kernel count value; and updating the outer output base location register and the outer input base location register in response to the kernel element counter wrapping back to the initial kernel count value.

Example A93. The method of example A88, further comprising: resetting an accumulator counter to an initial accumulator value in response to a change in the kernel element counter; incrementing the accumulator counter, in response to a new input location being calculated, until reaching a maximum accumulator count value; loading the outer input base location into an inner input base register in response to the kernel element counter wrapping back to the initial kernel count value, wherein the inner input base register provides an inner input base location; incrementing the inner input base register in response to the accumulator counter being incrementing; incrementing the inner input base register in response to the accumulator counter wrapping back to the initial accumulator value; and calculating the input location based on the inner input base location and the output of the kernel element counter.

Example A94. The method of example A93, wherein the inner input base register, when incremented, increments by a stride amount for the convolution operation.

Example A95. The method of example A93, further comprising calculating the input location by multiplying the output of the kernel element counter by a dilation value for the convolution operation and adding a difference between the inner input base register and an effective pad value for the convolution operation.

Example A96. The method of example A95, further comprising: checking the input location against bounds for an input to the convolution operation, and setting a predicate for the input location to indicate that no memory read should be performed and that a value of zero should be provided in place of data read from memory for the input location in response to determining that the input location is outside of the bounds.

Example A97. The method of example A93, further comprising: calculating the input location by indexing into an offset lookup table using the output of the kernel element counter to obtain an input offset value; and adding a value of the inner input base register to the input offset value.

Example A98. The method of example A95, further comprising: checking the input location against bounds for an input to the convolution operation, and setting a predicate for the input location to indicate that no memory read should be performed and that a value of zero should be provided in place of data read from memory for the input location in response to determining that the input location is outside of the bounds.

Example A99. The method of example A88, further comprising: calculating an input memory address based on the input location; accessing an input memory using the input memory address to retrieve an input element; and sending the input element to a compute unit for use in the convolution operation.

Example B1. A statically reconfigurable dataflow architecture processor comprising: an array of coarse-grained reconfigurable (CGR) units including a plurality of statically reconfigurable memory units, a plurality of statically reconfigurable compute units, a plurality of statically reconfigurable switches, and a plurality of links that respectively connect two of the CGR units, and respectively include a vector link; the plurality of statically reconfigurable compute units respectively including an array of multiply-accumulate circuits (MACs) having a plurality of lanes and a plurality of stages, the plurality of statically reconfigurable compute units including a first statically reconfigurable compute unit; the plurality of statically reconfigurable memory units respectively including a memory array, a general address calculation unit, and a convolution address compute unit, the plurality of statically reconfigurable memory units including a first, a second, and a third statically reconfigurable memory unit; and the convolution address compute units of the plurality of statically reconfigurable memory units respectively comprising: a kernel element counter for a convolution operation between a kernel and an input tensor, the kernel element counter wrapping back to an initial kernel count value after reaching a maximum kernel count value; an offset look-up table (LUT) that provides a relative input offset into the input tensor based on an output of the kernel element counter; and input location calculation logic that provides an input location within an input tensor for the convolution operation based on the relative input offset provided by the offset LUT.

Example B2. The statically reconfigurable dataflow architecture processor of example B1, wherein the convolution address compute units are configured to update the input location in response to an update of the kernel element counter.

Example B3. The statically reconfigurable dataflow architecture processor of example B1, wherein the relative input offset provided by the offset LUT is precomputed for a dilation value, an effective pad value, and/or a fractional stride value for the convolution operation.

Example B4. The statically reconfigurable dataflow architecture processor of example B1, the convolution address compute units further respectively comprising a kernel offset LUT providing a kernel offset into the kernel based on the kernel element counter.

Example B5. The statically reconfigurable dataflow architecture processor of example B1, wherein the maximum kernel count value is less than a size of the kernel and the offset LUT omits entries corresponding to elements of the kernel that do not correspond to an element of the input tensor due to a fractional stride value for the convolution operation.

Example B6. The statically reconfigurable dataflow architecture processor of example B1, wherein the offset LUT further provides a kernel offset into the kernel based on the kernel element counter.

Example B7. The statically reconfigurable dataflow architecture processor of example B1, wherein the maximum kernel count value is less than a size of the kernel and the offset LUT omits entries corresponding to elements of the kernel that would be multiplied by a zero value due to a fractional stride value for the convolution operation.

Example B8. The statically reconfigurable dataflow architecture processor of example B1, the convolution address compute units respectively further comprising: an outer input base location register to provide an outer input base location for the input tensor; an inner input base register to provide an inner input base location for the input tensor, the inner input base register is configured to increment in response to a new input location being calculated, and to load the outer input base location in response to the kernel element counter wrapping back to the initial kernel count value; and an adder in the input location calculation logic with a first input coupled to an output of the inner input base register, a second input coupled to an output of the offset LUT, and an output to provide the input location as a sum of the inner input base location and the relative input offset provided by the offset LUT.

Example B9. The statically reconfigurable dataflow architecture processor of example B8, the convolution address compute units respectively further comprising address generation circuitry configured to generate at least one input address in response to a change in the kernel element counter to provide to a memory array.

Example B10. The statically reconfigurable dataflow architecture processor of example B8, the input location calculation logic including circuitry to check the input location against bounds for the input tensor, and in response to determining that the input location is outside of the bounds, to set a predicate for the input location to indicate that no memory read should be performed and that a value of zero should be provided in place of data read from memory for the input location.

Example B11. The statically reconfigurable dataflow architecture processor of example B8, the convolution address compute units respectively further comprising: an accumulator counter configured to be reset to an initial accumulator value in response to a change in the kernel element counter and increment in response to a new input location being calculated, until reaching a maximum accumulator count value; wherein the inner input base register is configured to increment in response to the new input location being calculated; and the kernel element counter is configured to increment in response to the accumulator counter reaching the maximum accumulator count value.

Example B12. The statically reconfigurable dataflow architecture processor of example B11, wherein the inner input base register, when incremented, increments by a stride amount for the convolution operation.

Example B13. The statically reconfigurable dataflow architecture processor of example B11, the convolution address compute units respectively further comprising: an outer output base location register to provide an outer output base location for the convolution operation; and an inner output register to provide an output location, the inner output register configured to increment in response to the accumulator counter incrementing and to load the outer output base location in response to the kernel element counter changing.

Example B14. The statically reconfigurable dataflow architecture processor of example B1, the convolution address compute units respectively further comprising: a first dimension outer input base location register to provide an outer input base location for a first dimension of the input tensor; a second dimension outer input base location register to provide an outer input base location for a second dimension of the input tensor; a first dimension kernel counter of the kernel element counter for a first dimension of the kernel and a second dimension kernel counter of the kernel element counter for a second dimension of the kernel, the second dimension kernel counter configured to increment in response to the first dimension kernel counter wrapping to its initial value from a maximum first dimension kernel count value; the offset LUT including a first dimension offset LUT, indexed by an output of the first dimension kernel counter, that provides a first dimension relative input offset for a first dimension of the input tensor, and a second dimension offset LUT indexed by an output of the second dimension kernel counter that provides a second dimension relative input offset for a second dimension of the input tensor; a first adder in the input location calculation logic with inputs coupled to the first dimension outer input base location register and the first dimension offset LUT, having an output to provide a first dimension of the input location; and a second adder in the input location calculation logic with inputs coupled to the second dimension outer input base location register and the second dimension offset LUT, having an output to provide a second dimension of the input location; wherein the convolution operation is a multidimensional convolution operation.

Example B15. The statically reconfigurable dataflow architecture processor of example B14, the convolution address compute units respectively further comprising: a third dimension outer input base location register to provide an outer input base location for a third dimension of the input tensor; a third dimension kernel counter of the kernel element counter for the third dimension of the kernel, the third dimension kernel counter configured to increment in response to the second dimension kernel counter wrapping to its initial value from a maximum second dimension kernel count value; the offset LUT including a third dimension offset LUT, indexed by an output of the third dimension kernel counter, that provides a third dimension relative input offset for a third dimension of the input tensor; and a third adder in the input location calculation logic with inputs coupled to the third dimension outer input base location register and the third dimension offset LUT, having an output to provide a third dimension of the input location; wherein the convolution operation is a three-dimensional convolution operation.

Example B16. The statically reconfigurable dataflow architecture processor of example B1, the convolution address compute units respectively further comprising: a group counter to provide a group number; and a group LUT that provides a value K based on the group number; wherein the kernel element counter is configured to use the value K as the maximum kernel count value until the group number is changed; and the offset LUT provides the relative input offset further based on the group number.

Example B17. The statically reconfigurable dataflow architecture processor of example B16, the convolution address compute units respectively further comprising a kernel offset LUT providing a kernel offset into the kernel based on the kernel element counter and the group number.

Example B18. The statically reconfigurable dataflow architecture processor of example B16, wherein the offset LUT further provides a kernel offset into the kernel based on the kernel element counter and the group number.

Example B19. The statically reconfigurable dataflow architecture processor of example B16, the offset LUT further provides a predicate to indicate, for the relative input offset provided by the offset LUT, whether (a) a memory read should be performed and data read from memory provided as data for the input tensor or (b) a value of zero should be provided as the data for the input tensor.

Example B20. The statically reconfigurable dataflow architecture processor of example B16, the convolution address compute units respectively further comprising: a first dimension outer input base location register to provide an outer input base location for a first dimension of the input tensor; a second dimension outer input base location register to provide an outer input base location for a second dimension of the input tensor; a first dimension kernel counter of the kernel element counter for the first dimension of the kernel and a second dimension kernel counter of the kernel element counter for a second dimension of the kernel, the second dimension kernel counter configured to increment in response to the first dimension kernel counter wrapping to its initial value from a maximum first dimension kernel count value; the offset LUT including a first dimension offset LUT, indexed by an output of the first dimension kernel counter, that provides a first dimension relative input offset for a first dimension of the input tensor, and a second dimension offset LUT indexed by an output of the second dimension kernel counter that provides a second dimension relative input offset for a second dimension of the input tensor; a first adder in the input location calculation logic with inputs coupled to the first dimension outer input base location register and the first dimension offset LUT, having an output to provide a first dimension of the input location; and a second adder in the input location calculation logic with inputs coupled to the second dimension outer input base location register and the second dimension offset LUT, having an output to provide a second dimension of the input location; wherein the convolution operation is a multidimensional convolution operation.

Example B21. The statically reconfigurable dataflow architecture processor of example B16, the convolution address compute units respectively further comprising: an inner input base register to provide an inner input base location; an outer input base location register to provide an outer input base location for the convolution operation; an accumulator counter configured to be reset to an initial accumulator value in response to a change in the kernel element counter and increment in response to a new input location being calculated, until reaching a maximum accumulator count value; and an adder in the input location calculation logic with a first input coupled to an output of the inner input base register, a second input coupled to an output of the offset LUT, and an output to provide the input location as a sum of the inner input base location and the relative input offset provided by the offset LUT; wherein the inner input base register is configured to increment in response to the new input location being calculated, and to load the outer input base location in response to the kernel element counter wrapping back to the initial kernel count value.

Example B22. The statically reconfigurable dataflow architecture processor of example B21, wherein the inner input base register, when incremented, increments by a stride amount for the convolution operation.

Example B23. The statically reconfigurable dataflow architecture processor of example B21, the convolution address compute units respectively further comprising: an outer output base location register to provide an outer output base location for the convolution operation; and an inner output register to provide an output location, the inner output register configured to increment in response to the accumulator counter incrementing and to load the outer output base location in response to the kernel element counter changing.

Example B24. The statically reconfigurable dataflow architecture processor of example B21, the input location calculation logic including circuitry to check the input location against bounds for the input tensor, and in response to determining that the input location is outside of the bounds, to set a predicate for the input location to indicate that no memory read should be performed and that a value of zero should be provided in place of data read from memory for the input location.

Example B25. The statically reconfigurable dataflow architecture processor of example B21, the convolution address compute units respectively further comprising: a kernel offset LUT providing a kernel offset into the kernel based on the kernel element counter; and an inner output register loaded with an output location.

Example B26. The statically reconfigurable dataflow architecture processor of example B25, wherein the plurality of statically reconfigurable memory units include a first statically reconfigurable memory unit, a second statically reconfigurable memory unit, and a third statically reconfigurable memory unit, and the plurality of statically reconfigurable compute units includes a first statically reconfigurable compute unit and a second statically reconfigurable compute unit; the first statically reconfigurable memory unit is configured to use its general address calculation unit to calculate a first kernel memory address based on the kernel offset during a first period where the accumulator counter has a first value, use the first kernel memory address to read a first kernel vector element from its memory array, and send the first kernel vector element to the first statically reconfigurable compute unit; the second statically reconfigurable memory unit is configured to use its general address calculation unit to calculate a first input memory address based on the input location during the first period, use the first input memory address to read a first input vector element from its memory array, and send the first input vector element to the first statically reconfigurable compute unit; the first statically reconfigurable compute unit is configured to calculate a first dot product of the first kernel vector element and the first input vector element in a first MAC in first stage of the array of MACs, and accumulate a result of the first dot product with a previous value of an accumulator of the first MAC; the second statically reconfigurable memory unit is further configured to use its general address calculation unit to calculate a second input memory address based on the input location during a second period where the accumulator counter has a second value, use the second input memory address to read a second input vector element from its memory array, and send the second input vector element to the second statically reconfigurable compute unit; the first statically reconfigurable compute unit is further configured to calculate a second dot product of the first kernel vector element and the second input vector element in a second MAC in second stage of the array of MACs, and accumulate a result of the second dot product with a previous value of an accumulator of the second MAC, wherein the calculation of the second dot product in the second MAC occurs in parallel with the calculation of the first dot product in the first MAC; the first statically reconfigurable compute unit is further configured to process K input vector elements in both the first MAC and the second MAC, where K is a number of active locations in a receptive field of an input for the convolution operation, and then send both a first accumulated value from the accumulator of the first MAC and a second accumulated value from the accumulator of the second MAC to the third statically reconfigurable memory unit; and the third statically reconfigurable memory unit is configured to use its general address calculation unit to calculate a first output memory address based on the output location during the first period and a second output memory address based on the output location during the second period, use the first output memory address to store the first accumulated value received from the first statically reconfigurable compute unit in its memory array, and use the second output memory address to store the second accumulated value received from the first statically reconfigurable compute unit in its memory array.

Example B27. The statically reconfigurable dataflow architecture processor of example B26, wherein the first statically reconfigurable memory unit is configured to use its general address calculation unit to calculate a kernel memory address based on the kernel offset, use the kernel memory address to read kernel data from its memory array, and send the kernel data as a first element of a pair of values of a plurality of pairs of values to the first statically reconfigurable compute unit of the plurality of statically reconfigurable compute units; the second statically reconfigurable memory unit is configured to use its general address calculation unit to calculate an input memory address based on the input location, use the input memory address to read input data from its memory array, and send the input data as a second element of the pair of values of the plurality of pairs of values to the first statically reconfigurable compute unit; the first statically reconfigurable compute unit is configured to (a) receive the plurality of pairs of values respectively from the first statically reconfigurable memory unit and the second statically reconfigurable memory unit, (b) multiply and accumulate the plurality of pairs of values in a MAC unit in the array of MAC units as an accumulated value, and (c) send the accumulated value to the third statically reconfigurable memory unit; and the third statically reconfigurable memory unit is configured to use its general address calculation unit to calculate an output memory address based on the output location and use the output memory address to store the accumulated value received from the first statically reconfigurable compute unit in its memory array.

Example B28. A convolution calculation engine comprising: a kernel element counter for a convolution operation between a kernel and an input tensor, the kernel element counter wrapping back to an initial kernel count value after reaching a maximum kernel count value; an offset look-up table (LUT) that provides a relative input offset into the input tensor based on an output of the kernel element counter; and input location calculation logic that provides an input location within an input tensor for the convolution operation based on the relative input offset provided by the offset LUT.

Example B29. The convolution calculation engine of example B28, wherein the relative input offset provided by the offset LUT is precomputed for a dilation value, an effective pad value, and/or a fractional stride value for the convolution operation.

Example B30. The convolution calculation engine of example B28, further comprising a kernel offset LUT providing a kernel offset into the kernel based on the kernel element counter.

Example B31. The convolution calculation engine of example B28, wherein the maximum kernel count value is less than a size of the kernel and the offset LUT omits entries corresponding to elements of the kernel that do not correspond to an element of the input tensor due to a fractional stride value for the convolution operation.

Example B32. The convolution calculation engine of example B28, wherein the offset LUT further provides a kernel offset into the kernel based on the kernel element counter.

Example B33. The convolution calculation engine of example B32, wherein the maximum kernel count value is less than a size of the kernel and the offset LUT omits entries corresponding to elements of the kernel that would be multiplied by a zero value due to a fractional stride value for the convolution operation.

Example B34. The convolution calculation engine of example B28, further comprising: an outer input base location register to provide an outer input base location for the input tensor; an inner input base register to provide an inner input base location for the input tensor, the inner input base register configured to load the outer input base location in response to the kernel element counter wrapping back to the initial kernel count value; and an adder in the input location calculation logic with a first input coupled to an output of the inner input base register, a second input coupled to an output of the offset LUT, and an output to provide the input location as a sum of the inner input base location and the relative input offset provided by the offset LUT.

Example B35. The convolution calculation engine of example B34, further comprising address generation circuitry configured to generate at least one input address in response to a change in the kernel element counter.

Example B36. The convolution calculation engine of example B34, further comprising address generation circuitry configured to generate a single input address in response to a change in the kernel element counter, wherein the kernel element counter is configured to increment in response to the generation of the single input address.

Example B37. The convolution calculation engine of example B34, further comprising circuitry in the input location calculation logic to check the input location against bounds for the input tensor, and in response to determining that the input location is outside of the bounds, to set a predicate for the input location to indicate that no memory read should be performed and that a value of zero should be provided in place of data read from memory for the input location.

Example B38. The convolution calculation engine of example B34, further comprising: an accumulator counter configured to be reset to an initial accumulator value in response to a change in the kernel element counter and increment in response to a new input location being calculated, until reaching a maximum accumulator count value; wherein the inner input base register is configured to increment in response to the new input location being calculated; and the kernel element counter is configured to increment in response to the accumulator counter reaching the maximum accumulator count value.

Example B39. The convolution calculation engine of example B38, wherein the inner input base register, when incremented, increments by a stride amount for the convolution operation.

Example B40. The convolution calculation engine of example B38, further comprising address generation circuitry configured to generate an input address in response to a change in the accumulator counter.

Example B41. The convolution calculation engine of example B38, further comprising: an outer output base location register to provide an outer output base location for the convolution operation; and an inner output register to provide an output location, the inner output register configured to increment in response to the accumulator counter incrementing and to load the outer output base location in response to the kernel element counter changing.

Example B42. The convolution calculation engine of example B28, further comprising: a first dimension outer input base location register to provide an outer input base location for a first dimension of the input tensor; a second dimension outer input base location register to provide an outer input base location for a second dimension of the input tensor; a first dimension kernel counter of the kernel element counter for a first dimension of the kernel and a second dimension kernel counter of the kernel element counter for a second dimension of the kernel, the second dimension kernel counter configured to increment in response to the first dimension kernel counter wrapping to its initial value from a maximum first dimension kernel count value; the offset LUT including a first dimension offset LUT, indexed by an output of the first dimension kernel counter, that provides a first dimension relative input offset for a first dimension of the input tensor, and a second dimension offset LUT indexed by an output of the second dimension kernel counter that provides a second dimension relative input offset for a second dimension of the input tensor; a first adder in the input location calculation logic with inputs coupled to the first dimension outer input base location register and the first dimension offset LUT, having an output to provide a first dimension of the input location; and a second adder in the input location calculation logic with inputs coupled to the second dimension outer input base location register and the second dimension offset LUT, having an output to provide a second dimension of the input location; wherein the convolution operation is a multidimensional convolution operation.

Example B43. The convolution calculation engine of example B42, further comprising: a third dimension outer input base location register to provide an outer input base location for a third dimension of the input tensor; a third dimension kernel counter of the kernel element counter for the third dimension of the kernel, a third dimension kernel counter configured to increment in response to the second dimension kernel counter wrapping to its initial value from a maximum second dimension kernel count value; the offset LUT including a third dimension offset LUT, indexed by an output of the third dimension kernel counter, that provides a third dimension relative input offset for a third dimension of the input tensor; and a third adder in the input location calculation logic with inputs coupled to the third dimension outer input base location register and the third dimension offset LUT, having an output to provide a third dimension of the input location; wherein the convolution operation is a three-dimensional convolution operation.

Example B44. The convolution calculation engine of example B28, further comprising: a group counter to provide a group number; and a group LUT that provides a value K based on the group number; wherein the kernel element counter is configured to use the value K as the maximum kernel count value until the group number is changed; and the offset LUT provides the relative input offset further based on the group number.

Example B45. The convolution calculation engine of example B44, further comprising a kernel offset LUT providing a kernel offset into the kernel based on the kernel element counter and the group number.

Example B46. The convolution calculation engine of example B44, wherein the offset LUT further provides a kernel offset into the kernel based on the kernel element counter and the group number.

Example B47. The convolution calculation engine of example B44, the offset LUT further provides a predicate to indicate, for the relative input offset provided by the offset LUT, whether (a) a memory read should be performed and data read from memory provided as data for the input tensor or (b) a value of zero should be provided as the data for the input tensor.

Example B48. The convolution calculation engine of example B44, further comprising: a first dimension outer input base location register to provide an outer input base location for a first dimension of the input tensor; a second dimension outer input base location register to provide an outer input base location for a second dimension of the input tensor; a first dimension kernel counter of the kernel element counter for the first dimension of the kernel and a second dimension kernel counter of the kernel element counter for a second dimension of the kernel, the second dimension kernel counter configured to increment in response to the first dimension kernel counter wrapping to its initial value from a maximum first dimension kernel count value; the offset LUT including a first dimension offset LUT, indexed by an output of the first dimension kernel counter, that provides a first dimension relative input offset for a first dimension of the input tensor, and a second dimension offset LUT indexed by an output of the second dimension kernel counter that provides a second dimension relative input offset for a second dimension of the input tensor; a first adder in the input location calculation logic with inputs coupled to the first dimension outer input base location register and the first dimension offset LUT, having an output to provide a first dimension of the input location; and a second adder in the input location calculation logic with inputs coupled to the second dimension outer input base location register and the second dimension offset LUT, having an output to provide a second dimension of the input location; wherein the convolution operation is a multidimensional convolution operation.

Example B49. The convolution calculation engine of example B44, further comprising: an inner input base register to provide an inner input base location; an outer input base location register to provide an outer input base location for the convolution operation; an accumulator counter configured to be reset to an initial accumulator value in response to a change in the kernel element counter and increment in response to a new input location being calculated, until reaching a maximum accumulator count value; and an adder in the input location calculation logic with a first input coupled to an output of the inner input base register, a second input coupled to an output of the offset LUT, and an output to provide the input location as a sum of the inner input base location and the relative input offset provided by the offset LUT; wherein the inner input base register is configured to increment in response to the new input location being calculated, and to load the outer input base location in response to the kernel element counter wrapping back to the initial kernel count value.

Example B50. The convolution calculation engine of example B49, further comprising address generation circuitry configured to generate an input address in response to a change in the accumulator counter.

Example B51. The convolution calculation engine of example B49, further comprising: an outer output base location register to provide an outer output base location for the convolution operation; and an inner output register to provide an output location, the inner output register configured to increment in response to the accumulator counter incrementing and to load the outer output base location in response to the kernel element counter changing.

Example B52. The convolution calculation engine of example B49, further comprising circuitry in the input location calculation logic to check the input location against bounds for the input tensor, and in response to determining that the input location is outside of the bounds, to set a predicate for the input location to indicate that no memory read should be performed and that a value of zero should be provided in place of data read from memory for the input location.

Example B53. The convolution calculation engine of any one of clauses 28 through 26, further comprising: address generation circuitry to generate a memory address for an element of the input tensor based on the input location; a memory array; and a memory controller configured to access the memory array using the memory address and provide data read from the memory array to a multiply-accumulate unit for using in performing the convolution operation.

Example B54. The convolution calculation engine of any one of clauses 28 through 26, further comprising: a multiply-accumulate unit; address generation circuitry configured to generate a memory address for an element of the input tensor based on the input location; a memory array; and a memory controller configured to access the memory array using the memory address and provide data read from the memory array to the multiply-accumulate unit for using in performing the convolution operation.

Example B55. A method for use in a convolution operation between a kernel and an input tensor comprising: counting, using a kernel element counter from an initial kernel count value to a maximum kernel count value before wrapping back to the initial kernel count value; using an offset look-up table (LUT) to look up a relative input offset into the input tensor based on an output of the kernel element counter; and calculating an input location within an input tensor for the convolution operation based on the relative input offset provided by the offset LUT.

Example B56. The method of example B55, wherein the relative input offset provided by the offset LUT is precomputed for a dilation value, an effective pad value, and/or a fractional stride value for the convolution operation.

Example B57. The method of example B55, further comprising using a kernel offset LUT to look up a kernel offset into the kernel based on the kernel element counter.

Example B58. The method of example B55, wherein the maximum kernel count value is less than a size of the kernel and the offset LUT omits entries corresponding to elements of the kernel that do not correspond to an element of the input tensor due to a fractional stride value for the convolution operation.

Example B59. The method of example B55, further comprising using the offset LUT to look up a kernel offset into the kernel based on the kernel element counter.

Example B60. The method of example B59, wherein the maximum kernel count value is less than a size of the kernel and the offset LUT omits entries corresponding to elements of the kernel that would be multiplied by a zero value due to a fractional stride value for the convolution operation.

Example B61. The method of example B55, further comprising: loading an outer input base location into an inner input base register in response to the kernel element counter wrapping back to the initial kernel count value, wherein an outer input base location register provides an outer input base location for the input tensor and the inner input base register provides an inner input base location for the input tensor; and adding an output of the inner input base register to an output of the offset LUT to provide the input location as a sum of the inner input base location and the relative input offset provided by the offset LUT.

Example B62. The method of example B61, further comprising generating at least one input address in response to a change in the kernel element counter.

Example B63. The method of example B61, further comprising generating a single input address in response to a change in the kernel element counter, wherein the kernel element counter is configured to increment in response to the generation of the single input address.

Example B64. The method of example B61, further comprising checking the input location against bounds for the input tensor, and in response to determining that the input location is outside of the bounds, setting a predicate for the input location to indicate that no memory read should be performed and that a value of zero should be provided in place of data read from memory for the input location.

Example B65. The method of example B61, further comprising: resetting an accumulator counter to an initial accumulator value in response to the kernel element counter wrapping back to the initial kernel count value; incrementing the accumulator counter, in response to an update of the inner input base register, until reaching a maximum accumulator count value before wrapping back to the initial accumulator value; incrementing the inner input base register in response to the accumulator counter wrapping back to the initial accumulator value; incrementing the inner input base register in response to the accumulator counter incrementing; and incrementing the kernel element counter in response to the accumulator counter reaching the maximum accumulator count value.

Example B66. The method of example B65, wherein the inner input base register, when incremented, increments by a stride amount for the convolution operation.

Example B67. The method of example B65, further comprising generating an input address in response to a change in the accumulator counter.

Example B68. The method of example B65, further comprising: providing an outer output base location for the convolution operation from an outer output base location register; loading an inner output register with the outer output base location in response to the kernel element counter changing; and incrementing the inner output register in response to the accumulator counter incrementing.

Example B69. The method of example B55, wherein the convolution operation is a multidimensional convolution operation; the offset LUT includes a first dimension offset LUT and a second dimension offset LUT; a first dimension outer input base location register for a first dimension of an input to the convolution operation; and a second dimension outer input base location register for a second dimension of the input to the convolution operation; the method further comprising: incrementing a first dimension kernel counter as a part of the counting by the kernel element counter, wherein the first dimension outer input base location register to provide an outer input base location for a first dimension of the input tensor; incrementing a second dimension kernel counter in response to the first dimension kernel counter wrapping to its initial value from a maximum first dimension kernel count value, wherein the second dimension outer input base location register to provide an outer input base location for a second dimension of the input tensor; obtaining a first dimension relative input offset for a first dimension of the input tensor from the first dimension offset LUT using an output of the first dimension kernel counter; obtaining a second dimension relative input offset for second first dimension of the input tensor from the second dimension offset LUT using an output of the second dimension kernel counter; adding the first dimension outer input base location register to the first dimension offset LUT to provide a first dimension of the input location; and adding the second dimension outer input base location register to the second dimension offset LUT to provide a second dimension of the input location.

Example B70. The method of example B55, further comprising: providing a group number from a group counter; obtaining a value K from a group LUT based on the group number; using the value K as the maximum kernel count value the kernel element counter until the group number is changed; and using the group number as a further index into the offset LUT to look up the relative input offset.

Example B71. The method of example B70, further comprising obtaining a predicate, from the offset LUT, to indicate, for the relative input offset provided by the offset LUT, whether (a) a memory read should be performed and data read from memory provided as data for the input tensor or (b) a value of zero should be provided as the data for the input tensor.

Example B72. The method of example B70, wherein the convolution operation is a multidimensional convolution operation; the offset LUT includes a first dimension offset LUT and a second dimension offset LUT; a first dimension outer input base location register for a first dimension of an input to the convolution operation; and a second dimension outer input base location register for a second dimension of the input to the convolution operation; the method further comprising: incrementing a first dimension kernel counter as a part of the counting by the kernel element counter, wherein the first dimension outer input base location register to provide an outer input base location for a first dimension of the input tensor; incrementing a second dimension kernel counter in response to the first dimension kernel counter wrapping to its initial value from a maximum first dimension kernel count value, wherein the second dimension outer input base location register to provide an outer input base location for a second dimension of the input tensor; obtaining a first dimension relative input offset for a first dimension of the input tensor from the first dimension offset LUT using an output of the first dimension kernel counter; obtaining a second dimension relative input offset for second first dimension of the input tensor from the second dimension offset LUT using an output of the second dimension kernel counter; adding the first dimension outer input base location register to the first dimension offset LUT to provide a first dimension of the input location; and adding the second dimension outer input base location register to the second dimension offset LUT to provide a second dimension of the input location.

Example B73. The method of example B70, further comprising: initializing an outer output base location register to provide an outer output base location for the convolution operation; initializing an outer input base location register to provide an outer input base location for the convolution operation; calculating an input location based on the outer input base location and the output of the kernel element counter; resetting an accumulator counter to an initial accumulator value in response to the kernel element counter wrapping back to the initial kernel count value; incrementing the accumulator counter in response to an update of an inner input base register; wrapping the accumulator counter back to the initial accumulator value after reaching a maximum accumulator count value; incrementing the kernel element counter in response to the accumulator counter reaching the maximum accumulator count value; loading the outer input base location into an inner input base register in response to the kernel element counter wrapping back to the initial kernel count value, wherein the inner input base register provides an inner input base location; incrementing the inner input base register in response to the accumulator counter being incrementing; incrementing the inner input base register in response to the accumulator counter wrapping back to the initial accumulator value; and calculating the input location based on the inner input base location and the output of the kernel element counter.

Example B74. The method of example B73, wherein the inner input base register, when incremented, increments by a stride amount for the convolution operation.

Example B75. The method of example B73, further comprising generating an input address in response to a change in the accumulator counter.

Example B76. The method of example B73, further comprising: providing an outer output base location for the convolution operation from an outer output base location register; loading an inner output register with the outer output base location in response to the kernel element counter changing; and incrementing the inner output register in response to the accumulator counter incrementing.

Example B77. The method of example B73, further comprising: checking the input location against bounds for an input to the convolution operation, and setting a predicate for the input location to indicate that no memory read should be performed and that a value of zero should be provided in place of data read from memory for the input location in response to determining that the input location is outside of the bounds.

Example C1. A computer-implemented method for producing a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value, the method comprising: determining a first group of relative input offsets into the input tensor for an output element of an output of the convolution operation based on the dilation value, and the effective padding value; generating an offset table including the first group of relative input offsets to load into an offset look-up table (LUT) in the convolution calculation engine, wherein the offset table is indexable by an index count; and including the offset table in the configuration file.

Example C2. The method of example C1, wherein the stride value is a fractional stride value with a stride numerator value of 1 and a stride denominator value that is a positive integer, the method further comprising: determining a first group of kernel offsets for the output element corresponding to the first group of relative input offsets; determining a number of groups of pairs of kernel offsets and relative input offsets for the convolution operation, wherein the number of groups is equal to the stride denominator value; including each group of the number of groups of pairs of kernel offsets and relative input offsets in the offset table, wherein the offset table is also indexable by a group number in addition to the index count; determining a number of pairs of kernel offsets and relative input offsets in each group of the number of groups; generating a group table including the number of pairs in each group of the number of groups to load into a group LUT in the convolution calculation engine, wherein the group table is indexable by the group number; and including the group table in the configuration file; wherein a first group of pairs of kernel offsets and relative input offsets includes the first group of kernel offsets and the first group of relative input offsets.

Example C3. The method of example C1, further comprising including any combination of a size of the output of the convolution operation, a number of accumulators to use for the convolution operation, a size of the input tensor, and/or the stride value in the configuration file for use by the convolution calculation engine.

Example C4. The method of example C1, further comprising: determining first group of kernel offsets for the output element corresponding to the first group of relative input offsets; determining a first index count based on a first kernel offset in the first group of kernel offsets; calculating a first relative input offset of the first group of relative input offsets in the offset table corresponding to the first kernel offset by multiplying the first kernel offset by the dilation value and subtracting the effective padding value; and storing the first relative input offset in the offset table at a location indexed by the first index count.

Example C5. The method of example C4, further comprising: generating a kernel table including the first group of kernel offsets to load a kernel LUT in the convolution calculation engine, wherein the kernel table is indexable by the index count so that for a given index count, a relative input offset of the first group of relative input offsets in the offset table corresponds to a kernel offset of the first group of kernel offsets in the kernel table; and including the kernel table in the configuration file.

Example C6. The method of example C5, wherein the offset table and the kernel table are separate fields of a common table stored in a combined offset LUT.

Example C7. The method of example C5, wherein the stride value is a fractional stride value with a stride numerator value of 1 and a stride denominator value that is a positive integer, the method further comprising: determining a number of groups of pairs of kernel offsets and relative input offsets for the convolution operation, wherein the number of groups is equal to the stride denominator value; and including each group of the number of groups of pairs of kernel offsets and relative input offsets in the kernel table and the offset table, respectively, wherein both the offset table and the kernel table are also indexable by a group number in addition to the index count; determining a number of pairs of kernel offsets and relative input offsets in each group of the number of groups; generating a group table including the number of pairs in each group of the number of groups to load into a group LUT in the convolution calculation engine, wherein the group table is indexable by the group number; and including the group table in the configuration file; wherein a first group of pairs of kernel offsets and relative input offsets includes the first group of kernel offsets and the first group of relative input offsets.

Example C8. The method of example C7, further comprising including the stride denominator value in the configuration file for use by the convolution calculation engine.

Example C9. The method of example C7, wherein the group number ranges from 0 to one less than the stride denominator value, inclusive, a first relative input offset is included in the offset table indexed by a first group number and a first index count, and a first kernel offset is included in the kernel table indexed by the first group number and the first index count, the method further comprising: multiplying the first kernel offset by the dilation value, adding the first group number and subtracting the effective padding value, and then dividing that result by the stride denominator value to obtain an integer quotient and a remainder; and adding the integer quotient as the first relative input offset to the offset table and adding the first kernel offset to the kernel table, in response to the remainder being 0.

Example C10. The method of example C9, further comprising: resetting an elements counter to zero at a start of calculating a group of the number of groups of pairs; using the elements counter as the first index count for adding both the integer quotient to the offset table and the first kernel offset to the kernel table; and incrementing the elements counter after adding both the integer quotient to the offset table and the first kernel offset to the kernel table.

Example C11. The method of example C5, wherein the convolution operation is multidimensional; the kernel has a first dimension size and a second dimension size; each kernel offset of the first group of kernel offsets includes a first dimension kernel offset and a second dimension kernel offset; each relative input offset of the first group of relative input offsets includes a first dimension relative input offset and a second dimension relative input offset; the index count includes a first dimension index count and a second dimension index count; the offset table includes a first dimension offset table and second dimension offset table; the kernel table includes a first dimension kernel table and a second dimension kernel table; the dilation value includes a first dimension dilation value and a second dimension dilation value; the effective padding value includes a first dimension effective padding value and a second effective padding value; the stride value includes a first dimension stride value and a second dimension stride value; the first dimension stride value includes a first dimension stride numerator value and a first dimension stride denominator value; and the second dimension stride value includes a second dimension stride numerator value and a second dimension stride denominator value; the method further comprising: determining a number of groups of pairs of kernel offsets and relative input offsets for a first dimension of the convolution operation, wherein the number of groups for the first dimension is equal to the first dimension stride denominator value; and including each group of the number of groups of pairs of kernel offsets and relative input offsets for the first dimension in the first dimension kernel table and the first dimension offset table, respectively, wherein both the first dimension offset table and the first dimension kernel table are indexable by a first dimension group number in addition to the first dimension index count; determining a number of pairs of kernel offsets and relative input offsets in each group of the number of groups for the first dimension, generating a first dimension group table including the number of pairs in each group of the number of groups for the first dimension to load into a first dimension group LUT in the convolution calculation engine, and including the first dimension group table in the configuration file, wherein the first dimension group table is indexable by the first dimension group number; determining a number of groups of pairs of kernel offsets and relative input offsets for a second dimension of the convolution operation, wherein the number of groups for the second dimension is equal to the second dimension stride denominator value; and including each group of the number of groups of pairs of kernel offsets and relative input offsets for the second dimension in the second dimension kernel table and the second dimension offset table, respectively, wherein both the second dimension offset table and the second dimension kernel table are indexable by a second dimension group number in addition to the second dimension index count; determining a number of pairs of kernel offsets and relative input offsets in each group of the number of groups for the second dimension, generating a second dimension group table including the number of pairs in each group of the number of groups for the second dimension to load into a second dimension group LUT in the convolution calculation engine, and including the second dimension group table in the configuration file, wherein the second dimension group table is indexable by the second dimension group number; and including the first dimension group table and the second dimension group table in the configuration file.

Example C12. The method of example C5, wherein the convolution operation is multidimensional; the kernel has a first dimension size and a second dimension size; each kernel offset of the first group of kernel offsets includes a first dimension kernel offset and a second dimension kernel offset; each relative input offset of the first group of relative input offsets includes a first dimension relative input offset and a second dimension relative input offset; the index count includes a first dimension index count and a second dimension index count; the offset table includes a first dimension offset table and second dimension offset table; the kernel table includes a first dimension kernel table and a second dimension kernel table; the dilation value includes a first dimension dilation value and a second dimension dilation value; the effective padding value includes a first dimension effective padding value and a second dimension effective padding value; and the stride value includes a first dimension stride value and a second dimension stride value.

Example C13. The method of example C12, further comprising: generating a number of relative input offsets in the first dimension offset table equal to the first dimension size of the kernel, relative input offsets in the number of relative input offsets in the first dimension offset table calculated based on the first dimension dilation value, the first dimension effective padding value, and the first dimension stride value; and generating a number of relative input offsets in the second dimension offset table equal to the second dimension size of the kernel, relative input offsets in the number of relative input offsets in the second dimension offset table calculated based on the second dimension dilation value, the second dimension effective padding value, and the second dimension stride value.

Example C14. The method of example C12, wherein the first dimension stride value includes a first dimension stride numerator value and a first dimension stride denominator value, the second dimension stride value includes a second dimension stride numerator value and a second dimension stride denominator value, the method further comprising: determining a number of groups of pairs of kernel offsets and relative input offsets for a first dimension of the convolution operation, wherein the number of groups for the first dimension is equal to the first dimension stride denominator value; and including each group of the number of groups of pairs of kernel offsets and relative input offsets for the first dimension in the first dimension kernel table and the first dimension offset table, respectively, wherein both the first dimension offset table and the first dimension kernel table are indexable by a first dimension group number in addition to the first dimension index count; determining a number of pairs of kernel offsets and relative input offsets in each group of the number of groups for the first dimension, generating a first dimension group table including the number of pairs in each group of the number of groups for the first dimension to load into a first dimension group LUT in the convolution calculation engine, and including the first dimension group table in the configuration file, wherein the first dimension group table is indexable by the first dimension group number; determining a number of groups of pairs of kernel offsets and relative input offsets for a second dimension of the convolution operation, wherein the number of groups for the second dimension is equal to the second dimension stride denominator value; and including each group of the number of groups of pairs of kernel offsets and relative input offsets for the second dimension in the second dimension kernel table and the second dimension offset table, respectively, wherein both the second dimension offset table and the second dimension kernel table are indexable by a second dimension group number in addition to the second dimension index count; determining a number of pairs of kernel offsets and relative input offsets in each group of the number of groups for the second dimension, generating a second dimension group table including the number of pairs in each group of the number of groups for the second dimension to load into a second dimension group LUT in the convolution calculation engine, and including the second dimension group table in the configuration file, wherein the second dimension group table is indexable by the second dimension group number; and including the first dimension group table and the second dimension group table in the configuration file.

Example C15. The method of example C14, further comprising including the first dimension stride denominator value and the second dimension stride denominator value in the configuration file for use by the convolution calculation engine.

Example C16. The method of example C14, wherein the first dimension group number ranges from 0 to one less than the first dimension stride denominator value and the second dimension group number ranges from 0 to one less than the second dimension stride denominator value, inclusive; a first, first dimension relative input offset is included in the first dimension offset table indexed by a first, first dimension group number and a first, first dimension index count, and a first, first dimension kernel offset is included in the first dimension kernel table indexed by the first, first dimension group number and the first, first dimension index count; a first, second dimension relative input offset is included in the second dimension offset table indexed by a first, second dimension group number and a first, second dimension index count, and a first, second dimension kernel offset is included in the second dimension kernel table indexed by the first, second dimension group number and the first, second dimension index count; the method further comprising: multiplying the first, first dimension kernel offset by the first dimension dilation value, adding the first, first dimension group number and subtracting the first dimension effective padding value, and then dividing that result by the first dimension stride denominator value to obtain a first integer quotient and a first remainder; adding the first integer quotient as the first, first dimension relative input offset to the first dimension offset table and adding the first, first dimension kernel offset to the first dimension kernel table, in response to the first remainder being 0; multiplying the first, second dimension kernel offset by the second dimension dilation value, adding the first, second dimension group number and subtracting the second dimension effective padding value, and then dividing that result by the second dimension stride denominator value to obtain a second integer quotient and a second remainder; and adding the second integer quotient as the first, second dimension relative input offset to the second dimension offset table and adding the first, second dimension kernel offset to the second dimension kernel table, in response to the second remainder being 0.

Example C17. The method of example C1, further comprising: sending the configuration file to the statically reconfigurable dataflow architecture processor to configure the convolution calculation engine to generate an address sequence for a convolution operation between an input tensor and a kernel.

Example C18. A non-transitory machine-readable medium comprising computer instructions that, in response to being executed by a processor, cause the processor to produce a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value, using a method comprising: determining a first group of relative input offsets into the input tensor for an output element of an output of the convolution operation based on the dilation value, and the effective padding value; generating an offset table including the first group of relative input offsets to load into an offset look-up table (LUT) in the convolution calculation engine, wherein the offset table is indexable by an index count; and including the offset table in the configuration file.

Example C19. The non-transitory machine-readable medium of example C18, wherein the stride value is a fractional stride value with a stride numerator of 1 and a stride denominator value that is a positive integer, the method further comprising: determining a first group of kernel offsets for the output element corresponding to the first group of relative input offsets; determining a number of groups of pairs of kernel offsets and relative input offsets for the convolution operation, wherein the number of groups is equal to the stride denominator value; and including each group of the number of groups of pairs of kernel offsets and relative input offsets in the offset table, wherein the offset table is also indexable by a group number in addition to the index count; determining a number of pairs of kernel offsets and relative input offsets in each group of the number of groups; generating a group table including the number of pairs in each group to load into a group LUT in the convolution calculation engine, wherein the group table is indexable by the group number; and including the group table in the configuration file; wherein a first group of pairs of kernel offsets and relative input offsets includes the first group of kernel offsets and the first group of relative input offsets.

Example C20. The non-transitory machine-readable medium of example C18, the method further comprising including any combination of a size of the output of the convolution operation, a number of accumulators to use for the convolution operation, a size of the input tensor, and/or the stride value in the configuration file for use by the convolution calculation engine.

Example C21. The non-transitory machine-readable medium of example C18, the method further comprising: determining a first group of kernel offsets for the output element corresponding to the first group of relative input offsets; determining a first index count based on a first kernel offset in the first group of kernel offsets; calculating a first relative input offset in the offset table corresponding to the first kernel offset by multiplying the first kernel offset by the dilation value and subtracting the effective padding value; and storing the first relative input offset in the offset table at a location indexed by the first index count.

Example C22. The non-transitory machine-readable medium of example C21, the method further comprising: generating a kernel table including the first group of kernel offsets to load a kernel LUT in the convolution calculation engine, wherein the kernel table is indexable by the index count so that for a given index count, a relative input offset of the first group of relative input offsets in the offset table corresponds to a kernel offset of the first group of kernel offsets in the kernel table; and including the kernel table in the configuration file.

Example C23. The non-transitory machine-readable medium of example C22, wherein the offset table and the kernel table are separate fields of a common table stored in a combined offset LUT.

Example C24. The non-transitory machine-readable medium of example C22, wherein the stride value is a fractional stride value with a stride numerator of 1 and a stride denominator value that is a positive integer, the method further comprising: determining a number of groups of pairs of kernel offsets and relative input offsets for the convolution operation, wherein the number of groups is equal to the stride denominator value; and including each group of the number of groups of pairs of kernel offsets and relative input offsets in the kernel table and the offset table, respectively, wherein both the offset table and the kernel table are also indexable by a group number in addition to the index count; determining a number of pairs of kernel offsets and relative input offsets in each group of the number of groups; generating a group table including the number of pairs in each group to load into a group LUT in the convolution calculation engine, wherein the group table is indexable by the group number; and including the group table in the configuration file; wherein a first group of pairs of kernel offsets and relative input offsets includes the first group of kernel offsets and the first group of relative input offsets.

Example C25. The non-transitory machine-readable medium of example C24, the method further comprising including the stride denominator value in the configuration file for use by the convolution calculation engine.

Example C26. The non-transitory machine-readable medium of example C24, wherein the group number ranges from 0 to one less than the stride denominator value, inclusive, a first relative input offset is included in the offset table indexed by a first group number and a first index count, and a first kernel offset is included in the kernel table indexed by the first group number and the first index count, the method further comprising: multiplying the first kernel offset by the dilation value, adding the first group number and subtracting the effective padding value, and then dividing that result by the stride denominator value to obtain an integer quotient and a remainder; and adding the integer quotient as the first relative input offset to the offset table and adding the first kernel offset to kernel table, in response to the remainder being 0.

Example C27. The non-transitory machine-readable medium of example C26, the method further comprising: resetting an elements counter to zero at a start of calculating a group of the number of groups of pairs; using the elements counter as the first index count for adding both the integer quotient to the offset table and the first kernel offset to the kernel table; and incrementing the elements counter after adding both the integer quotient to the offset table and the first kernel offset to the kernel table.

Example C28. The non-transitory machine-readable medium of example C22, wherein the convolution operation is multidimensional; the kernel has a first dimension size and a second dimension size; each kernel offset of the first group of kernel offsets includes a first dimension kernel offset and a second dimension kernel offset; each relative input offset of the first group of relative input offsets includes a first dimension relative input offset and a second dimension relative input offset; the index count includes a first dimension index count and a second dimension index count; the offset table includes a first dimension offset table and second dimension offset table; the kernel table includes a first dimension kernel table and a second dimension kernel table; the dilation value includes a first dimension dilation value and a second dimension dilation value; the effective padding value includes a first dimension effective padding value and a second dimension effective padding value; and the stride value includes a first dimension stride value and a second dimension stride value.

Example C29. The non-transitory machine-readable medium of example C28, the method further comprising: generating a number of relative input offsets in the first dimension offset table equal to the first dimension size of the kernel, relative input offsets in the number of relative input offsets in the first dimension offset table calculated based on the first dimension dilation value, the first dimension effective padding value, and the first dimension stride value; and generating a number of relative input offsets in the second dimension offset table equal to the second dimension size of the kernel, relative input offsets in the number of relative input offsets in the second dimension offset table calculated based on the second dimension dilation value, the second dimension effective padding value, and the second dimension stride value.

Example C30. The non-transitory machine-readable medium of example C28, wherein the first dimension stride value includes a first dimension stride numerator value and a first dimension stride denominator value, the second dimension stride value includes a second dimension stride numerator value and a second dimension stride denominator value, the method further comprising: determining a number of groups of pairs of kernel offsets and relative input offsets for a first dimension of the convolution operation, wherein the number of groups for the first dimension is equal to the first dimension stride denominator value and including each group of the number of groups of pairs of kernel offsets and relative input offsets for the first dimension in the first dimension kernel table and the first dimension offset table, respectively, wherein both the first dimension offset table and the first dimension kernel table are indexable by a first dimension group number in addition to the first dimension index count; determining a number of pairs of kernel offsets and relative input offsets in each group of the number of groups for the first dimension, generating a first dimension group table including the number of pairs in each group of the number of groups for the first dimension to load into a first dimension group LUT in the convolution calculation engine, and including the first dimension group table in the configuration file, wherein the first dimension group table is indexable by the first dimension group number; determining a number of groups of pairs of kernel offsets and relative input offsets for a second dimension of the convolution operation, wherein the number of groups for the second dimension is equal to the second dimension stride denominator value; and including each group of the number of groups of pairs of kernel offsets and relative input offsets for the second dimension in the second dimension kernel table and the second dimension offset table, respectively, wherein both the second dimension offset table and the second dimension kernel table are indexable by a second dimension group number in addition to the second dimension index count; determining a number of pairs of kernel offsets and relative input offsets in each group of the number of groups for the second dimension, generating a second dimension group table including the number of pairs in each group of the number of groups for the second dimension to load into a second dimension group LUT in the convolution calculation engine, and including the second dimension group table in the configuration file, wherein the second dimension group table is indexable by the second dimension group number; and including the first dimension group table and the second dimension group table in the configuration file.

Example C31. The non-transitory machine-readable medium of example C30, the method further comprising including the first dimension stride denominator value and the second dimension stride denominator value in the configuration file for use by the convolution calculation engine.

Example C32. The non-transitory machine-readable medium of example C30, wherein the first dimension group number ranges from 0 to one less than the first dimension stride denominator value and the second dimension group number ranges from 0 to one less than the second dimension stride denominator value, inclusive; a first, first dimension relative input offset is included in the first dimension offset table indexed by a first, first dimension group number and a first, first dimension index count, and a first, first dimension kernel offset is included in the first dimension kernel table indexed by the first, first dimension group number and the first, first dimension index count; a first, second dimension relative input offset is included in the second dimension offset table indexed by a first, second dimension group number and a first, second dimension index count, and a first, second dimension kernel offset is included in the second dimension kernel table indexed by the first, second dimension group number and the first, second dimension index count; the method further comprising: multiplying the first, first dimension kernel offset by the first dimension dilation value, adding the first, first dimension group number and subtracting the first dimension effective padding value, and then dividing that result by the first dimension stride denominator value to obtain a first integer quotient and a first remainder; adding the first integer quotient as the first, first dimension relative input offset to the first dimension offset table and adding the first, first dimension kernel offset to the first dimension kernel table, in response to the first remainder being 0; multiplying the first, second dimension kernel offset by the second dimension dilation value, adding the first, second dimension group number and subtracting the second dimension effective padding value, and then dividing that result by the second dimension stride denominator value to obtain a second integer quotient and a second remainder; and adding the second integer quotient as the first, second dimension relative input offset and the first, second dimension kernel offset to the second dimension offset table and second dimension kernel table, respectively, in response to the second remainder being 0.

Example C33. The non-transitory machine-readable medium of example C18, the method further comprising: sending the configuration file to the statically reconfigurable dataflow architecture processor to configure the convolution calculation engine to generate an address sequence for a convolution operation between an input tensor and a kernel.

Example C34. A data processing system comprising: a compiler configured to produce a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value, the compiler further configured to perform the method of any one of clauses 1 through 17.

Example C35. A computer-implemented method for producing a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, a stride numerator value, and a stride denominator value, the method comprising: determining a number of groups of pairs of kernel offsets and relative input offsets for the convolution operation, wherein the number of groups is equal to the stride denominator value; and including each group of the number of groups of pairs of kernel offsets and relative input offsets in an offset table, indexable by a group number and an index count, to load into an offset look-up table (LUT) in the convolution calculation engine; determining a first group of the number of groups of pairs of kernel offsets and relative input offsets including relative input offsets into the input tensor for an output element of an output of the convolution operation based on the dilation value, and the effective padding value; determining a number of pairs of kernel offsets and relative input offsets in each group of the number of groups; generating a group table including the number of pairs in each group to load into a group LUT in the convolution calculation engine, wherein the group table is indexable by the group number; and including the group table and the offset table in the configuration file.

Example C36. The method of example C35, further comprising including any combination of a size of the output of the convolution operation, a number of accumulators to use for the convolution operation, a size of the input tensor, the stride numerator value, and/or the stride denominator value in the configuration file for use by the convolution calculation engine.

Example C37. The method of example C35, wherein the group number ranges from 0 to one less than the stride denominator value, inclusive, a first pair of a first relative input offset a first kernel offset is included in the offset table indexed by a first group number and a first index count, the method further comprising: multiplying the first kernel offset by the dilation value, adding the first group number and subtracting the effective padding value, and then dividing that result by the stride denominator value to obtain an integer quotient and a remainder; and adding the integer quotient, as the first relative input offset, and the first kernel offset as the first pair to the offset table, in response to the remainder being 0.

Example C38. The method of example C37, further comprising: resetting an elements counter to zero at a start of calculating a group of the number of groups of pairs; using the elements counter as the first index count for adding the first pair to the offset table; and incrementing the elements counter after adding the first pair to the offset table.

Example C39. The method of example C35, wherein the convolution operation is multidimensional; the kernel has a first dimension size and a second dimension size; each kernel offset includes a first dimension kernel offset and a second dimension kernel offset; each relative input offset includes a first dimension relative input offset and a second dimension relative input offset; the index count includes a first dimension index count and a second dimension index count; the offset table includes a first dimension offset table and second dimension offset table; the dilation value includes a first dimension dilation value and a second dimension dilation value; the effective padding value includes a first dimension effective padding value and a second dimension effective padding value; the stride numerator value includes a first dimension stride numerator value and a second dimension stride numerator value; and the stride denominator value includes a first dimension stride denominator value and a second dimension stride denominator value.

Example C40. The method of example C39, further comprising: generating a number of pairs of kernel offsets and relative input offsets in the first dimension offset table equal to the first dimension size of the kernel, the relative input offsets in the first dimension offset table calculated based on the first dimension dilation value, the first dimension effective padding value, and the first dimension stride denominator value; and generating a number of pairs of kernel offsets and relative input offsets in the second dimension offset table equal to the second dimension size of the kernel, the relative input offsets in the second dimension offset table calculated based on the second dimension dilation value, the second dimension effective padding value, and the second dimension stride denominator value.

Example C41. The method of example C35, further comprising: sending the configuration file to the statically reconfigurable dataflow architecture processor to configure the convolution calculation engine to generate an address sequence for a convolution operation between an input tensor and a kernel.

Example C42. A non-transitory machine-readable medium comprising computer instructions that, in response to being executed by a processor, cause the processor to produce a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value, using the method of any one of clauses 35 through 41.

Example C43. A data processing system comprising: a compiler configured to produce a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value, the compiler further configured to perform the method of any one of clauses 35 through 41.

Example C44. A data processing system comprising: a compiler configured to produce a configuration file to configure a convolution calculation engine using one or more statically reconfigurable units in an array of coarse-grained reconfigurable (CGR) units of a statically reconfigurable dataflow architecture processor to generate an address sequence for a convolution operation between an input tensor and a kernel, the convolution operation having a dilation value, an effective padding value, and a stride value including a fractional stride value with a stride numerator of 1 and a stride denominator value that is a positive integer, the compiler further configured to perform a method comprising: determining a number of groups of pairs of kernel offsets and relative input offsets for the convolution operation, wherein the number of groups is equal to the stride denominator value; and including each group of the number of groups of pairs of kernel offsets and relative input offsets in an offset table, indexable by a group number and an index count, to load into an offset look-up table (LUT) in the convolution calculation engine; determining a first group of the number of groups of pairs of kernel offsets and relative input offsets including relative input offsets into the input tensor for an output element of an output of the convolution operation based on the dilation value, and the effective padding value; determining a number of pairs of kernel offsets and relative input offsets in each group of the number of groups; generating a group table including the number of pairs in each group to load into a group LUT in the convolution calculation engine, wherein the group table is indexable by the group number; and including the group table and the offset table in the configuration file.

### Further or Additional Considerations

We describe various implementations of an address generator for a convolution computation engine. The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more statically reconfigurable dataflow architecture processors to execute a high-level program. Furthermore, one or more implementations of the technology or elements thereof can be implemented in the form of an apparatus including a memory and at least one processor that is coupled to the memory and operative to perform exemplary method steps, and/or a statically reconfigurable dataflow architecture processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope of the technology disclosed.

1. A statically reconfigurable dataflow architecture processor comprising:
an array of coarse-grained reconfigurable (CGR) units including a plurality of statically reconfigurable memory units, a plurality of statically reconfigurable compute units, a plurality of statically reconfigurable switches, and a plurality of links that respectively connect two of the CGR units, and respectively include a vector link;
the plurality of statically reconfigurable compute units respectively including an array of multiply-accumulate circuits (MACs) having a plurality of lanes and a plurality of stages, the plurality of statically reconfigurable compute units including a first statically reconfigurable compute unit;
the plurality of statically reconfigurable memory units respectively including a memory array, a general address calculation unit, and a convolution address compute unit, the plurality of statically reconfigurable memory units including a first statically reconfigurable memory unit, a second statically reconfigurable memory unit, and a third statically reconfigurable memory unit; and
convolution address compute units of the plurality of statically reconfigurable memory units respectively comprising:
an outer output base location register to provide an outer output base location for a convolution operation;
an outer input base location register to provide an outer input base location for the convolution operation;
a kernel element counter that starts to count from an initial kernel count value to a maximum kernel count value in response to a change in the outer output base location;
a kernel offset generator to generate a kernel offset based on an output of the kernel element counter; and
inner location logic to calculate an output location based on the outer output base location and an input location based on the outer input base location and the output of the kernel element counter.

2. The statically reconfigurable dataflow architecture processor of claim 1, wherein the outer output base location register includes a first dimension outer output base location register for a first dimension of an output of the convolution operation and a second dimension outer output base location register for a second dimension of the output of the convolution operation;
the outer input base location register includes a first dimension outer input base location register for a first dimension of an input to the convolution operation and a second dimension outer input base location register for a second dimension of the input to the convolution operation;
a kernel offset generator generates a first dimension kernel offset for a first dimension of a kernel for the convolution operation and a second dimension kernel offset for a second dimension of the kernel for the convolution operation;
the inner location logic calculates a first dimension input location for the first dimension of the input to the convolution operation, a second dimension input location for the second dimension of the input to the convolution operation, a first dimension output location for the first dimension of the output of the convolution operation, a second dimension output location for the second dimension of the output of the convolution operation; and
the convolution operation is a multidimensional convolution operation.

3. A circuit to generate addresses for a convolution operation comprising:
an outer output base location register to provide an outer output base location for the convolution operation;
an outer input base location register to provide an outer input base location for the convolution operation;
a kernel element counter that starts to count from an initial kernel count value to a maximum kernel count value in response to a change in the outer output base location;
a kernel offset generator to generate a kernel offset based on an output of the kernel element counter; and
inner location logic to calculate an output location based on the outer output base location and an input location based on the outer input base location and the output of the kernel element counter.

4. The circuit of claim 3, wherein the inner location logic is configured to update the input location in response to an update of the kernel element counter.

5. The circuit of claim 3, wherein the inner location logic is configured to calculate the input location further based on a dilation value and/or an effective pad value for the convolution operation.

6. The circuit of claim 3, wherein the outer output base location register includes a first dimension outer output base location register for a first dimension of an output of the convolution operation and a second dimension outer output base location register for a second dimension of the output of the convolution operation;
the outer input base location register includes a first dimension outer input base location register for a first dimension of an input to the convolution operation and a second dimension outer input base location register for a second dimension of the input to the convolution operation;
a kernel offset generator generates a first dimension kernel offset for a first dimension of a kernel for the convolution operation and a second dimension kernel offset for a second dimension of the kernel for the convolution operation;
the inner location logic calculates a first dimension input location for the first dimension of the input to the convolution operation, a second dimension input location for the second dimension of the input to the convolution operation, a first dimension output location for the first dimension of the output of the convolution operation, a second dimension output location for the second dimension of the output of the convolution operation; and
the convolution operation is a multidimensional convolution operation.

7. The circuit of claim 6, wherein the outer output base location register includes a third dimension outer output base location register for a third dimension of the output of the convolution operation;
the outer input base location register includes a third dimension outer input base location register for a third dimension of the input to the convolution operation;
the kernel offset generator generates a third dimension kernel offset for a third dimension of the kernel for the convolution operation;
the inner location logic calculates a third dimension input location for the third dimension of the input to the convolution operation, and a third dimension output location for the third dimension of the output of the convolution operation; and
the convolution operation is a three-dimensional convolution operation.

8. The circuit of claim 7, the kernel element counter including a first dimension kernel counter for the first dimension of the kernel, a second dimension kernel counter for the second dimension of the kernel, and a third dimension kernel counter for a third dimension of the kernel, the third dimension kernel counter configured to increment in response to the second dimension kernel counter wrapping to its initial value from a maximum second dimension kernel count value, the second dimension kernel counter configured to increment in response to the first dimension kernel counter wrapping to its initial value from a maximum first dimension kernel count value.

9. The circuit of claim 3, wherein the kernel element counter wraps back to the initial kernel count value from the maximum kernel count value; and
the outer output base location register and the outer input base location register are updated in response to the kernel element counter wrapping back to the initial kernel count value.

10. The circuit of claim 3, the inner location logic comprising:
an inner input base register to provide an inner input base location;
an accumulator counter configured to be reset to an initial accumulator value in response to a change in the kernel element counter and increment in response to a new input location being calculated, until reaching a maximum accumulator count value;
input location calculation logic configured to calculate the input location based on the inner input base register and the output of the kernel element counter; and
an inner output register to provide the output location, the inner output register configured to increment in response to the accumulator counter incrementing and to load the outer output base location in response to the kernel element counter changing;
wherein the kernel element counter is configured to increment in response to the accumulator counter reaching the maximum accumulator count value; and
the inner input base register is configured to increment in response to the new input location being calculated, and to load the outer input base location in response to the kernel element counter wrapping back to the initial kernel count value.

11. The circuit of claim 10, wherein the inner input base register, when incremented, increments by a stride amount for the convolution operation.

12. The circuit of claim 10, wherein the input location calculation logic is configured to calculate the input location by multiplying the output of the kernel element counter by a dilation value for the convolution operation and adding a difference between the inner input base register and an effective pad value for the convolution operation.

13. The circuit of claim 12, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

14. The circuit of claim 10, the inner location logic further comprising:
an offset lookup table, indexed by the output of the kernel element counter, and outputting an input offset value;
wherein the input location calculation logic is configured to calculate the input location by adding the inner input base location to the input offset value.

15. The circuit of claim 14, wherein the input location calculation logic is further configured to check the input location against bounds for an input to the convolution operation, and in response to determining that the input location is outside of the bounds, to set a predicate for the input location to indicate that no memory read should be performed and that a value of zero should be provided in place of data read from memory for the input location.

16. The circuit of claim 14, wherein the kernel offset generator includes a portion of the offset lookup table, and the offset lookup table further outputs the kernel offset.

17. The circuit of claim 3, wherein the kernel offset generator includes an offset lookup table, indexed by the output of the kernel element counter, and outputting the kernel offset.

18. A method for use in a convolution operation comprising:
initializing an outer output base location register to provide an outer output base location for the convolution operation;
initializing an outer input base location register to provide an outer input base location for the convolution operation;
counting, with a kernel element counter, from an initial kernel count value to a maximum kernel count value in response to a change in the outer output base location;
generating a kernel offset based on an output of the kernel element counter;
calculating an output location based on the outer output base location; and
calculating an input location based on the outer input base location and the output of the kernel element counter.

19. The method of claim 18, further comprising:
resetting an accumulator counter to an initial accumulator value in response to a change in the kernel element counter;
incrementing the accumulator counter in response to a new input location being calculated, until reaching a maximum accumulator count value;
incrementing the kernel element counter in response to the accumulator counter reaching the maximum accumulator count value;
loading the outer input base location into an inner input base register in response to the kernel element counter wrapping back to the initial kernel count value, the inner input base register to provide an inner input base location;
incrementing the inner input base register in response to the accumulator counter being incremented and incrementing the inner input base register in response to the accumulator counter wrapping back to the initial accumulator value;
calculating the input location based on the inner input base location and the output of the kernel element counter;
incrementing an inner output register in response to the accumulator counter incrementing, the inner output register to provide the output location; and
loading the outer output base location into the inner output register in response to the kernel element counter changing.

20. The method of claim 19, further comprising:
calculating a first kernel memory address based on the kernel offset during a first period where the accumulator counter has a first value;
accessing a kernel memory using the first kernel memory address to retrieve a first kernel vector element;
sending the first kernel vector element to a first multiply-accumulate circuit (MAC);
calculating a first input memory address based on the input location during the first period;
accessing an input memory using the first input memory address to retrieve a first input vector element;
sending the first input vector element to the first MAC;
calculating a first dot product of the first kernel vector element and the first input vector element in the first MAC, and accumulating a result of the first dot product with a previous value of an accumulator of the first MAC;
calculating a second input memory address based on the input location during a second period;
accessing the input memory using the second input memory address to retrieve a second input vector element;
sending the second input vector element to a second MAC;
calculating a second dot product of the first kernel vector element and the second input vector element in the second MAC, and accumulating a result of the second dot product with a previous value of an accumulator of the second MAC, wherein the calculation of the second dot product in the second MAC occurs in parallel with the calculation of the first dot product in the first MAC;
processing K input vector elements in both the first MAC and the second MAC, where K is a number of active locations in a receptive field of an input for the convolution operation;
calculating a first output memory address based on the output location during the first period;
saving an accumulated result from the accumulator of the first MAC in an output memory using the first output memory address;
calculating a second output memory address based on the output location during the second period; and
saving an accumulated result from the accumulator of the second MAC in the output memory using the second output memory address.
